(19) United States
(12) Patent Application Publication
(10) Pub. No.: US 2012/0057775 A1
(43) Pub. Date: Mar. 8, 2012

(54) INFORMATION PROCESSING DEVICE, INFORMATION PROCESSING METHOD, AND PROGRAM

(76) Inventors: Hirotaka Suzuki, Kanagawa (JP); Masato Ito, Tokyo (JP); Kohtaro Sabe, Tokyo (JP)

(21) Appl. No.: 13/076,744

(22) Filed: Mar. 31, 2011

(30) Foreign Application Priority Data
Sep. 4, 2010 (JP) P2010-090054

(51) Int. Cl. G06K 9/62; G06K 9/00

(52) U.S. Cl. 382/154; 382/159

(57) ABSTRACT

An information processing device includes a feature amount extracting unit configured to extract the feature amount of each frame of an image of a content for detector learning of interest that is a content to be used for learning of a highlight detector which is a model for detecting a scene in which the user is interested as a highlight scene; a clustering unit configured to use cluster information that is the information of the cluster obtained by performing cluster learning; a highlight label generating unit configured to generate a highlight label sequence; and a highlight detector learning unit configured to perform learning of the highlight detector.

### BACKGROUND OF THE INVENTION

1. Field of the Invention

The present invention relates to an information processing device, an information processing method, and a program, and specifically relates to an information processing device, an information processing method, and a program, which enables a digest, in which scenes in which a user has an interest are collected as highlight scenes, to be readily obtained.

2. Description of the Related Art

For example, as for a highlight scene detection technique for detecting a highlight scene from a content such as a movie, a television broadcast program, or the like, there is a technique taking advantage of the experience and knowledge of an expert (designer), a technique taking advantage of statistical learning using learning samples, and so forth.

With the technique taking advantage of the experience and knowledge of an expert, a detector for detecting an event that occurs in a highlight scene, and a detector for detecting a scene defined from the event thereof (scene where an event occurs) are designed based on the experience and knowledge of the expert. A highlight scene is thus detected using these detectors.

With the technique taking advantage of statistical learning employing a learning sample, a detector for detecting a highlight scene (highlight detector), and a detector for detecting an event that occurs in a highlight scene (event detector), which employs a learning sample, are used. A highlight scene is thus detected using these detectors.

Also, with the highlight scene detection technique, the image or audio feature amount of a content is extracted, and a highlight scene is detected using the feature amount thereof. As for feature amount for detecting a highlight scene, in general, a feature amount customized to the genre of a content from which a highlight scene is to be detected, is employed.

For example, with the highlight scene detection technique of Wang and others, and Duan and others, from a soccer game video, high dimensional feature amount for detecting an event such as “whistle”, “applause”, or the like is extracted by taking advantage of the lines of a soccer field, the path of travel of a soccer ball, the motion of the entire screen, and audio MFCC (Mel-Frequency Cepstrum Coefficient), and feature amount combined from these is used to perform detection of a play scene of the soccer such as “offensive play”, “foul”, and so forth.

Also, for example, Wang and others have proposed a highlight scene detection technique wherein a view type sorter employing color histogram feature amount, play location identifier employing a line detector, a replay logo detector, a sportscaster's excitement degree detector, a whistle detector, and so forth are designed from the soccer game video, temporal relationship of these is subjected to modeling by a Bayesian network, thereby making up a soccer highlight detector.

As for the highlight scene detection technique, in addition, for example, with Japanese Unexamined Patent Application Publication No. 2008-185626 (hereafter, also referred to as PTL 1), a technique has been proposed wherein feature amount for featuring the buildup of sound (cheering) is used to detect a highlight scene of a content.

With the above highlight scene detection techniques, a highlight scene (or event) may be detected regarding contents belonging to a particular genre, but it is difficult to detect a suitable scene as a highlight scene regarding contents belonging to other genres.

Specifically, for example, with the highlight scene detection technique according to PTL 1, a highlight scene is detected under a rule that a scene including cheering is a highlight scene, but the genres of contents wherein a scene including cheering is a highlight scene are limited. Also, with the highlight scene detection technique according to PTL 1, it is difficult to detect a highlight scene with a content belonging to a genre wherein a scene without cheering is a highlight scene, as an object.

Accordingly, in order to perform detection of a highlight scene with a content belonging to a genre other than a particular genre as an object by the highlight scene detection technique according to PTL 1, it is necessary to design the feature amount so as to be suitable for the genre thereof. Further, a rule design for detection of a highlight scene (or definition of an event) using the feature amount thereof has to be performed based on an interview of an expert, and so forth.

Therefore, for example, with Japanese Unexamined Patent Application Publication No. 2000-299829 (hereafter, also referred to as PTL 2), a method has been proposed wherein feature amount and a threshold whereby detection of a scene generally determined to be a highlight scene may be used are designed, and a highlight scene is detected by threshold processing using the feature amount and threshold thereof.

However, in recent years, contents have become diversified, and it is extremely difficult to obtain a general rule, for example, such as a feature amount, rule of threshold processing, and so forth, to be used for detecting a scene suitable for a highlight scene regarding all of the contents.

Accordingly, in order to detect a scene suitable for a highlight scene, for example, it is necessary to design feature amount and a rule to detect a highlight scene, for each genre or the like, adapted to the genre thereof. However, even in the event that such a rule has been designed, it is difficult to detect what we might call a exceptional highlight scene not following the rule.

### SUMMARY OF THE INVENTION

With regard to contents, for example, such as a game of sports such as a goal scene of a soccer game, a rule to detect a scene generally called a highlight scene may be designed with high precision using the knowledge of an expert.

However, a user's preference greatly varies from one user to another. Specifically, for example, there are separate users who prefer “a scene with a field manager sitting on the bench”, “a scene of a pickoff throw to first base in baseball”, “a question and answer scene of a quiz program”, and so forth, respectively. In this case, it is unrealistic to individually design a rule adapted to each of these user's preferences and to incorporate these in a detection system such as an AV (Audio Visual) device for detecting a highlight scene.

On the other hand, instead of the user viewing and listening to a digest in which highlight scenes detected in accordance with a fixed rule incorporated in a detection system are collected, a detection system learns the preference of each of the users, detects a scene matching the preferences thereof (a scene in which the user is interested) as a highlight scene, and provides a digest wherein such highlight scenes are collected, thereby realizing “personalization”, as if it were, of viewing and listening to a content, and expanding ways in how to enjoy contents.

It has been found to be desirable to enable a digest, in which scenes in which a user has an interest are collected as highlight scenes, to be readily obtained.

An information processing device or program according to an embodiment of the present invention is an information processing device including: a feature amount extracting unit configured to extract the feature amount of each frame of an image of a content for detector learning of interest that is a content to be used for learning of a highlight detector which is a model for detecting a scene in which the user is interested as a highlight scene; a clustering unit configured to use cluster information that is the information of the cluster obtained by performing cluster learning for extracting the feature amount of each frame of an image of a content for learning that is a content to be used for cluster learning for dividing feature amount space that is the space of the feature amount into a plurality of clusters, and dividing the feature amount space into a plurality of clusters using the feature amount of each frame of the content for learning to subject the feature amount of each frame of the content for detector learning of interest to clustering into one cluster of the plurality of clusters, thereby converting the time sequence of the feature amount of the content for detector learning of interest into the code sequence of a code representing a cluster to which the feature amount of the content for detector learning of interest belongs; a highlight label generating unit configured to generate a highlight label sequence regarding the content for detector learning of interest by labeling each frame of the content for detector learning of interest using a highlight label representing whether or not the highlight scene in accordance with the user's operations; and a highlight detector learning unit configured to perform learning of the highlight detector which is a state transition probability model stipulated by state transition probability that a state will proceed, and observation probability that a predetermined observation value will be observed from the state, using a label sequence for learning that is a pair of the code sequence obtained from the content for detector learning of interest, and the highlight label sequence, or a program causing a computer to serve as the information processing device.

An information processing method according to an embodiment of the present invention is an information processing method using an information processing device, including the steps of: extracting the feature amount of each frame of an image of a content for detector learning of interest that is a content to be used for learning of a highlight detector which is a model for detecting a scene in which the user is interested as a highlight scene; using cluster information that is the information of the cluster obtained by performing cluster learning for extracting the feature amount of each frame of an image of a content for learning that is a content to be used for cluster learning for dividing feature amount space that is the space of the feature amount into a plurality of clusters, and dividing the feature amount space into a plurality of clusters using the feature amount of each frame of the content for learning to subject the feature amount of each frame of the content for detector learning of interest to clustering into one cluster of the plurality of clusters, thereby converting the time sequence of the feature amount of the content for detector learning of interest into the code sequence of a code representing a cluster to which the feature amount of the content for detector learning of interest belongs; generating a highlight label sequence regarding the content for detector learning of interest by labeling each frame of the content for detector learning of interest using a highlight label representing whether or not the highlight scene in accordance with the user's operations; and performing learning of the highlight detector which is a state transition probability model stipulated by state transition probability that a state will proceed, and observation probability that a predetermined observation value will be observed from the state, using a label sequence for learning that is a pair of the code sequence obtained from the content for detector learning of interest, and the highlight label sequence.

With the configuration described above, the feature amount of each frame of an image of a content for detector learning of interest that is a content to be used for learning of a highlight detector which is a model for detecting a scene in which the user is interested is extracted as a highlight scene. Cluster information that is the information of the cluster obtained by performing cluster learning for extracting the feature amount of each frame of an image of a content for learning that is a content to be used for cluster learning for dividing feature amount space that is the space of the feature amount into a plurality of clusters, and dividing the feature amount space into a plurality of clusters using the feature amount of each frame of the content for learning is used to subject the feature amount of each frame of the content for detector learning of interest to clustering into one cluster of the plurality of clusters, thereby converting the time sequence of the feature amount of the content for detector learning of interest into the code sequence of a code representing a cluster to which the feature amount of the content for detector learning of interest belongs. Also, a highlight label sequence is generated regarding the content for detector learning of interest by labeling each frame of the content for detector learning of interest using a highlight label representing whether or not the highlight scene in accordance with the user's operations. Learning of the highlight detector which is a state transition probability model stipulated by state transition probability that a state will proceed, and observation probability that a predetermined observation value will be observed from the state is performed using a label sequence for learning that is a pair of the code sequence obtained from the content for detector learning of interest, and the highlight label sequence.

An information processing device or program according to an embodiment of the present invention is an information processing device including: an obtaining unit configured to obtain the highlight detector obtained by extracting the feature amount of each frame of an image of a content for detector learning of interest that is a content to be used for learning of a highlight detector which is a model for detecting a scene in which the user is interested as a highlight scene, using cluster information that is the information of the clusters obtained by performing cluster learning for extracting the feature amount of each frame of an image of a content for learning that is a content to be used for cluster learning for dividing feature amount space that is the space of the feature amount into a plurality of clusters, and dividing the feature amount space into a plurality of clusters using the feature amount of each frame of the content for learning to subject the feature amount of each frame of the content for detector learning of interest to clustering into one cluster of the plurality of clusters, thereby converting the time sequence of the feature amount of the content for detector learning of interest into the code sequence of a code representing a cluster to which the feature amount of the content for detector learning of interest belongs, generating a highlight label sequence regarding the content for detector learning of interest by labeling each frame of the content for detector learning of interest using a highlight label representing whether or not the highlight scene in accordance with the user's operations, and performing learning of the highlight detector which is a state transition probability model stipulated by state transition probability that a state will proceed, and observation probability that a predetermined observation value will be observed from the state, using a label sequence for learning that is a pair of the code sequence obtained from the content for detector learning of interest, and the highlight label sequence; a feature amount extracting unit configured to extract the feature amount of each frame of an image of a content for highlight detection of interest that is a content from which a highlight scene is to be detected; a clustering unit configured to convert the time sequence of the feature amount of the content for highlight detection of interest into the code sequence by subjecting the feature amount of each frame of the content for highlight detection of interest to clustering into one cluster of the plurality of clusters using the cluster information; a maximum likelihood state sequence estimating unit configured to estimate the maximum likelihood state sequence that is a state sequence causing state transition to occur where likelihood is the highest that a label sequence for detection that is a pair of the code sequence obtained from the content for highlight detection of interest, and the highlight label sequence of a highlight label representing a highlight scene or non-highlight scene will be observed in the highlight detector; a highlight scene detecting unit configured to detect the frame of a highlight scene from the content for highlight detection of interest based on the observation probability of the highlight label of each state of a highlight relation state sequence that is the maximum likelihood state sequence obtained from the label sequence for detection; and a digest contents generating unit configured to generate a digest content that is the digest of the content for highlight detection of interest using the frame of the highlight scene.

An information processing method according to an embodiment of the present invention is an information processing method using an information processing device, including the steps of: obtaining the highlight detector to be obtained by extracting the feature amount of each frame of an image of a content for detector learning of interest that is a content to be used for learning of a highlight detector which is a model for detecting a scene in which the user is interested as a highlight scene, using cluster information that is the information of the clusters obtained by performing cluster learning for extracting the feature amount of each frame of an image of a content for learning that is a content to be used for cluster learning for dividing feature amount space that is the space of the feature amount into a plurality of clusters, and dividing the feature amount space into a plurality of clusters using the feature amount of each frame of the content for learning to subject the feature amount of each frame of the content for detector learning of interest to clustering into one cluster of the plurality of clusters, thereby converting the time sequence of the feature amount of the content for detector learning of interest into the code sequence of a code representing a cluster to which the feature amount of the content for detector learning of interest belongs, generating a highlight label sequence regarding the content for detector learning of interest by labeling each frame of the content for detector learning of interest using a highlight label representing whether or not the highlight scene in accordance with the user's operations, and performing learning of the highlight detector which is a state transition probability model stipulated by state transition probability that a state will proceed, and observation probability that a predetermined observation value will be observed from the state, using a label sequence for learning that is a pair of the code sequence obtained from the content for detector learning of interest, and the highlight label sequence; extracting the feature amount of each frame of an image of a content for highlight detection of interest that is a content from which a highlight scene is to be detected; converting the time sequence of the feature amount of the content for highlight detection of interest into the code sequence by subjecting the feature amount of each frame of the content for highlight detection of interest to clustering into one cluster of the plurality of clusters using the cluster information; estimating the maximum likelihood state sequence that is a state sequence causing state transition to occur where likelihood is the highest that a label sequence for detection that is a pair of the code sequence obtained from the content for highlight detection of interest, and the highlight label sequence of a highlight label representing a highlight scene or non-highlight scene will be observed in the highlight detector; detecting the frame of a highlight scene from the content for highlight detection of interest based on the observation probability of the highlight label of each state of a highlight relation state sequence that is the maximum likelihood state sequence obtained from the label sequence for detection; and generating a digest content that is the digest of the content for highlight detection of interest using the frame of the highlight scene.

With the configuration described above, there is obtained the highlight detector to be obtained by extracting the feature amount of each frame of an image of a content for detector learning of interest that is a content to be used for learning of a highlight detector which is a model for detecting a scene in which the user is interested as a highlight scene, using cluster information that is the information of the clusters obtained by performing cluster learning for extracting the feature amount of each frame of an image of a content for learning that is a content to be used for cluster learning for dividing feature amount space that is the space of the feature amount into a plurality of clusters, and dividing the feature amount space into a plurality of clusters using the feature amount of each frame of the content for learning to subject the feature amount of each frame of the content for detector learning of interest to clustering into one cluster of the plurality of clusters, thereby converting the time sequence of the feature amount of the content for detector learning of interest into the code sequence of a code representing a cluster to which the feature amount of the content for detector learning of interest belongs, generating a highlight label sequence regarding the content for detector learning of interest by labeling each frame of the content for detector learning of interest using a highlight label representing whether or not the highlight scene in accordance with the user's operations, and performing learning of the highlight detector which is a state transition probability model stipulated by state transition probability that a state will proceed, and observation probability that a predetermined observation value will be observed from the state, using a label sequence for learning that is a pair of the code sequence obtained from the content for detector learning of interest, and the highlight label sequence. Further, the feature amount of each frame of an image of a content for highlight detection of interest that is a content from which a highlight scene is to be detected is extracted, and the feature amount of each frame of the content for highlight detection of interest is subjected to clustering into one cluster of the plurality of clusters using the cluster information, thereby converting the time sequence of the feature amount of the content for highlight detection of interest into the code sequence. Also, there is estimated the maximum likelihood state sequence that is a state sequence causing state transition to occur where likelihood is the highest that a label sequence for detection that is a pair of the code sequence obtained from the content for highlight detection of interest, and the highlight label sequence of a highlight label representing a highlight scene or non-highlight scene will be observed in the highlight detector. The frame of a highlight scene is detected from the content for highlight detection of interest based on the observation probability of the highlight label of each state of a highlight relation state sequence that is the maximum likelihood state sequence obtained from the label sequence for detection. A digest content that is the digest of the content for highlight detection of interest is generated using the frame of the highlight scene.

Note that the information processing device may be a stand-alone device, or may be an internal block making up a single device.

Also, the program may be provided by being transmitted via a transmission medium or by being recorded in a recording medium.

According to the above-described configurations, a digest, in which scenes in which a user has an interest are collected as highlight scenes, can be readily obtained.

### BRIEF DESCRIPTION OF THE DRAWINGS

FIG. 1 is a block diagram illustrating a configuration example of an embodiment of a recorder to which the present invention has been applied;

FIG. 2 is a block diagram illustrating a configuration example of a contents model learning unit;

FIG. 3 is a diagram illustrating an example of an HMM;

FIG. 4 is a diagram illustrating an example of an HMM;

FIG. 5 is a diagram illustrating an example of an HMM;

FIG. 6 is a diagram illustrating an example of an HMM;

FIG. 7 is a diagram for describing feature amount extraction processing by a feature amount extracting unit;

FIG. 8 is a flowchart for describing contents model learning processing;

FIG. 9 is a block diagram illustrating a configuration example of a contents structure presenting unit;

FIG. 10 is a diagram for describing the outline of contents structure presentation processing;

FIG. 11 is a diagram illustrating an example of a model map;

FIG. 12 is a diagram illustrating an example of a model map;

FIG. 13 is a flowchart for describing the contents structure presentation processing by the contents structure presenting unit;

FIG. 14 is a block diagram illustrating a configuration example of a digest generating unit;

FIG. 15 is a block diagram illustrating a configuration example of a highlight detector learning unit;

FIG. 16 is a diagram for describing processing of a highlight label generating unit;

FIG. 17 is a flowchart for describing highlight detector learning processing by the highlight detector learning unit;

FIG. 18 is a block diagram illustrating a configuration example of a highlight detecting unit;

FIG. 19 is a diagram for describing an example of a digest content that a digest contents generating unit generates;

FIG. 20 is a flowchart for describing highlight detection processing by a highlight detecting unit;

FIG. 21 is a flowchart for describing highlight scene detection processing;

FIG. 22 is a block diagram illustrating a configuration example of a scrapbook generating unit;

FIG. 23 is a block diagram illustrating a configuration example of an initial scrapbook generating unit;

FIG. 24 is a diagram illustrating an example of user interface for a user specifying the state on a model map;

FIG. 25 is a flowchart for describing initial scrapbook generation processing by the initial scrapbook generating unit;

FIG. 26 is a block diagram illustrating a configuration example of a registered scrapbook generating unit;

FIG. 27 is a flowchart for describing registered scrapbook generation processing by the registered scrapbook generating unit;

FIG. 28 is a diagram for describing the registered scrapbook generation processing;

FIG. 29 is a block diagram illustrating a first configuration example of a server client system;

FIG. 30 is a block diagram illustrating a second configuration example of the server client system;

FIG. 31 is a block diagram illustrating a third configuration example of the server client system;

FIG. 32 is a block diagram illustrating a fourth configuration example of the server client system;

FIG. 33 is a block diagram illustrating a fifth configuration example of the server client system;

FIG. 34 is a block diagram illustrating a sixth configuration example of the server client system;

FIG. 35 is a block diagram illustrating a configuration example of another embodiment of the recorder to which the present invention has been applied;

FIG. 36 is a block diagram illustrating a configuration example of a contents model learning unit;

FIG. 37 is a diagram for describing feature amount extraction processing by an audio feature amount extracting unit 221;

FIG. 38 is a diagram for describing the feature amount extraction processing by the audio feature amount extracting unit;

FIG. 39 is a diagram for describing feature amount extraction processing by an object feature amount extracting unit;

FIG. 40 is a flowchart for describing audio contents model learning processing by the contents model learning unit;

FIG. 41 is a flowchart for describing object contents model learning processing by the contents model learning unit;

FIG. 42 is a block diagram illustrating a configuration example of a digest generating unit;

FIG. 43 is a block diagram illustrating a configuration example of a highlight detector learning unit;

FIG. 44 is a flowchart for describing highlight detector learning processing by the highlight detector learning unit;

FIG. 45 is a block diagram illustrating a configuration example of a highlight detecting unit;

FIG. 46 is a flowchart for describing highlight detection processing by the highlight detecting unit;

FIG. 47 is a block diagram illustrating a configuration example of a scrapbook generating unit;

FIG. 48 is a block diagram illustrating a configuration example of an initial scrapbook generating unit;

FIG. 49 is a diagram illustrating an example of user interface for a user specifying the state on a model map;

FIG. 50 is a block diagram illustrating a configuration example of a registered scrapbook generating unit;

FIG. 51 is a flowchart for describing registered scrapbook generation processing by the registered scrapbook generating unit;

FIG. 52 is a diagram for describing the registered scrapbook generation processing; and

FIG. 53 is a block diagram illustrating a configuration example of an embodiment of a computer to which the present invention has been applied.

### DESCRIPTION OF THE PREFERRED EMBODIMENTS

Embodiment of Recorder with Information Processing Device of Present Invention Being Applied

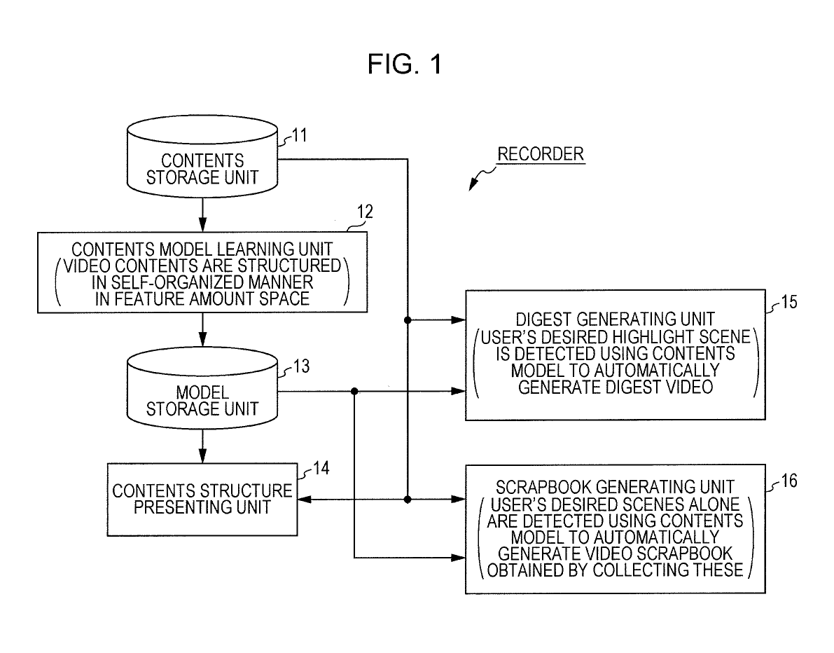

FIG. 1 is a block diagram illustrating a configuration example of an embodiment of a recorder to which an information processing device according to the present invention has been applied.

The recorder in FIG. 1 is, for example, an HD (Hard Disk) recorder or the like, and can video-record (record) (store) various types of contents such as television broadcast programs, contents provided via a network such as the Internet or the like, contents taken by a video camera or the like, and the like.

Specifically, in FIG. 1, the recorder is configured of a contents storage unit 11, a contents model learning unit 12, a model storage unit 13, a contents structure presenting unit 14, a digest generating unit 15, and a scrapbook generating unit 15.

The contents storage unit 11 stores (records) a content, for example, such as a television broadcast program. Storage of a content to the contents storage unit 11 constitutes recording of the content thereof, and the video-recorded content (content stored in the contents storage unit 11) is played, for example, according to the user's operations.

The contents model learning unit 12 performs learning (statistical learning) for structuring the content stored in the contents storage unit 11 in a self-organized manner in predetermined feature amount space to obtain a model (hereafter, also referred to as contents model) representing the structure (temporal space structure) of the content. The contents model learning unit 12 supplies the contents model obtained as learning results to the model storage unit 13.

The model storage unit 13 store the contents model supplied from the contents model learning unit 12.

The contents structure presenting unit 14 uses the content stored in the contents storage unit 11, and the contents model stored in the model storage unit 13 to create and present a later-described model map representing the structure of the content.

The digest generating unit 15 uses the contents model stored in the model storage unit 13 to detect a scene in which the user is interested from the content stored in the contents storage unit 11 as a highlight scene. Subsequently, the digest generating unit 15 generates a digest in which highlight scenes are collected.

The scrapbook generating unit 16 uses the contents model stored in the model storage unit 13 to detect scenes in which the user is interested, and generates a scrapbook collected from the scenes thereof.

Note that generation of a digest by the digest generating unit 15, and generation of a scrapbook by the scrapbook generating unit 16 are common in that a scene in which the user is interested is detected as a result, but detection methods (algorithms) thereof differ.

Also, the recorder in FIG. 1 may be configured without providing the contents structure presenting unit 14 and the scrapbook generating unit 16 and so forth.

Specifically, for example, in the event that a learned contents model has already been stored in the model storage unit 13, the recorder may be configured without providing the contents model learning unit 12.

Also, for example, with regard to the contents structure presenting unit 14, digest generating unit 15, and scrapbook generating unit 16, the recorder may be configured by providing only one or two blocks of these.

Now, let us say that the data of the contents to be stored in the contents storage unit 11 includes an image, audio, and necessary text (subtitle) data (stream).

Also, now, let us say that of the data of the contents, only the data of an image is employed for contents model learning processing, and processing employing a contents model.

However, with the contents model learning processing, and the processing employing a contents model, the data of audio or text other than the data of an image may also be employed, and in this case, the precision of the processing can be improved.

Also, with the contents model learning processing, and the processing employing a contents model, only the data of audio may be employed instead of images.

Configuration Example of Contents Model Learning Unit 12

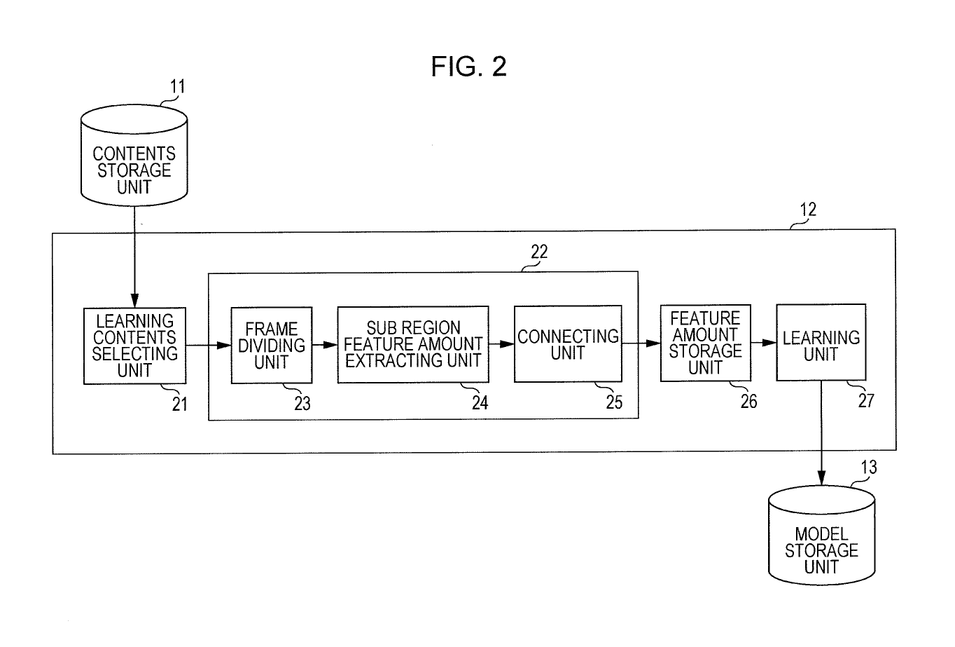

FIG. 2 is a block diagram illustrating a configuration example of the contents model learning unit 12 in FIG. 1.

The contents model learning unit 12 extracts the feature amount of each frame of the image of a content for learning that is a content to be used for learning of a state transition probability model stipulated by state transition probability that a state will proceed, and observation probability that a predetermined observation value will be observed from a state. Further, the contents model learning unit 12 uses the feature amount of a content for learning to perform learning of a state transition probability model.

Specifically, the contents model learning unit 12 is configured of a learning contents selecting unit 21, a feature amount extracting unit 22, a feature amount storage unit 26, and a learning unit 27.

The learning contents selecting unit 21 selects a content to be used for learning of a state transition probability model out of the contents stored in the contents storage unit 11 as a content for learning, and supplies to the feature amount extracting unit 22.

Here, the learning contents selecting unit 21 selects, for example, one or more contents belonging to a predetermined category out of the contents stored in the contents storage unit 11 as contents for learning.

The expression “contents belonging to a predetermined category” means that contents have a common structure hidden therein, for example, such as programs of the same genre, a series of programs, a program broadcast every week or every day or otherwise periodically (program of the same title), or the like.

What we might call rough classification, such as a sports program, news program, or the like, for example, may be employed as a genre, but what we might call fine classification, such as a program of a soccer game, a program of a baseball game, or the like, for example, is preferable.

Also, for example, a program of a soccer game may also be classified into a content belonging to a different category from one channel (broadcast station) to another.

Now, let us say that it has already been set in the recorder in FIG. 1 what kind of category is employed as the category of a content.

Also, the category of a content stored in the contents storage unit 11 can be recognized from, for example, meta data such as the genre or title of a program that is transmitted along with the program in television broadcasting, information of a program that a site on the Internet provides, and so forth.

The feature amount extracting unit 22 inversely multiplexes the content for learning from the learning contents selecting unit 21 to image data and audio data, extracts the feature amount of each frame of the image, and supplies to the feature amount storage unit 26.

Specifically, the feature amount extracting unit 22 is configured of a frame dividing unit 23, a sub region feature amount extracting unit 24, and a connecting unit 25.

Each frame of the image of the content for learning from the learning contents selecting unit 21 is supplied to the frame dividing unit 23 in time sequence.

The frame dividing unit 23 sequentially takes the frame of the content for learning supplied in time sequence from the learning contents selecting unit 21 as the frame of interest. Subsequently, the frame dividing unit 23 divides the frame of interest into sub regions that are multiple small regions, and supplies to the sub region feature amount extracting unit 24.

The sub region feature amount extracting unit 24 extracts from each sub region of the frame of interest from the frame dividing unit 23 the feature amount of the sub region thereof (hereafter, also referred to as “sub region feature amount”), and supplies to the connecting unit 25.

The connecting unit 25 combines the sub region feature amount of the sub regions of the frame of interest from the sub region feature amount extracting unit 24, and supplies the combined result to the feature amount storage unit 26 as the feature amount of the frame of interest.

The feature amount storage unit 26 stores the feature amount of each frame of the content for learning supplied from (the connecting unit 25 of) the feature amount extracting unit 22 in time sequence.

The learning unit 27 uses the feature amount of each frame of the content for learning stored in the feature amount storage unit 26 to perform learning of a contents model.

Specifically, the learning unit 27 uses the feature amount (vector) of each frame of the content for learning stored in the feature amount storage unit 26 to perform cluster learning for dividing feature amount space that is the space of the feature amount thereof into multiple clusters, and obtains cluster information that is the information of clusters.

Here, as for the cluster learning, for example, the k-means method may be employed. In the event of employing the k-means method as the cluster learning, cluster information obtained as a result of the cluster learning becomes a code book in which a representative vector representing clusters in the feature amount space, and code representing the cluster that the representative vector thereof represents are correlated.

Note that, with the k-means method, the representative vector of the cluster of interest becomes the mean value (vector) of the feature amount belonging to the cluster of interest (of distance (Euclidean distance) with each representative vector of the code book, the feature amount of which the distance as to the representative vector of the cluster of interest is the shortest) of the feature amount (vectors) of the content for learning.

The learning unit 27 further uses the cluster information obtained from the content for learning to subject the feature amount of each frame of the content for learning stored in the feature amount storage unit 26 to clustering to any one cluster of the multiple clusters, thereby obtaining code representing the cluster to which the feature amount thereof belongs, thereby converting the time sequence of the feature amount of the content for learning into a code sequence (obtains the code sequence of the content for learning).

Here, in the event of employing the k-means method as the cluster learning, clustering to be performed using the code book serving as the cluster information obtained as the cluster learning thereof becomes vector quantization.

With the vector quantization, the distance as to the feature amount (vector) regarding each of the representative vectors of the code book is calculated, the code of the representative vector of which the distance thereof is the minimum is output as the vector quantization result.

Upon subjecting the time sequence of the feature amount of the content for learning to clustering to be converted into a code sequence, the learning unit 27 uses the code sequence thereof to perform model learning that is learning of a state transition model.

Subsequently, the learning unit 27 supplies a set of the state transition probability model after the model learning, and the cluster information obtained by the cluster learning to the model storage unit 13 as a contents model in a manner correlated with the category of the content for learning.

Accordingly, the contents model is made up of the state transition probability model and the cluster information.

Here, the state transition probability model (the state transition probability model of which the learning is performed using the code sequence) making up the contents model will also be referred to as a code model below.

State Transition Probability Model

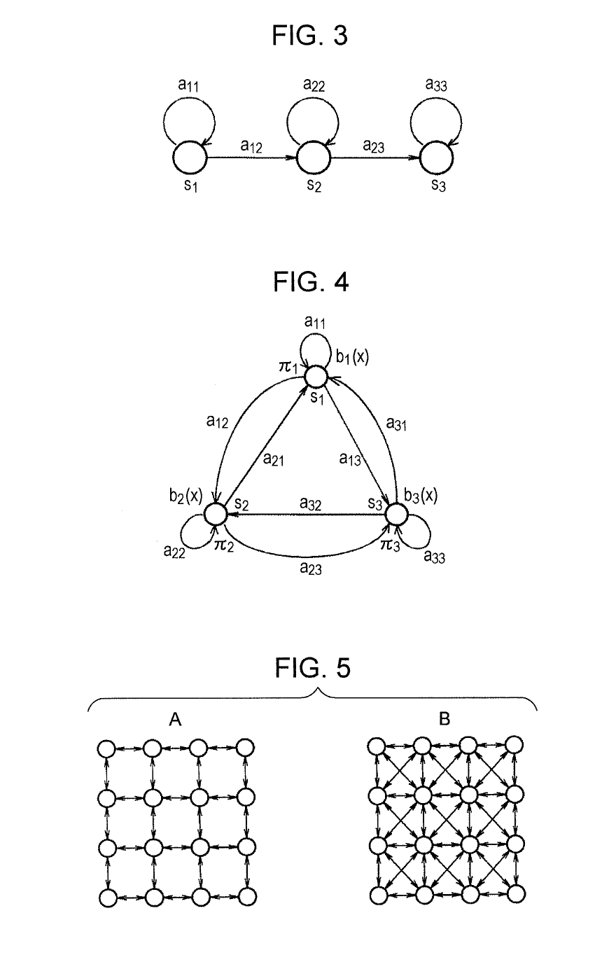

Description will be made regarding the state transition probability model that the learning unit 27 in FIG. 2 learns, with reference to FIG. 3 through FIG. 6.

As for the state transition probability model, for example, an HMM (Hidden Marcov Model) may be employed. In the event of employing an HMM as the state transition probability model, learning of an HMM is performed, for example, by the Baum-Welch re-estimation method.

FIG. 3 is a diagram illustrating an example of a left-to-right type HMM.

The left-to-right type HMM is an HMM where states are arrayed on a straight line from the left to the right direction, and can perform self transition (transition from a certain state to the state thereof), and transition from a certain state to a state positioned on the right side of the state thereof. The left-to-right type HMM is employed for audio recognition or the like, for example.

The HMM in FIG. 3 is made up of three states s₁, s₂, and s₃, and is allowed to perform self transition, and transition from a certain state to a state right-adjacent thereto as state transition.

Note that the HMM is stipulated by the initial probability πᵢ of the state sᵢ, state transition probability aᵢⱼ, and observation probability bᵢ(o) that a predetermined observation value o will be observed from the state sᵢ.

Here, the initial probability πᵢ is probability that the state sᵢ is the initial state (first state), and with the left-to-right type HMM, the initial probability πᵢ of the state sᵢ on the leftmost side is set to 1.0, and the initial probability πᵢ of another state sᵢ is set to 0.0.

The state transition probability aᵢⱼ is probability that transition will be made from the state sᵢ to state sⱼ.

The observation probability bᵢ(o) is probability that the observation value o will be observed from the state sᵢ at the time of state transition to the state sᵢ. As for the observation probability bᵢ(o), in the event that the observation value o is a discrete value, a value serving as probability (discrete value) is employed, but in the event that the observation value o is a continuous value, a probability distribution function is employed. As for the probability distribution function, for example, a Gaussian distribution defined by a mean value (mean vector) and dispersion (covariance matrix), or the like may be employed. Note that, with the present embodiment, a discrete value is employed as the observation value o.

FIG. 4 is a diagram illustrating an example of an Ergodic type HMM.

The Ergodic type HMM is an HMM with no constraint regarding state transition, i.e., an HMM capable of state transition from an arbitrary state sᵢ to an arbitrary state sⱼ.

The HMM in FIG. 4 is made up of three states s₁, s₂, and s₃, and is allowed to perform arbitrary state transition.

The Ergodic type HMM is an HMM wherein the flexibility of state transition is the highest, but in the event that the number of states is great, may converge on the local minimum depending on the initial values of the parameters (initial probability πᵢ, state transition probability aᵢⱼ, observation probability bᵢ(o)) of the HMM, which prevents suitable parameters from being obtained.

Therefore, we will employ the hypothesis that “most phenomena in nature, and camera work or program configuration creating a video content, can be represented with a sparse connection such as a small world network”, and employ an HMM wherein state transition is restricted to a sparse structure for learning at the learning unit 27.

Here, a sparse configuration is not a density state transition such as the Ergodic type HMM whereby state transition from a certain state to an arbitrary state can be made, but a configuration wherein a state to which state transition can be made from a certain state is extremely restricted (structure of sparse state transition).

Now, let us say that even with a sparse structure, there is at least one state transition to another state, and also there is self transition.

FIG. 5 is a diagram illustrating an example of a two-dimensional neighborhood restraint HMM that is an HMM having a sparse structure.

With the HMMs in A in FIG. 5 and B in FIG. 5, in addition to the HMMs having a sparse structure, restraint is imposed wherein states making up an HMM are disposed in a grid shape on a two-dimensional plane.

Here, with the HMM in A in FIG. 5, state transition to another state is restricted to a horizontally adjacent state, and a vertically adjacent state. With the HMM in B in FIG. 5, state transition to another state is restricted to a horizontally adjacent state, a vertically adjacent state, and an obliquely adjacent state.

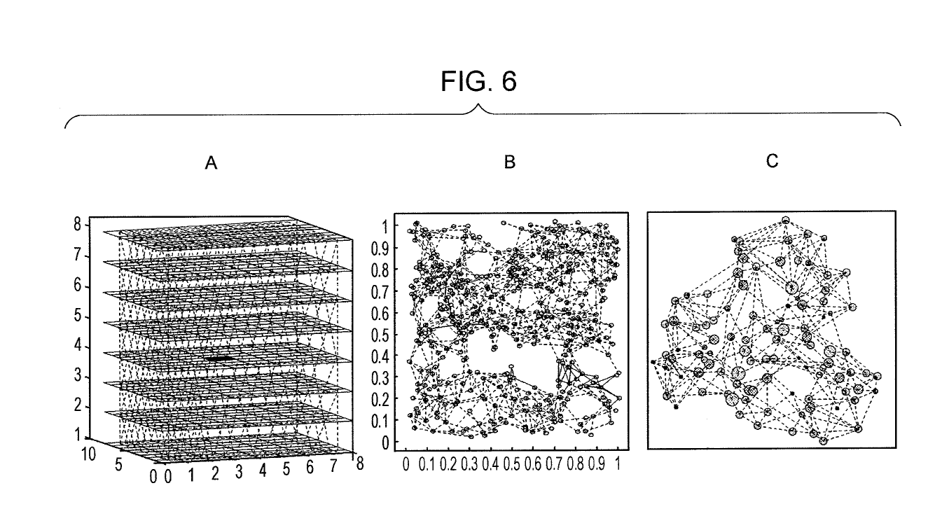

FIG. 6 is a diagram illustrating an example of an HMM having a sparse structure other than a two-dimensional neighborhood restraint HMM.

Specifically, A in FIG. 6 illustrates an example of an HMM according to three-dimensional grid constraints. B in FIG. 6 illustrates an example of an HMM according to two-dimensional random relocation constraints. C in FIG. 6 illustrates an example of an HMM according to a small world network.

With the learning unit 27 in FIG. 2, learning of an HMM having a sparse structure illustrated in FIG. 5 and FIG. 6 made up of, for example, 100 through several hundred states is performed by the Baum-Welch re-estimation method using the code sequence of the feature amount (extracted from frames) of an image stored in the feature amount storage unit 26.

The HMM that is a code model obtained as learning results at the learning unit 27 is obtained by learning using only the feature amount of the image (Visual) of a content, and accordingly may be referred to as a Visual HMM.

Here, the code sequence of the feature amount, which is used for learning of an HMM (model learning), is a discrete value, and as for the observation probability bᵢ(o) of the HMM, a value serving as probability is employed.

Note that, an HMM is described in, for example, “Fundamentals of Speech Recognition (First and Second), NTT ADVANCED TECHNOLOGY CORPORATION” co-authored by Laurence Rabiner and Biing-Hwang Juang, and Japanese Patent Application No. 2008-064993 previously proposed by the present applicant. Also, use of the Ergodic type HMM or an HMM having a sparse structure is described in, for example, Japanese Unexamined Patent Application Publication No. 2009-223444 previously proposed by the present applicant.

Extraction of Feature Amount

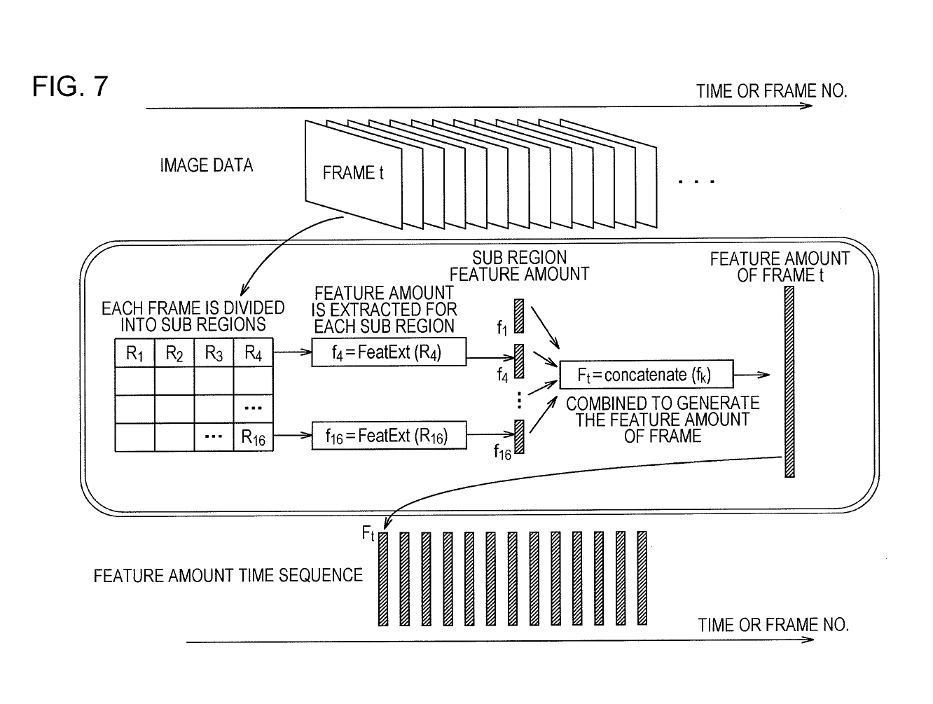

FIG. 7 is a diagram for describing feature amount extraction processing by the feature amount extracting unit 22 in FIG. 2.

With the feature amount extracting unit 22, each frame of the image of the content for learning from the learning contents selecting unit 21 is supplied to the frame dividing unit 23 in time sequence.

The frame dividing unit 23 sequentially takes the frame of the content for learning supplied in time sequence from the learning contents selecting unit 21 as the frame of interest, divides the frame of interest into multiple sub regions Rₖ, and supplies to the sub region feature amount extracting unit 24.

Here, in FIG. 7, the frame of interest is equally divided into 16 sub regions R₁, R₂, . . . , R₁₆ where horizontal×vertical is 4×4.

Note that the number of sub regions Rₖ at the time of dividing one frame into sub regions Rₖ is not restricted to 16 of 4×4. Specifically, one frame can be divided into, for example, 20 sub regions Rₖ of 5×4, 25 sub regions Rₖ of 5×5, or the like.

Also, in FIG. 7, one frame is divided (equally divided) into the sub regions Rₖ having the same size, but the sizes of the sub regions may not be the same. Specifically, for example, an arrangement may be made wherein the center portion of a frame is divided into sub regions having a small size, and the peripheral portions (portions adjacent to the image frame, etc.) of the frame are divided into sub regions having a great size.

The sub region feature amount extracting unit 24 (FIG. 2) extracts the sub region feature amount fₖ=FeatExt(Rₖ) of each sub region Rₖ of the frame of interest from the frame dividing unit 23, and supplies to the connecting unit 25.

Specifically, the sub region feature amount extracting unit 24 uses the pixel values (e.g., RGB components, YUV components, etc.) of the sub region Rₖ to obtain the global feature amount of the sub region Rₖ as the sub region feature amount fₖ.

Here, the above “global feature amount of the sub region Rₖ” means feature amount, for example, such as a histogram, which is calculated in an additive manner using only the pixel values without using the information of the positions of the pixels making up the sub region Rₖ.

As for the global feature amount, a feature amount called GIST may be employed, for example. The details of the GIST is described in, for example, A. Torralba, K. Murphy, W. Freeman, M. Rubin, “Context-based vision system for place and object recognition”, IEEE Int. Conf. Computer Vision, vol. 1, no. 1, pp. 273-280, 2003.

Note that the global feature amount is not restricted to the GIST. Specifically, the global feature amount should be (robust) feature amount, which is robust with regard to visual change such as local position, luminosity, viewpoint, and so forth (so as to absorb change). Examples of such feature amount include HLAC (Higher-order Local Auto-Correlation), LBP (Local Binary Patterns), and color histogram.

The details of the HLAC is described in, for example, N. Otsu, T. Kurita, “A new scheme for practical flexible and intelligent vision systems”, Proc. IAPR Workshop on Computer Vision, pp. 431-435, 1988. The details of the LBP is described in, for example, Ojala T, Pietikainen M & Maenpaa T, “Multiresolution gray-scale and rotation invariant texture classification with Local Binary Patterns”, IEEE Transactions on Pattern Analysis and Machine Intelligence 24(7): 971-987 (the “a” in Pietikainen and Maenpaa is more accurately a character wherein “\ddot{}” is added above an “a”).

Here, the global feature amount such as the above GIST, LBP, HLAC, color histogram, and so forth has a tendency that the number of dimensions is great, and also has a tendency that correlation between dimensions is high.

Therefore, the sub region feature amount extracting unit 24 (FIG. 2) may perform, after extracting the GIST or the like from the sub regions Rₖ, principal component analysis (PCA (Principal Component Analysis)) such as the GIST thereof or the like. Subsequently, with the sub region feature amount extracting unit 24, the number of dimensions such as the GIST or the like is compressed (restricted) so that an accumulated contribution rate becomes a high value to some extent (e.g., value equal to or greater than 95% or the like) based on the results of the PCA, and the compression result may be taken as sub region feature amount.

In this case, a projective vector projected in PCA space where the number of dimensions such as the GIST or the like is compressed becomes a compression result wherein the number of dimensions such as the GIST or the like is compressed.

The connecting unit 25 (FIG. 2) connects the sub region feature amount f₁ through f₁₆ of the sub regions R₁ through R₁₆ of the frame of interest from the sub region feature amount extracting unit 24, and supplies the connection result thereof to the feature amount storage unit 26 as the feature amount of the frame of interest.

Specifically, the connecting unit 25 generates a vector with the sub region feature amount f₁ through f₁₆ as components by connecting the sub region feature amount f₁ through f₁₆ from the sub region feature amount extracting unit 24, and supplies the vector thereof to the feature amount storage unit 26 as feature amount Fₜ of the frame of interest.

Here, in FIG. 7, the frame (frame t) at point-in-time t is the frame of interest. The “point-in-time t” is point-in-time with the head of a content as a reference for example, and with the present embodiment, the frame at the point-in-time t means the t'th frame from the head of the content.

With the feature amount extracting unit 22 in FIG. 2, each frame of a content for learning is sequentially taken from the head as the frame of interest, and the feature amount Fₜ is obtained as described above. Subsequently, the feature amount Fₜ of each frame of the content for learning is supplied and stored from the feature amount extracting unit 22 to the feature amount storage unit 26 in time sequence (in a state in which temporal context is maintained).

As described above, with the feature amount extracting unit 22, the global feature amount of the sub regions Rₖ is obtained as sub region feature amount fₖ, and a vector with the sub region feature amount fₖ as components is obtained as the feature amount Fₜ of the frame.

Accordingly, the feature amount Fₜ of the frame is robust against local change (change that occurs within the sub regions), but becomes feature amount that is discriminative (property for perceptively distinguishing difference) against change in the layout of patterns serving as the entire frame.

According to such feature amount Fₜ, the similarity of a scene (content) between frames may suitably be determined. For example, a scene of “beach” is satisfied as long as it includes “sky” on the upper side of the frame, “sea” in the middle, and “beach” on the lower side of the screen, and accordingly, at what part of the “beach” a person exists, in what part of the “sky” a cloud exists, or the like, has no bearing on whether or not the scene is a scene of a “beach”. The feature amount Fₜ is adapted to determine the similarity of a scene (to classify a scene) from such a viewpoint.

Contents Model Learning Processing

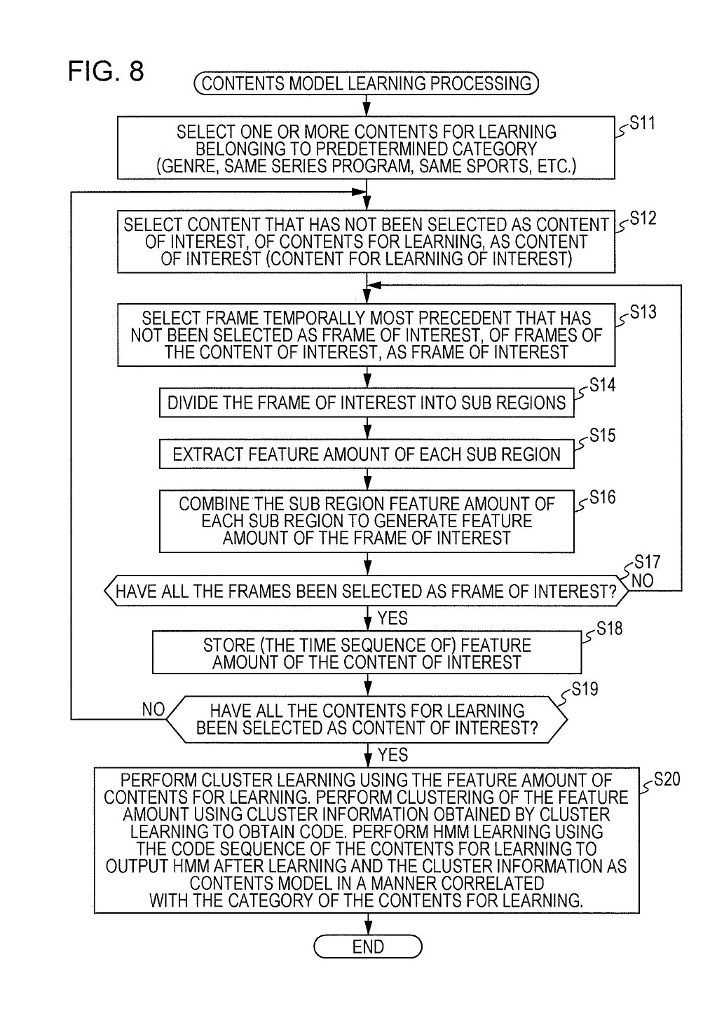

FIG. 8 is a flowchart for describing the processing (contents model learning processing) that the contents model learning unit 12 in FIG. 2 performs.

In step S11, the learning contents selecting unit 21 selects one or more contents belonging to a predetermined category out of the contents stored in the contents storage unit 11 as contents for learning.

Specifically, for example, the learning contents selecting unit 21 selects an arbitrary content that has not been selected as a content for learning yet out of the contents stored in the contents storage unit 11 as a content for learning.

Further, the learning contents selecting unit 21 recognizes the category of the one content selected as a content for learning, and in the event that another content belonging to the category thereof is stored in the contents storage unit 11, further selects the content thereof (the other content) as a content for learning.

The learning contents selecting unit 21 supplies the content for learning to the feature amount extracting unit 22, and the processing proceeds from step S11 to step S12.

In step S12, the frame dividing unit 23 of the feature amount extracting unit 22 selects one of the contents for learning that has not been selected as the content for learning of interest (hereafter, also referred to as “content of interest”) out of the contents for learning from the learning contents selecting unit 21, as the content of interest.

Subsequently, the processing proceeds from step S12 to step S13, where the frame dividing unit 23 selects a temporally most preceding frame that has not been selected as the frame of interest, out of the frames of the content of interest, as the frame of interest, and the processing proceeds to step S14.

In step S14, the frame dividing unit 23 divides the frame of interest into multiple sub regions, and supplies to the sub region feature amount extracting unit 24, and the processing proceeds to step S15.

In step S15, the sub region feature amount extracting unit 24 extracts the sub region feature amount of each of the multiple sub regions from the frame dividing unit 23, and supplies to the connecting unit 25, and the processing proceeds to step S16.

In step S16, the connecting unit 25 generates the feature amount of the frame of interest by connecting the sub region feature amount of each of the multiple sub regions making up the frame of interest from the sub region feature amount extracting unit 24, and the processing proceeds to step S17.

In step S17, the frame dividing unit 23 determines whether or not all the frames of the content of interest have been selected as the frame of interest.

In the event that determination is made in step S17 that there is a frame in the frames of the content of interest that has not been selected as the frame of interest, the processing returns to step S13, and hereafter, the same processing is repeated.

Also, in the event that determination is made in step S17 that all the frames of the content of interest have been selected as the frame of interest, the processing proceeds to step S18, where the connecting unit 25 supplies and stores (the time sequence of) the feature amount of each frame of the content of interest obtained regarding the content of interest to the feature amount storage unit 26.

Subsequently, the processing proceeds from step S18 to step S19, where the frame dividing unit 23 determines whether or not all the contents for learning from the learning contents selecting unit 21 have been selected as the content of interest.

In the event that determination is made in step S19 that, of the contents for learning, there is a content for learning that has not been selected as the content of interest, the processing returns to step S12, and hereafter, the same processing is repeated.

Also, in the event that determination is made in step S19 that all the contents for learning have been selected as the content of interest, the processing proceeds to step S20, where the learning unit 27 uses the feature amount of the contents for learning (time sequence of the feature amount of each frame) stored in the feature amount storage unit 26 to perform learning of a contents model.

Specifically, the learning unit 27 uses the feature amount (vector) of each frame of the content for learning stored in the feature amount storage unit 26 to perform cluster learning for dividing the feature amount space that is the space of the feature amount thereof into multiple clusters by the k-means method to obtain a code book of a hundred through several hundreds of clusters (representative vectors) serving as a predetermined number, as cluster information, for example.

Further, the learning unit 27 uses the code book serving as the cluster information obtained by cluster learning to perform vector quantization for subjecting the feature amount of each frame of the content for learning stored in the feature amount storage unit 26 to clustering, and converts the time sequence of the feature amount of the content for learning into a code sequence.

Upon converting the time sequence of the feature amount of the content for learning into a code sequence by clustering, the learning unit 27 uses the code sequence thereof to perform model learning that is learning of an HMM (discrete HMM).

Subsequently, the learning unit 27 outputs (supplies) a set of a code model that is an HMM after model learning, a code book serving as cluster information obtained by cluster learning to the model storage unit 13 as a contents model in a manner correlated with the category of the content for learning, and ends the contents model learning processing.

Note that the contents model learning processing may be started at an arbitrary timing.

According to the above contents model learning processing, with an HMM that is a code model, the structure of a content (e.g., configuration created by a program configuration, camera work, etc.) hidden in a content for learning is acquired in a self-organized manner.

As a result thereof, each state of the HMM serving as a code model in the contents model obtained by the contents model learning processing corresponds to an element of the structure of the content acquired by learning, and state transition expresses temporal transition between the elements of the structure of the content.

Subsequently, the state of the contents model expresses a frame group having near spatial distance, and also similar temporal context in feature amount space (the space of the feature amount extracted at the feature amount extracting unit 22 (FIG. 2)) (i.e., “similar scenes”) in a collective manner.

Here, for example, in the event that the content is a quiz program, roughly, the flow of setting of a quiz, presentation of a hint, an answer by a performer, and a correct answer announcement, is taken as the basic flow of a program, and the quiz program advances by repeating this basic flow.

The above basic flow of a program is equivalent to the structure of a content, and each of setting of a quiz, presentation of a hint, an answer by a performer, and a correct answer announcement is equivalent to an element of the structure of the content.

Also, for example, advancement from setting of a quiz to presentation of a hint, or the like is equivalent to temporal transition between the elements of the structure of the content.

Configuration Example of Contents Structure Presenting Unit 14

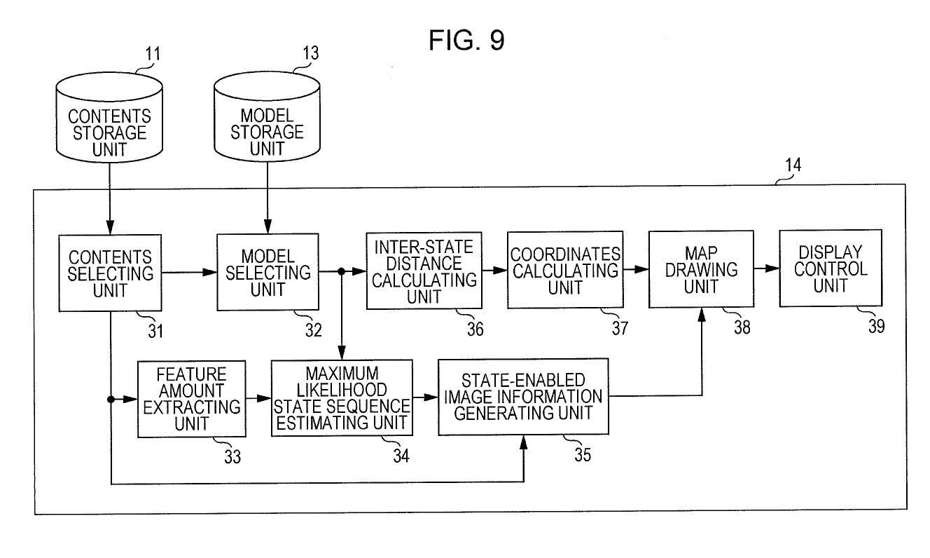

FIG. 9 is a block diagram illustrating a configuration example of the contents structure presenting unit 14 in FIG. 1.

As described above, (an HMM that is the code model of) the contents model acquires the structure of a content hidden in a content for learning, but the contents structure presenting unit 14 presents the structure of the content thereof to the user in a visual manner.

Specifically, the contents structure presenting unit 14 is configured of a contents selecting unit 31, a model selecting unit 32, a feature amount extracting unit 33, a maximum likelihood state sequence estimating unit 34, a state-enabled image information generating unit 35, a inter-state distance calculating unit 36, a coordinates calculating unit 37, a map drawing unit 38, and a display control unit 39.

The contents selecting unit 31 selects a content, out of the contents stored in the contents storage unit 11, of which the structure is to be visualized, as the content for presentation of interest (hereafter, also simply referred to as “content of interest”), for example, according to the user's operations or the like.

Subsequently, the contents selecting unit 31 supplies the content of interest to the feature amount extracting unit 33 and state-enabled image information generating unit 35. Also, the contents selecting unit 31 recognizes the category of the content of interest, and supplies to the model selecting unit 32.

The model selecting unit 32 selects a contents model of the category matching the category of the content of interest (the contents model correlated with the category of the content of interest), from the contents selecting unit 31, out of the contents models stored in the model storage unit 13 as the model of interest.

Subsequently, the model selecting unit 32 supplies the model of interest to the maximum likelihood state sequence estimating unit 34 and inter-state distance calculating unit 36.

The feature amount extracting unit 33 extracts the feature amount of each frame of (the image of) the content of interest supplied from the contents selecting unit 31 in the same way as with the feature extracting unit 22 in FIG. 2, and supplies (the time sequence of) the feature amount of each frame of the content of interest to the maximum likelihood state sequence estimating unit 34.

The maximum likelihood state sequence estimating unit 34 uses the cluster information of the model of interest from the model selecting unit 32 to subject (the time sequence of) the feature amount of the content of interest from the feature amount extracting unit 33 to clustering, and obtains the code sequence (of the feature amount) of the content of interest.

The maximum likelihood state sequence estimating unit 34 estimates the maximum likelihood state sequence (the sequence of states making up a so-called Viterbi path) that is a state sequence causing state transition where likelihood is the highest that the code sequence (of the feature amount) of the content of interest from the feature amount extracting unit 33 will be observed in the code model of the model of interest from the model selecting unit 32, for example, in accordance with the Viterbi algorithm.

Subsequently, the maximum likelihood state sequence estimating unit 34 supplies the maximum likelihood state sequence (hereafter, also referred to as “the maximum likelihood state sequence of the model of interest corresponding to the content of interest”) in the event that the code sequence of the content of interest is observed in the code model of the model of interest (hereafter, also referred to as “code model of interest”) to the state-enabled image information generating unit 35.

Now, let us say that the state of point-in-time t with the head of the maximum likelihood state sequence of the code model of interest as to the content of interest as a reference (the t'th state from the top, making up the maximum likelihood state sequence) is represented as s(t), and also the number of frames of the content of interest is represented as T.

In this case, the maximum likelihood state sequence of the code model of interest as to the content of interest is the sequence of T states s(1), s(2), . . . , s(T), and the t'th state thereof (state at point-in-time t) s(t) corresponds to the frame at the point-in-time t (frame t) of the content of interest.

Also, if we say that the total of the states of the code model of interest is represented as N, the state s(t) at the point-in-time t is one of N states s₁, s₂, . . . , s_{N}.

Further, each of the N states s₁, s₂, . . . , s_{N} is appended with a state ID (Identification) that is an index for determining a state.

Now, if we say that the state s(t) at point-in-time t of the maximum likelihood state sequence of the code model of interest as to the content of interest is the i'th state sᵢ of N states s₁ through s_{N}, the frame at the point-in-time t corresponds to the state sᵢ.

Accordingly, each frame of the content of interest corresponds of one of the N states s₁ through s_{N}.

The entity of the maximum likelihood state sequence of the code model of interest as to the content of interest is the sequence of the state ID of one state of the N states sᵢ through s_{N}, corresponding to the frame of each point-in-time t of the content of interest.

The maximum likelihood state sequence of the code model of interest as to the content of interest as described above expresses what kind of state transition the content of interest causes on the code model of interest.

The state-enabled image information generating unit 35 selects the frame corresponding to the same state out of the content of interest from the contents selecting unit 31 for each state ID of the states making up the maximum likelihood state sequence (sequence of state IDs) from the maximum likelihood state sequence estimating unit 34.

Specifically, the state-enabled image information generating unit 35 sequentially selects the N states s₁ through s_{N} of the code model of interest as the state of interest.

Now, if we say that the state sᵢ of which the state ID is #i has been selected as the state of interest, the state-enabled image information generating unit 35 retrieves the state matching the state of interest (state of which the state ID is #i) out of the maximum likelihood state sequence, and stores the frame corresponding to the state thereof in a manner correlated with the state ID of the state of interest.

Subsequently, the state-enabled image information generating unit 35 processes the frame correlated with the state ID to generate image information corresponding to the state ID thereof (hereafter, also referred to as “state-enabled image information”), and supplies to the map drawing unit 38.

Here, as for the state-enabled image information, for example, still images where the thumbnails of one or more frames correlated with the state ID are disposed in the time sequential order (image sequence), moving images (movies) where one or more frames correlated with the state ID are reduced and arrayed in the time sequential order, or the like may be employed.

Note that the state-enabled image information generating unit 35 generates no (cannot generate) state-enabled image information regarding the state ID of a state not appearing in the maximum likelihood state sequence out of the state IDs of the N states s₁ through s_{N} of the code model of interest.

The inter-state distance calculating unit 36 obtains inter-state distance dᵢⱼ* from one state sᵢ to another state sⱼ of the code model of interest from the model selecting unit 32 based on the state transition probability aᵢⱼ from one state sᵢ to another state sⱼ. Subsequently, after obtaining the inter-state distance dᵢⱼ* from an arbitrary state sᵢ to an arbitrary state sⱼ of the N states of the code model of interest, the inter-state distance calculating unit 36 supplies a matrix with N rows by N columns (inter-state distance matrix) with the inter-state distance dᵢⱼ* as components to the coordinates calculating unit 37.

Now, let us say that, for example, in the event that the state transition probability aᵢⱼ is greater than a predetermined threshold (e.g., (1/N)×10₋₂), the inter-state distance calculating unit 36 sets the inter-state distance dᵢⱼ to, for example, 0.1 (small value), and in the event that the state transition probability aᵢⱼ is equal to or smaller than the predetermined threshold, sets the inter-state distance dᵢⱼ* to, for example, 1.0 (great value).

The coordinates calculating unit 37 obtains state coordinates Yi that are the coordinates of the position of the state sᵢ on the model map so as to reduce error between Euclidean distance dᵢⱼ from one state sᵢ to another state sⱼ on the model map that is a two-dimensional or three-dimensional map where the N states s₁ through s_{N} of the code model of interest are disposed, and the inter-state distance dᵢⱼ* of the inter-state distance matrix from the inter-state distance calculating unit 36.

Specifically, the coordinates calculating unit 37 obtains the state coordinates Yi so as to minimize a Sammon Map error function E in proportional to statistical error between the Euclidean distance dᵢⱼ and the inter-state distance dᵢⱼ*.

Here, the Sammon Map is one of multidimensional scaling methods, and the details thereof are described in, for example, J. W. Sammon, JR., “A Nonlinear Mapping for Data Structure Analysis”, IEEE Transactions on Computers, vol. C-18, No. 5, May 1969.

With the Sammon Map, for example, state coordinates Yᵢ=(xᵢ, yᵢ) on the model map that is a two-dimensional map is obtained so as to minimize the error function E of Expression (1).

$$E = \frac{1}{{\sum }_{i < j} [ {d}_{ij}^{*} ]} {\sum }_{i < j}^{N} \frac{{[ {d}_{ij}^{*} - {d}_{ij} ]}^{2}}{{d}_{ij}^{*}} \qquad ( 1 )$$

Here, in Expression (1), N represents the total number of the states of the code model of interest, and i and j are state indexes that take an integer value in a range of 1 through N (and also serve as state IDs in the present embodiment).

dᵢⱼ* represents an element in the i'th row the j'th column of the inter-state distance matrix, and represents inter-state distance from the state sᵢ to the state sⱼ. dᵢⱼ represents Euclidean distance between the coordinates (state coordinates) Yᵢ of the position of the state Sᵢ, and the coordinates Yⱼ of the position of the state Sⱼ on the model map.

The coordinates calculating unit 37 obtains the state coordinates Yᵢ (i=1, 2, . . . , N) by repetitive application of a gradient method so as to minimize the error function E in Expression (1), and supplies to the map drawing unit 38.

The map drawing unit 38 draws (the graphics of) the model map where (the image of) the corresponding state sᵢ is disposed in the state coordinates Yᵢ from the coordinates calculating unit 37. Also, the map drawing unit 38 draws the segment of a line connecting between states on the model map according to the state transition probability between the states thereof.

Further, the map drawing unit 38 links the state sᵢ on the model map with the state-enabled image information corresponding to the state ID of the state sᵢ, of the state-enabled image information from the state-enabled image information generating unit 35, and supplies to the display control unit 39.

The display control unit 39 performs display control for displaying the model map from the map drawing unit 38 on an unshown display.

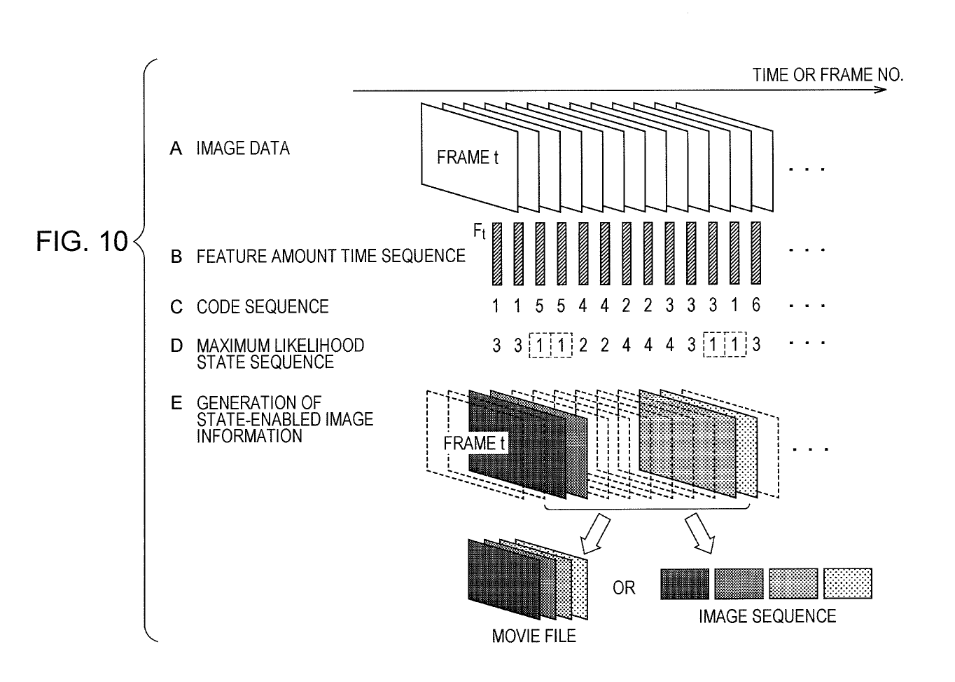

FIG. 10 is a diagram for describing the outline of the processing (contents structure presentation processing) that the contents structure presenting unit 14 in FIG. 9 performs.

A in FIG. 10 illustrates the time sequence of the frames of the content selected as the content of interest (content for presentation of interest) at the contents selecting unit 31.

B in FIG. 10 illustrates the time sequence of the feature amount of the time sequence of the frames in A in FIG. 10 extracted at the feature amount extracting unit 33.

C in FIG. 10 illustrates a code sequence obtained by subjecting the time sequence of the feature amount in B in FIG. 10 to clustering at the maximum likelihood state sequence estimating unit 34.

D in FIG. 10 illustrates the maximum likelihood state sequence that the code sequence of (the time sequence of the feature amount of) the content of interest in C in FIG. 10 will be observed in the code model of interest (the maximum likelihood state sequence of the code model of interest as to the content of interest), estimated at the maximum likelihood state sequence estimating unit 34.

Here, the entity of the maximum likelihood state sequence of the code model of interest as to the content of interest is, as described above, the sequence of state IDs. Subsequently, the t'th state ID from the head of the maximum likelihood state sequence of the code model of interest as to the content of interest is the state ID of a state where (probability is high that) the code of the feature amount of the t'th frame (at point-in-time t) of the content of interest (the state ID of the state corresponding to the frame t) will be observed in the maximum likelihood state sequence.

E in FIG. 10 illustrates the state-enabled image information to be generated at the state-enabled image information generating unit 35.

In E in FIG. 10, with the maximum likelihood state sequence in D in FIG. 10, a frame corresponding to a state of which the state ID is “1” is selected, and a movie or image sequence serving as the state-enabled image information as to the state ID thereof is generated.

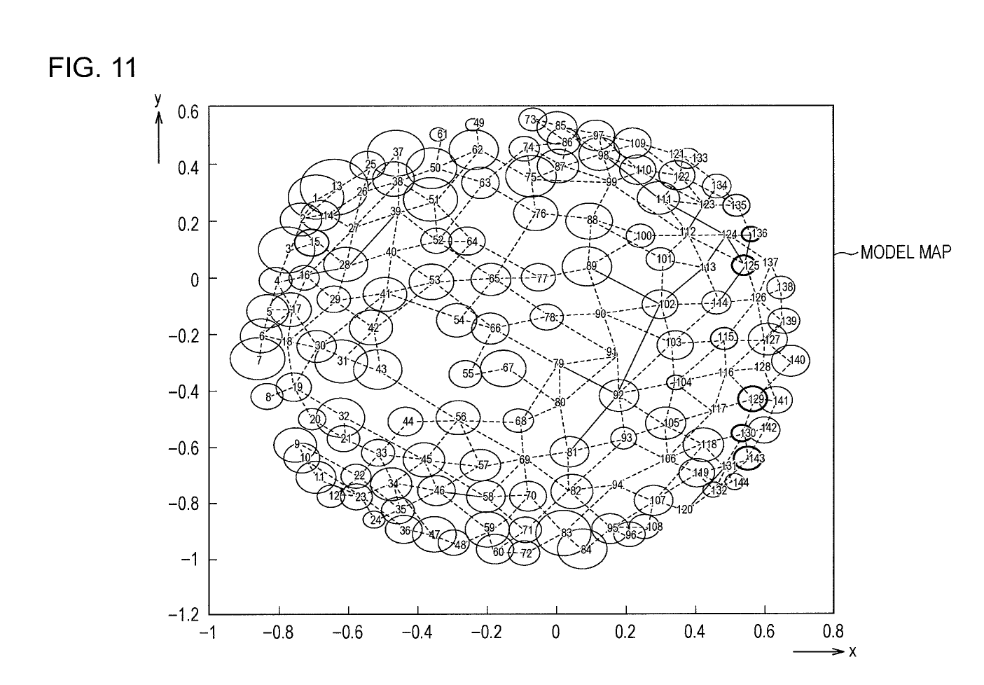

FIG. 11 is a diagram illustrating an example of a model map to be drawn by the map drawing unit 38 in FIG. 9.

With the model map in FIG. 11, an ellipse represents a state, and the segment of a line connecting between ellipses (dotted line) represents state transition. Also, a numeral provided to an ellipse represents the state ID of the state represented by the ellipse thereof.

The model map drawing unit 38 draws, as described above, (the graphics of) a model map where (the image (ellipse in FIG. 11) of) the corresponding state sᵢ is disposed in the position of the state coordinates Yᵢ obtained at the coordinates calculating unit 37.

Further, the map drawing unit 38 draws the segment of a line connecting between states on the model map according to the state transition probability between states thereof. Specifically, in the event that the state transition probability from a state sᵢ to another state sⱼ on the model map is greater than a predetermined threshold, the map drawing unit 38 draws the segment of a line connecting between the state sᵢ and sⱼ thereof.

Here, with the model map, states and so forth may be drawn in an emphasized manner.

Specifically, with the model map in FIG. 11, the state sᵢ is drawn with an ellipse (including a circle) or the like, but the ellipse or the like representing this state sᵢ may be drawn, for example, by changing its radius or color according to the maximum value of the observation probability bⱼ(o) of the state sᵢ thereof, or the like.

Also, the segment of a line connecting between states on the model map according to the state transition probability between the states thereof may be drawn by changing the width or color of the segment of the line according to the size of the state transition probability.

Note that a method for drawing states and so forth in an emphasized manner is not restricted to drawing as described above. Further, emphasis on states or the like may not be typically performed.

Incidentally, with the coordinates calculating unit 37 in FIG. 9, in the event that the error function E in Expression (1) is employed as is, and the state coordinates Yᵢ on the model map is obtained so as to minimize the error function E, (the ellipses representing) the states are disposed in a circular pattern on the model map, as illustrated in FIG. 11.

Subsequently, in this case, states are concentrated in the vicinity (outside) (outer edge) of the circumference of the model map, which prevents the user from viewing the locations of the states, and as if it were, visibility may be diminished.

Therefore, with the coordinates calculating unit 37 in FIG. 9, the state coordinates Y₁ on the model map may be obtained so as to correct the error function E in Expression (1) to minimize the error function E after correction.

Specifically, the coordinates calculating unit 37 determines whether or not the Euclidean distance dᵢⱼ is greater than a predetermined threshold THd (e.g., THd=1.0 or the like).

Subsequently, in the event that the Euclidean distance dᵢⱼ is not greater than the predetermined threshold THd, with calculation of the error function in Expression (1), the coordinates calculating unit 37 employs the Euclidean distance dᵢⱼ thereof as the Euclidean distance dᵢⱼ as is.

On the other hand, in the event that the Euclidean distance dᵢⱼ is greater than the predetermined threshold THd, with calculation of the error function in Expression (1), the coordinates calculating unit 37 employs the inter-state distance dᵢⱼ*(let us say that dᵢⱼ=dᵢⱼ*) as the Euclidean distance dᵢⱼ (the Euclidean distance dᵢⱼ is set to distance equal to the inter-state distance dᵢⱼ*).

In this case, with the model map, when paying notice to two states sᵢ and sⱼ of which the Euclidean distance dᵢⱼ is near to some extent (not greater than the threshold THd), the state coordinates Yᵢ and Yⱼ are changed so as to match the Euclidean distance dᵢⱼ with the inter-state distance dᵢⱼ* (so that the Euclidean distance dᵢⱼ approximates the inter-state distance dᵢⱼ*).

On the other hand, with the model map, when paying attention to two states sᵢ and sⱼ of which the Euclidean distance dᵢⱼ is distant to some extent (greater than the threshold THd), the state coordinates Yᵢ and Yⱼ are not changed.

As a result thereof, with the two states sᵢ and sⱼ of which the Euclidean distance dᵢⱼ is distant to some extent, the Euclidean distance dᵢⱼ remains still distant, so as illustrated in FIG. 11, states are concentrated in the vicinity (outer edge) of the circumference of the model map, whereby visibility can be prevented from being diminished.

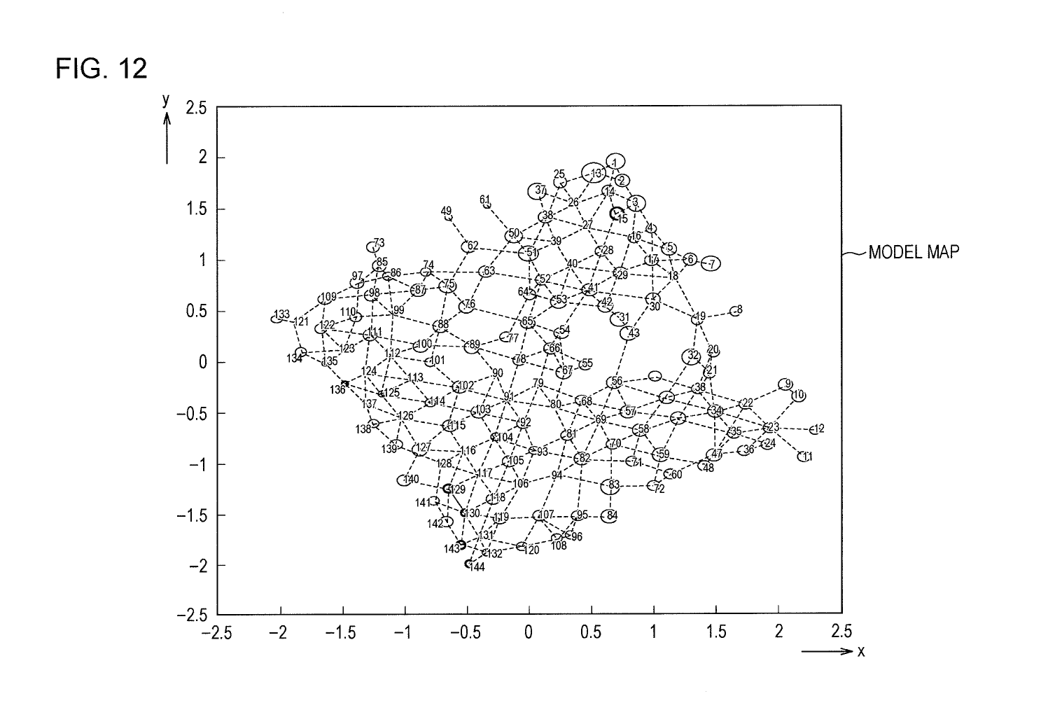

FIG. 12 is a diagram illustrating an example of the model map to be obtained using the error function E after correction.

According to the model map in FIG. 12, it can be confirmed that states are not concentrated in the vicinity of the circumference.

Contents Structure Presentation Processing

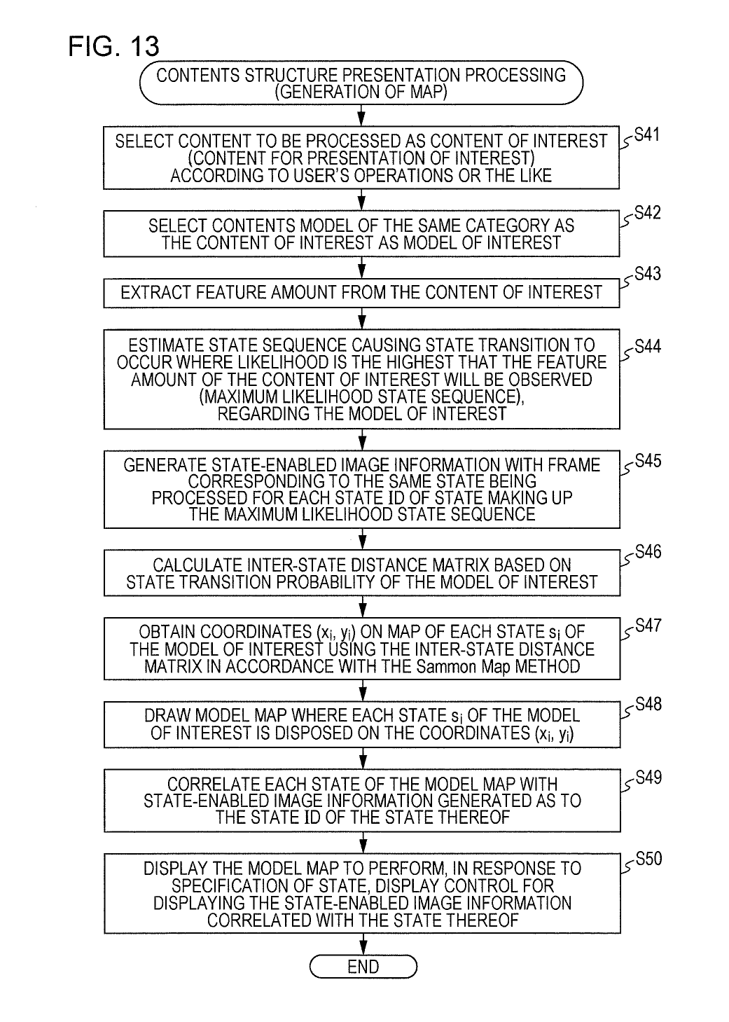

FIG. 13 is a flowchart for describing the contents structure presentation processing that the contents structure presenting unit 14 in FIG. 9 performs.

In step S41, the contents selecting unit 31 selects the content of interest (content for presentation of interest) out of the contents stored in the contents storage unit 11 according to, for example, the user's operations.

Subsequently, the contents selecting unit 31 supplies the content of interest to the feature amount extracting unit 33 and state-enabled image information generating unit 35. Also, the contents selecting unit 31 recognizes the category of the content of interest, and supplies to the model selecting unit 32, and the processing proceeds from step S41 to step S42.

In step S42, the model selecting unit 32 selects a contents model correlated with the category of the content of interest from the contents selecting unit 31 out of the contents models stored in the model storage unit 13 as the model of interest.

Subsequently, the model selecting unit 32 supplies the model of interest to the maximum likelihood state sequence estimating unit 34 and inter-state distance calculating unit 36, and the processing proceeds from step S42 to step S43.

In step S43, the feature amount extracting unit 33 extracts the feature amount of each frame of the content of interest from the contents selecting unit 31, and supplies (the time sequence of) the feature amount of each frame of the content of interest to the maximum likelihood state sequence estimating unit 34, and the processing proceeds to step S44.

In step S44, the maximum likelihood state sequence estimating unit 34 uses the cluster information of the model of interest from the model selecting unit 32 to subject the feature amount of the content of interest from the feature amount extracting unit 33 to clustering.

Further, the maximum likelihood state sequence estimating unit 34 estimates the maximum likelihood state sequence where the code sequence (of the feature amount) of the content of interest will be observed (the maximum likelihood state sequence of the code model of interest as to the content of interest) in the code model of interest of the model of interest from the model selecting unit 32.

Subsequently, the maximum likelihood state sequence estimating unit 34 supplies the maximum likelihood state sequence of the code model of interest as to the content of interest to the state-enabled image information generating unit 35, and the processing proceeds from step S44 to step S45.

In step S45, the state-enabled image information generating unit 35 selects a frame corresponding to the same state out of the content of interest from the contents selecting unit 31 for each state ID of states making up the maximum likelihood state sequence (sequence of state IDs) from the maximum likelihood state sequence estimating unit 34.

Further, the state-enabled image information generating unit 35 stores, in a manner correlated with a state ID, the frame corresponding to the state of the state ID thereof. Also, the state-enabled image information generating unit 35 processes the frame correlated with the state ID, thereby generating state-enabled image information.

Subsequently, the state-enabled image information generating unit 35 supplies the state-enabled image information corresponding to the state ID to the map drawing unit 38, and the processing proceeds from step S45 to step S46.

In step S46, the inter-state distance calculating unit 36 obtains the inter-state distance dᵢⱼ* from one state sᵢ to another state sⱼ of the code model of interest of the model of interest from the model selecting unit 32 based on the state transition probability aᵢⱼ. Subsequently, after obtaining the inter-state distance dᵢⱼ* from an arbitrary state sᵢ to an arbitrary state sⱼ of N states of the code model of interest, the inter-state distance calculating unit 36 supplies a inter-state distance matrix with the inter-state distance dᵢⱼ* thereof as a component to the coordinates calculating unit 37, and the processing proceeds from step S46 to step S47.

In step S47, the coordinates calculating unit 37 obtains the state coordinates Yᵢ=(xᵢ, yᵢ) so as to minimize the error function E in Expression (1) that is statistical error between the Euclidean distance dᵢⱼ from one state sᵢ to another state sⱼ, and the inter-state distance dᵢⱼ* of the inter-state distance matrix from the inter-state distance calculating unit 36, on the model map.

Subsequently, the coordinates calculating unit 37 supplies the state coordinates Yᵢ=(xᵢ, yᵢ) to the map drawing unit 38, and the processing proceeds from step S47 to step S48.

In step S48, the map drawing unit 38 draws, for example, (the graphics of) a two-dimensional model map where (the image of) the corresponding state sᵢ is disposed in the position of the state coordinates Yᵢ=(xᵢ, yᵢ) from the coordinates calculating unit 37. Further, the map drawing unit 38 draws the segment of a line connecting between states of which the state transition probabilities are equal to or greater than a predetermined threshold, on the model map, and the processing proceeds from step S48 to step S49.

In step S49, the map drawing unit 38 links the state sᵢ on the model map with the state-enabled image information corresponding to the state ID of the state sᵢ, of the state-enabled image information from the state-enabled image information generating unit 35, and supplies to the display control unit 39, and the processing proceeds step S50.

In step S50, the display control unit 39 performs display control for displaying the model map from the map drawing unit 38 on an unshown display.

Further, the display control unit 39 performs display control for displaying the state-enabled image information corresponding to the state ID of the state thereof (playback control for playing) in response to the specification of a state on the model map by the user's operations.

Specifically, upon the user performing operations for specifying a state on the model map, the display control unit 39 displays the state-enabled image information linked to the state thereof on an unshown display separate from the model map, for example.

Thus, the user can confirm the image of the frame corresponding to the state on the model map.

Configuration Example of Digest Generating Unit 15

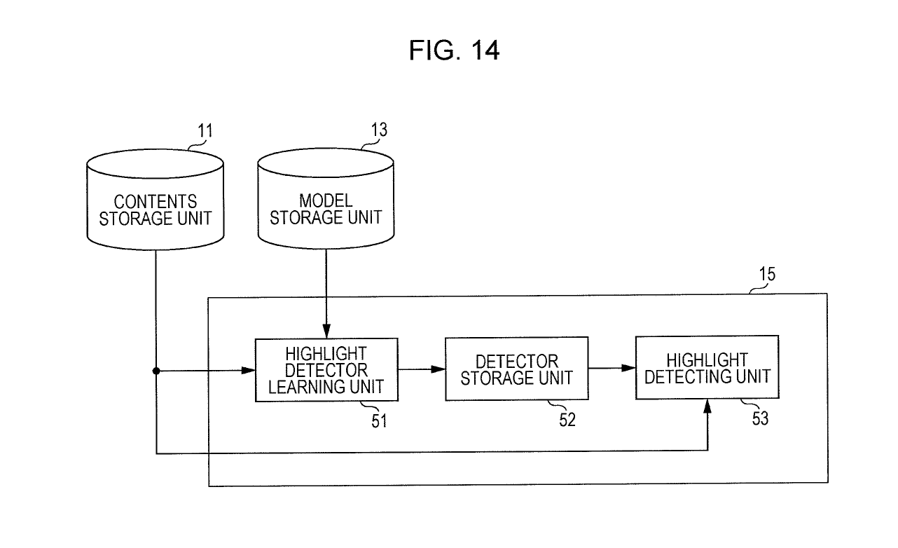

FIG. 14 is a block diagram illustrating a configuration example of the digest generating unit 15 in FIG. 1.

The digest generating unit 15 is configured of a highlight detector learning unit 51, a detector storage unit 52, and a highlight detecting unit 53.

The highlight detector learning unit 51 uses the content stored in the contents storage unit 11, and the contents model stored in the model storage unit 13 to perform learning of a highlight detector which is a model for detecting a scene in which the user is interested as a highlight scene.

The highlight detector learning unit 51 supplies a highlight detector after learning to the detector storage unit 52.

Here, as for a model serving as a highlight detector, in the same way as with the code model of a contents model, for example, an HMM may be employed, which is one of the state transition probability models.

The detector storage unit 52 stores the highlight detector from the highlight detector learning unit 51.

The highlight detector 53 uses the highlight detector stored in the detector storage unit 52 to detect the frame of a highlight scene from the content stored in the contents storage unit 11. Further, the highlight detector 53 uses the frame of a highlight scene to generate a digest content which is a digest of the content stored in the contents storage unit 11.

Configuration Example of Highlight Detector Learning Unit 51

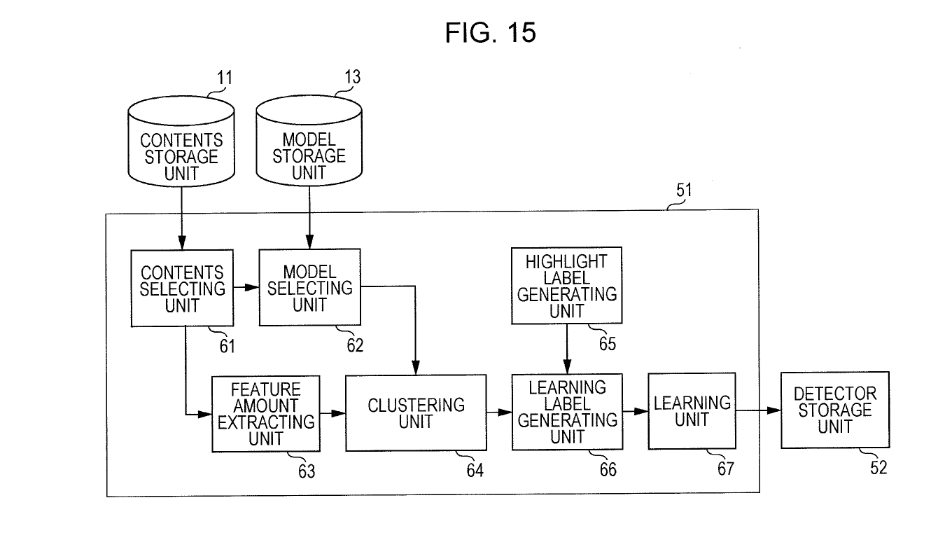

FIG. 15 is a block diagram illustrating a configuration example of the highlight detector learning unit 51 in FIG. 14.

In FIG. 15, the highlight detector learning unit 51 is configured of a contents selecting unit 61, a model selecting unit 62, a feature amount extracting unit 63, a clustering unit 64, a highlight label generating unit 65, a learning label generating unit 66, and a learning unit 67.

The contents selecting unit 61 selects a content to be used for learning of a highlight detector out of the contents stored in the contents storage unit 11 as the content for detector learning of interest (hereafter, simply referred to as “content of interest”), for example, according to the user's operations.

Specifically, the contents selecting unit 61 selects, for example, the content that the user specified as a playback object out of the recorded programs that are contents stored in the contents storage unit 11, as the content of interest.

Subsequently, the contents selecting unit 61 supplies the content of interest to the feature amount extracting unit 63, and also recognizes the category of the content of interest, and supplies to the model selecting unit 62.

The model selecting unit 62 selects the contents model correlated with the category of the content of interest, from the contents selecting unit 61, out of the contents models stored in the model storage unit 13, as the model of interest, and supplies to the clustering unit 64.

The feature amount extracting unit 63 extracts the feature amount of each frame of the content of interest supplied from the contents selecting unit 61 in the same way as with the feature amount extracting unit 22 in FIG. 2, and supplies (the time sequence of) the feature amount of each frame of the content of interest to the clustering unit 64.

The clustering unit 64 uses the cluster information of the model of interest from the model selecting unit 62 to subject (the time sequence of) the feature amount of the content of interest to clustering, obtain the code sequence (of the feature amount) of the content of interest from the feature amount extracting unit 63, and supplies to the learning label generating unit 66.

The highlight label generating unit 65 follows user operations to perform labeling of a highlight label representing whether or not a highlight scene, to each frame of the content of interest selected at the contents selecting unit 61, thereby generating a highlight label sequence regarding the content of interest.

Specifically, the content of interest selected by the contents selecting unit 61 is, as described above, the content that the user has specified as a playback object, and the image of the content of interest is displayed on an unshown display (and also, audio is output from an unshown speaker).

When an interesting scene is displayed on the display, the user can input a message to the effect that this scene is an interesting scene by operating an unshown remote commander or the like, and the highlight label generating unit 65 generates a highlight label in accordance with such a user's operations.

Specifically, for example, if we say that the user's operations at the time of inputting a message representing being an interesting scene are favorite operations, the highlight label generating unit 65 generates, for example, a highlight label of which the value is “0”, which represents being other than a highlight scene, as to a frame to which favorite operations have not been performed.

Also, the highlight label generating unit 65 generates, for example, a highlight label of which the value is “1”, which represents being a highlight scene, as to a frame to which favorite operations have been performed.

Subsequently, the highlight label generating unit 65 supplies a highlight label sequence that is the time sequence of a highlight label generated regarding the content of interest to the learning label generating unit 66.

The learning label generating unit 66 generates a label sequence for learning that is a pair of the code sequence of the content of interest from the clustering unit 64, and the highlight label sequence from the highlight label generating unit 65.

Specifically, the learning label generating unit 66 generates the label sequence for learning of multi streams, which is made up of a pair (taken as a sample at the point-in-time t) of the code at each point-in-time t (the code obtained by subjecting the feature amount of the frame t to clustering) in the code sequence from the clustering unit 64, and the highlight label (highlight label as to the frame t) in the highlight label sequence from the highlight label generating unit 65.

Subsequently, the learning label generating unit 66 supplies the label sequence for learning to the learning unit 67.

The learning unit 67 uses the label sequence for learning from the learning label generating unit 66 to perform, for example, learning of a highlight detector which is a multi-stream HMM of the Ergodic type, in accordance with the Baum-Welch re-estimation method.

Subsequently, the learning unit 67 supplies and stores the highlight detector after learning to the detector storage unit 52 in a manner correlated with the category of the content of interest selected at the contents selecting unit 61.

Here, the highlight label obtained at the highlight label generating unit 65 is a binary label (symbol) of which the value is “0” or “1”, and is a discrete value. Also, the code sequence of the content of interest obtained at the clustering unit 64 is the sequence of code (code representing a cluster (representative vector)), and is also a discrete value.

Accordingly, the label sequence for learning generated as a pair of such a highlight label and code sequence at the learning label generating unit 66 is also (the time sequence of) a discrete value. In this way, the label sequence for learning is a discrete value, so the observation probability bⱼ(o) of an HMM serving as a highlight detector of which the learning is performed at the learning unit 67 is a value (discrete value) serving as probability.

Note that with a multi-stream HMM, as to an individual sequence (stream) (hereafter, also referred to as “component sequence”) making up the multi-stream, weight that is a degree for affecting the component sequence thereof on the multi-stream HMM (hereafter, also referred to as “sequence weight”) may be set.

Great sequence weight is set to a component sequence to be emphasized at the time of learning of a multi-stream HMM, or at the time of recognition using a multi-stream HMM (at the time of obtaining the maximum likelihood state sequence), whereby pre-knowledge can be provided so as to prevent the learning result of the multi-stream HMM from falling into a local solution.

Note that the details of a multi-stream HMM are described in, for example, SATOSHI TAMURA, KOJI IWANO, SADAOKI FURUI, “Multi-modal speech recognition using optical-flow analysis”, Acoustical Society of Japan (ASJ), 2001 autumn lecture collected papers, 1-1-14, pp. 27-28 (2001-10), and so forth.

The above literature has introduced an example of use of a multi-stream HMM in the audio-visual speech recognition field. Specifically, description has been made wherein when the audio SN (Signal to Noise ratio) ratio is low, learning and recognition are performed so as to increase influence of an image larger than influence of audio by lowering the sequence weight of the audio feature amount sequence.

A point of a multi-stream HMM different from an HMM employing a single sequence other than a multi stream is, as illustrated in Expression (2), in that the observation probability bⱼ(o_{[1]}, o_{[2]}, . . . , o_{[M]}) of the entire multi-stream is calculated by taking sequence weight Wₘ set beforehand into consideration regarding the observation probability b_{[m]j}(o_{[m]}) of each component sequence o_{[m]} making up the multi stream.

$${b}_{j} ( {o}_{[ 1 ]} , {o}_{[ 2 ]} , … , {o}_{[ M ]} ) = {\prod }_{m = 1}^{M} {{b}_{[ m ] j} ( {o}_{[ m ]} )}^{Wm} , \\ where {W}_{m} \geq 0 , {\sum }_{m = 1}^{M} {W}_{m} = 1 \qquad ( 2 )$$

Here, in Expression (2), M represents the number of component sequences o_{[m]} (number of streams) making up the multi stream, sequence weight Wₘ represents the sequence weight of the m'th component sequences o_{[m]} of M component sequences making up the multi stream.

A label sequence for learning that is a multi stream to be used for learning at the learning unit 67 in FIG. 15 is made up of two component sequences of a code sequence o_{[V]} and a highlight label sequence o_{[HL]}.

In this case, the observation probability bⱼ(o_{[V]}, o_{[HL]}) of the label sequence for learning is represented with Expression (3).

bⱼ(o_{[V]},o_{[HL]})=(b_{[V]j}(o_{[V]}))^{W}×(b_{[HL]j}(o_{[HL]}))^{1-W} (3)

Here, in Expression (3), b_{[V]j}(o_{[V]}) represents the observation probability of the code sequence o_{[V]} (the observation probability that the observation value o_{[V]} will be observed in the state sⱼ), and b_{[HL]j}(o_{[HL])} represents the observation probability of the highlight label sequence o_{[HL]}. Also, W represents the sequence weight of the code sequence o_{[V]}, and 1−W represents the sequence weight of the highlight label sequence o_{[HL]}.

Note that, with learning of an HMM serving as a highlight detector, 0.5 may be employed as the sequence weight W, for example.

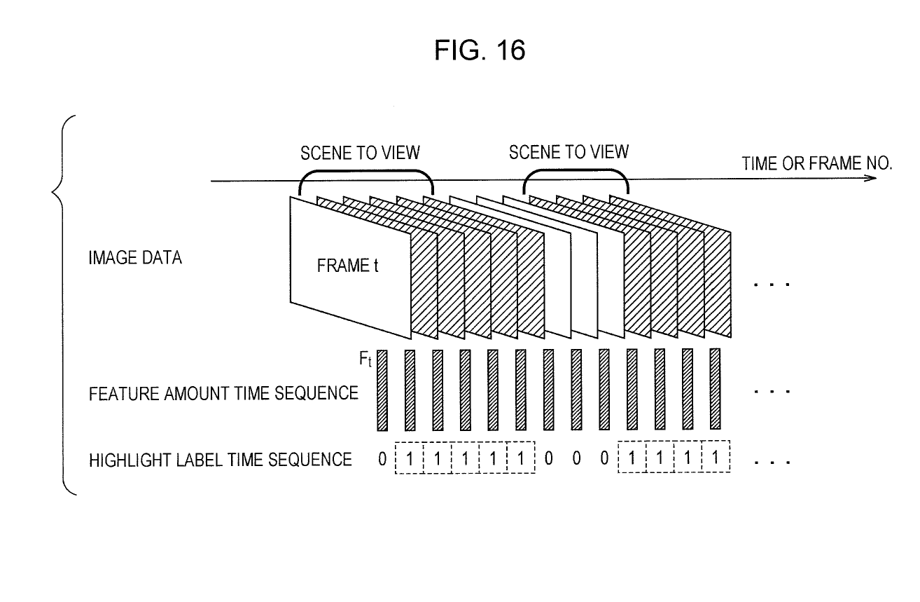

FIG. 16 is a diagram for describing the processing of the highlight label generating unit 65 in FIG. 15.

The highlight label generating unit 65 generates a highlight label of which the value is “0” as to a frame (point-in-time) of the content of interest to which the user's favorite operations have not been performed, which represents being other than a highlight scene. Also, the highlight label generating unit 65 generates a highlight label of which the value is “1” as to a frame of the content of interest to which the user's favorite operations have been performed, which represents being a highlight scene.

Highlight Detector Learning Processing

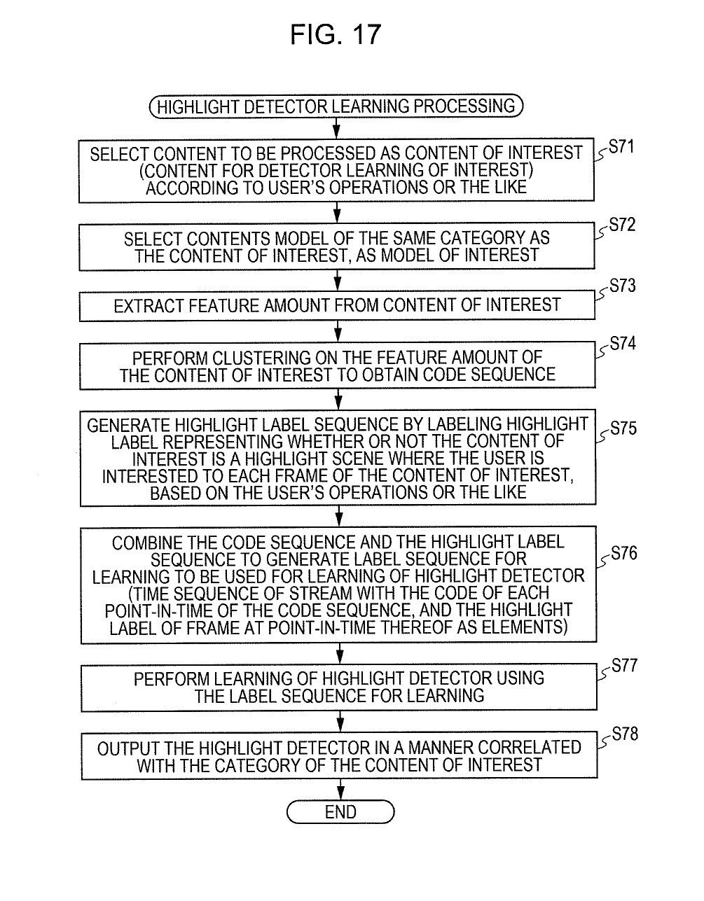

FIG. 17 is a flowchart for describing the processing (highlight detector learning processing) that the highlight detector learning unit 51 in FIG. 15 performs.

In step S71, the contents selecting unit 61 selects, for example, a content with playback being specified by the user's operations out of the contents stored in the contents storage unit 11 as the content of interest (content for detector learning of interest).

Subsequently, the contents selecting unit 61 supplies the content of interest to the feature amount extracting unit 63, and also recognizes the category of the content of interest, and supplies to the model selecting unit 62, and the processing proceeds from step S71 to step S72.

In step S72, the model selecting unit 62 selects a contents model correlated with the category of the content of interest from the contents selecting unit 61 out of the contents models stored in the model storage unit 13 as the model of interest.

Subsequently, the model selecting unit 62 supplies the model of interest to the clustering unit 64, and the processing proceeds from step S72 to step S73.

In step S73, the feature amount extracting unit 63 extracts the feature amount of each frame of the content of interest supplied from the contents selecting unit 61, supplies the feature amount of each frame of the content of interest to the clustering unit 64, and the processing proceeds to step S74.

In step S74, the clustering unit 64 uses the cluster information of the model of interest from the model selecting unit 62 to subject (the time sequence of) the feature amount of the content of interest from the feature amount extracting unit 63 to clustering, and supplies the code sequence of the content of interest obtained as a result thereof to the learning label generating unit 66, and the processing proceeds to step S75.

In step S75, the highlight label generating unit 65 generates a highlight label sequence regarding the content of interest by performing labeling of a highlight label to each frame of the content of interest selected at the contents selecting unit 61 in accordance with the user's operations.

Subsequently, the highlight label generating unit 65 supplies the highlight label sequence generated regarding the content of interest to the learning label generating unit 66, and the processing proceeds to step S76.

In step S76, the learning label generating unit 66 generates the label sequence for learning that is a pair of the code sequence of the content of interest from the clustering unit 64, and the highlight label sequence from the highlight label generating unit 65.

Subsequently, the learning label generating unit 66 supplies the label sequence for learning to the learning unit 67, and the processing proceeds from step S76 to step S77.

In step S77, the learning unit 67 uses the label sequence for learning from the learning label generating unit 66 to perform learning of a highlight detector that is an HMM, and the processing proceeds to step S78.

In step S78, the learning unit 67 supplies and stores the highlight detector after learning to the detector storage unit 52 in a manner correlated with the category of the content of interest selected at the contents selecting unit 61.

As described above, a highlight detector is obtained by performing learning of an HMM serving as a highlight detector using a label sequence for learning that is a pair of a code sequence obtained by subjecting the feature amount of the content of interest to clustering, and a highlight label sequence generated according to the user's operations.

Accordingly, determination may be made by referencing the observation probability b_{[HL]j}(o_{[HL]}) of the highlight label o_{[HL]} of each state of the highlight detector whether or not a frame of which the feature amount is to be subjected to clustering to obtain a cluster that the code (with a high probability) that will be observed in the state thereof represents is a scene in which the user is interested (highlight scene).

Configuration Example of Highlight Detecting Unit 53

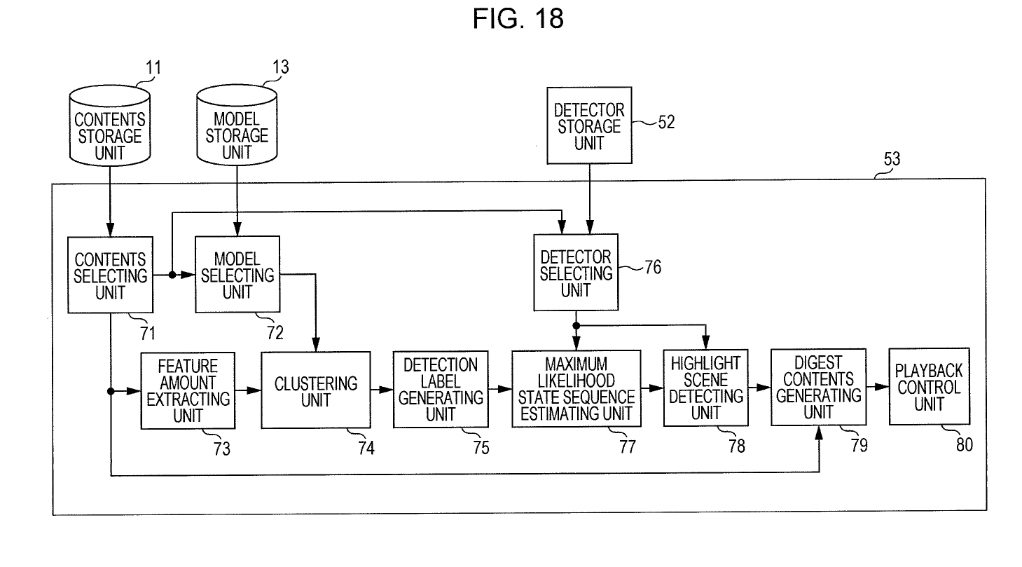

FIG. 18 is a block diagram illustrating a configuration example of the highlight detecting unit 53 in FIG. 14.

In FIG. 18, the highlight detecting unit 53 is configured of a contents selecting unit 71, a model selecting unit 72, a feature amount extracting unit 73, a clustering unit 74, a detection label generating unit 75, a maximum likelihood state sequence estimating unit 77, a highlight scene detecting unit 78, a digest contents generating unit 79, and a playback control unit 80.

The contents selecting unit 71 selects, for example, the content for highlight detection of interest (hereafter, also simply referred to as “content of interest”) that is an object content from which a highlight scene is to be detected, out of the contents stored in the contents storage unit 11, for example, according to the user's operations.

Specifically, the contents selecting unit 71 selects, for example, the content specified as a content from which a digest is generated by the user, as the content of interest. Alternatively, the contents selecting unit 71 selects, for example, an arbitrary content of contents from which a digest has not been generated yet as the content of interest.

After selecting the content of interest, the contents selecting unit 71 supplies the content of interest thereof to the feature amount extracting unit 73, and also recognizes the category of the content of interest, and supplies to the model selecting unit 72 and detector selecting unit 76.

The model selecting unit 72 selects a contents model correlated with the category of the content of interest, from the content selecting unit 71, out of the contents models stored in the model storage unit 13 as the model of interest, and supplies to the clustering unit 74.

The feature amount extracting unit 73 extracts, in the same way as with the feature amount extracting unit 22 in FIG. 2, the feature amount of each frame of the content of interest supplied from the contents selecting unit 71, and supplies (the time sequence of) the feature amount of each frame of the content of interest to the clustering unit 74.

The clustering unit 74 uses the cluster information of the model of interest from the model selecting unit 72 to subject (the time sequence of) the feature amount of the content of interest from the feature amount extracting unit 73 to clustering, and supplies code sequence obtained as a result thereof to the detection label generating unit 75.

The detection label generating unit 75 generates a label sequence for detection that is a pair of the code sequence of (the feature amount of) the content of interest from the clustering unit 74, and a highlight label sequence of highlight labels alone representing being other than a highlight scene (or being a highlight scene).

Specifically, the detection label generating unit 75 generates a highlight label sequence having the same length (sequence length) as the code sequence from the clustering unit 74, which is a highlight label sequence of highlight labels alone representing being other than a highlight scene, as a dummy sequence, as if it were, to be given to a highlight detector.

Further, the detection label generating unit 75 generates a label sequence for detection of a multi-stream, made up of a pair of code (the code of the feature amount of the frame t) at point-in-time t in the code sequence from the clustering unit 74, a highlight label at the point-in-time t (a highlight label as to the frame t (here, a highlight label representing being other than a highlight scene)) in a highlight label sequence serving as a dummy sequence.

Subsequently, the detection label generating unit 75 supplies the label sequence for detection to the maximum likelihood state sequence estimating unit 77.

The detector selecting unit 76 selects a highlight detector correlated with the category of the content of interest, from the contents selecting unit 71, out of the highlight detectors stored in the detector storage unit 52, as the detector of interest. Subsequently, the detector selecting unit 76 obtains the detector of interest out of the highlight detectors stored in the detector storage unit 52, and supplies to the maximum likelihood state sequence estimating unit 77 and highlight scene detecting unit 78.

The maximum likelihood state sequence estimating unit 77 estimates, for example, in accordance with the Viterbi algorithm, the maximum likelihood state sequence (hereafter, also referred to as “highlight relation state sequence”) causing state transition where likelihood is the highest that the label sequence for detection from the detection label generating unit 75 will be observed in the HMM that is the detector of interest from the detector selecting unit 76.

Subsequently, the maximum likelihood state sequence estimating unit 77 supplies the highlight relation state sequence to the highlight scene detecting unit 78.

Note that the label sequence for detection is a multi stream with the code sequence o_{[V]} of the content of interest, and the highlight label sequence o_{[HL]} serving as a dummy sequence as component sequences, and at the time of estimation of the highlight relation state sequence, the observation probability bⱼ(o_{[V]}, o_{[HL]}) of the label sequence for detection is obtained in accordance with Expression (3) in the same way as with the case of the label sequence for learning.

However, as for the sequence weight W of the code sequence o_{[V]} at the time of obtaining the observation probability bⱼ(o_{[V]}, o_{[HL]}) of the label sequence for detection, 1.0 is employed. In this case, the sequence weight 1−W of the highlight label sequence o_{[HL]} is 0.0. Thus, with the maximum likelihood state sequence estimating unit 77, estimation of the highlight relation state sequence is performed while taking only the code sequence the content of interest into consideration and without taking the highlight label sequence input as a dummy sequence into consideration.

The highlight scene detecting unit 78 recognizes the observation probability b_{[HL]j}(o_{[HL]}) of the highlight label o_{[HL]} of each state of the maximum likelihood state sequence (highlight relation state sequence) obtained from the label sequence for detection, from the maximum likelihood state sequence estimating unit 77 by referencing the detector of interest from the detector selecting unit 76.

Further, the highlight scene detecting unit 78 detects the frame of a highlight scene from the content of interest based on the observation probability b_{[HL]j}(o_{[HL]}) of the highlight label o_{[HL]}.

Specifically, in the event that, in the state sⱼ at the point-in-time t of the highlight relation state sequence, difference b_{[HL]j}(o_{[HL]}=“1”)−b_{[HL]j}(O_{[HL]}=“0”) between the observation probability b_{[HL]j}(o_{[HL]}=“1”) of a highlight label representing being a highlight scene, and the observation probability b_{[HL]j}(o_{[HL]}=“0”) of a highlight label representing being other than a highlight scene is greater than a predetermined threshold THb (e.g., THb=0, etc.), the highlight scene detecting unit 78 detects the frame t of the content of interest, corresponding to the state sⱼ at the point-in-time t, as the frame of a highlight scene.

Subsequently, the highlight scene detecting unit 78 sets, of the content of interest, regarding a frame being a highlight scene, a highlight flag of one bit representing whether or not the frame is a highlight scene frame, to a value representing being a highlight scene, for example, “1”. Also, the highlight scene detecting unit 78 sets, of the content of interest, regarding a frame being other than a highlight scene, the highlight flag to a value representing being other than a highlight scene, for example, “0”.

Subsequently, the highlight scene detecting unit 78 supplies (the time sequence of) the highlight flag of each frame of the content of interest to the digest contents generating unit 79.

The digest contents generating unit 79 extracts a highlight scene frame determined by the highlight flag from the highlight scene detecting unit 78 from the frames of the content of interest from the contents selecting unit 71. Further, the digest contents generating unit 79 uses the highlight scene frame extracted from the frames of the content of interest to generate a digest content that is a digest of the content of interest, and supplies to the playback control unit 80.

The playback control unit 80 performs playback control for playing the digest content from the digest contents generating unit 79.

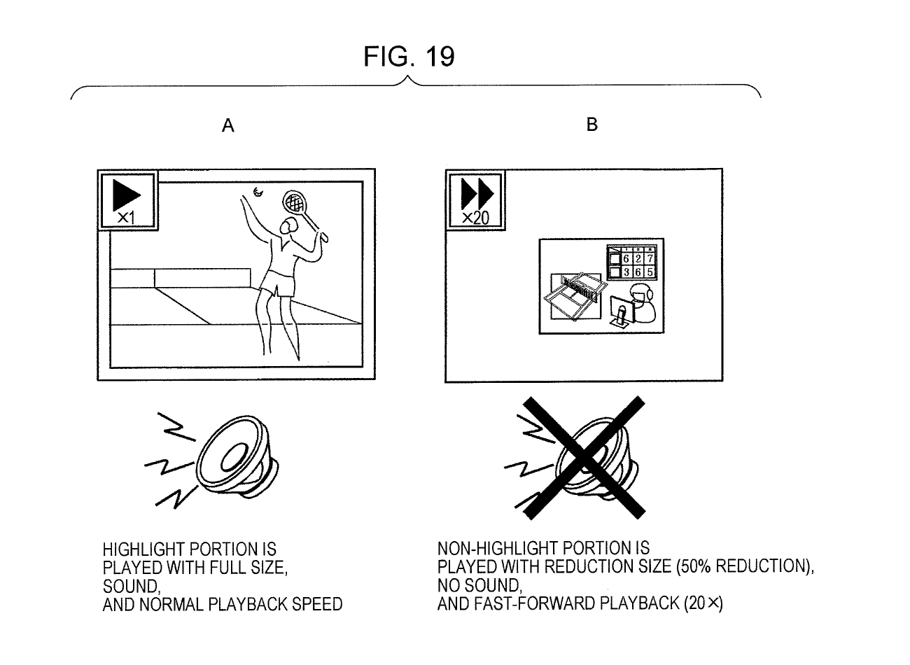

FIG. 19 illustrates an example of a digest content that the digest contents generating unit 79 in FIG. 18 generates.

A in FIG. 19 illustrates a first example of a digest content.

In A in FIG. 19, the digest contents generating unit 79 extracts the image of a highlight scene frame, and audio data along with the image thereof from the content of interest, and generates the content of a moving image where the image data and audio data thereof are combined while maintaining temporal context, as a digest content.

In this case, with the playback control unit 80 (FIG. 18), only the image of a highlight scene frame is displayed with the same size (hereafter, also referred to as “full size”) as with the original content (content of interest), and also the audio along with the image thereof is output.

Note that, in A in FIG. 19, with extraction of the image of a highlight scene frame from the content of interest, all the highlight scene frames may also be extracted, or extraction with frames being thinned out may also be performed, such as one frame extraction for every two highlight scene frames, or the like.

B in FIG. 19 illustrates a second example of a digest content.

In B in FIG. 19, the digest contents generating unit 79 performs frame thinning-out processing (e.g., thinning-out processing for extracting one frame per 20 frames) so that of the frames of the content of interest, the image of a non-highlight scene frame is viewed as fast forward at the time of viewing and listening, and also the content of interest is processed so that audio along with the image of a non-highlight scene frame is muted, thereby generating a digest content.

In this case, with the playback control unit 80 (FIG. 18), regarding a highlight scene, the image is displayed by 1×, and also, audio along with the image thereof is output, but with regard to other than a highlight scene (non-highlight scene), the image is displayed by fast forward (e.g., 20×), and also, audio along with the image thereof is not output.

Note that, in B in FIG. 19, audio along with the image of a non-highlight scene has been arranged so as not to be output, but audio along with the image of a non-highlight scene may be output in the same way as audio along with the image of a highlight scene. In this case, the audio along with the image of a non-highlight scene may be output at a small volume, and the audio along with the image of a highlight scene may be output at a large volume, respectively.

Also, in B in FIG. 19, the image of a highlight scene, and the image of a non-highlight scene are displayed with the same size (full size), but the image of a non-highlight scene may be displayed with a smaller size than the size of the image of a highlight scene (e.g., the sizes obtained by reducing the sizes of the width and length of the image of a highlight scene to 50% respectively, etc.) (, or the image of a highlight scene may be displayed with a greater size than the size of the image of a non-highlight scene).

Further, in FIG. 19, in the event of thinning out frames, thinning-out ratio thereof may be specified by the user, for example.

Highlight Detection Processing

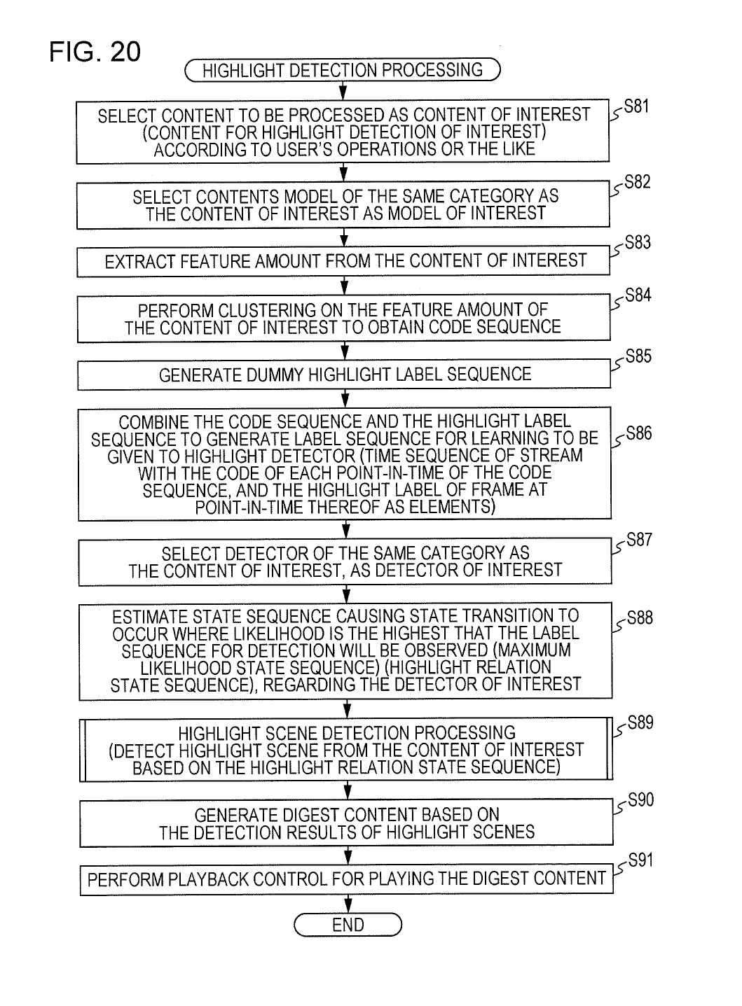

FIG. 20 is a flowchart for describing the processing (highlight detection processing) of the highlight detecting unit 53 in FIG. 18.

In step S81, the contents selecting unit 71 selects the content of interest that is a content from which a highlight scene is to be detected (content for highlight detection of interest) out of the contents stored in the contents storage unit 11.

Subsequently, the contents selecting unit 71 supplies the content of interest to the feature amount extracting unit 73. Further, the contents selecting unit 71 recognizes the category of the content of interest, and supplies to the model selecting unit 72 and detector selecting unit 76, and the processing proceeds from step S81 to step S82.

In step S82, the model selecting unit 72 selects a contents model correlated with the category of the content of interest, from the contents selecting unit 71, out of the contents models stored in the model storage unit 13, as the model of interest.

Subsequently, the model selecting unit 72 supplies the model of interest to the clustering unit 74, and the processing proceeds from step S82 to step S83.

In step S83, the feature amount extracting unit 73 extracts the feature amount of each frame of the content of interest supplied from the contents selecting unit 71, supplies to the clustering unit 74, and the processing proceeds to step S84.

In step S84, the clustering unit 74 uses the cluster information of the model of interest from the model selecting unit 72 to subject (the time sequence of) the feature amount of the content of interest from the feature amount extracting unit 73 to clustering, and supplies code sequence obtained as a result thereof to the detection label generating unit 75, and the processing proceeds to step S85.

In step S85, the detection label generating unit 75 generates a highlight label sequence made up of highlight labels (highlight labels of which the values are “0”) alone representing being other than a highlight scene, as a dummy highlight label sequence, for example, and the processing proceeds to step S86.

In step S86, the detection label generating unit 75 generates a label sequence for detection that is a pair of the code sequence of the content of interest from the clustering unit 74, and a dummy highlight label sequence.

Subsequently, the detection label generating unit 75 supplies the label sequence for detection to the maximum likelihood state sequence estimating unit 77, and the processing proceeds from step S86 to step S87.

In step S87, the detector selecting unit 76 selects a highlight detector correlated with the category of the content of interest, from the contents selecting unit 71, out of the highlight detectors stored in the detector storage unit 52, as the detector of interest. Subsequently, the detector selecting unit 76 obtains the detector of interest out of the highlight detectors stored in the detector storage unit 52, supplies to the maximum likelihood state sequence estimating unit 77 and highlight scene detecting unit 78, and the processing proceeds from step S87 to step S88.

In step S88, the maximum likelihood state sequence estimating unit 77 estimates the maximum likelihood state sequence (highlight relation state sequence) causing state transition where likelihood is the highest that the label sequence for detection from the detection label generating unit 75 will be observed in the detector of interest from the detector selecting unit 76.

Subsequently, the maximum likelihood state sequence estimating unit 77 supplies the highlight relation state sequence to the highlight scene detecting unit 78, and the processing proceeds from step S88 to step S89.

In step S89, the highlight scene detecting unit 78 detects a highlight scene from the content of interest based on the highlight relation state sequence from the maximum likelihood state sequence estimating unit 77, and performs highlight scene detection processing for outputting a highlight flag.

Subsequently, after completion of the highlight scene detection processing, the processing proceeds from step S89 to step S90, where the digest contents generating unit 79 extracts a highlight scene frame determined by the highlight flag that the highlight scene detecting unit 78 outputs, from the frames of the content of interest from the contents selecting unit 71.

Further, the digest contents generating unit 79 uses a highlight scene frame extracted from the frames of the content of interest to generate a digest content of the content of interest, supplies to the playback control unit 80, and the processing proceeds from step S90 to step S91.

In step S91, the playback control unit 80 performs playback control for playing the digest content from the digest contents generating unit 79.

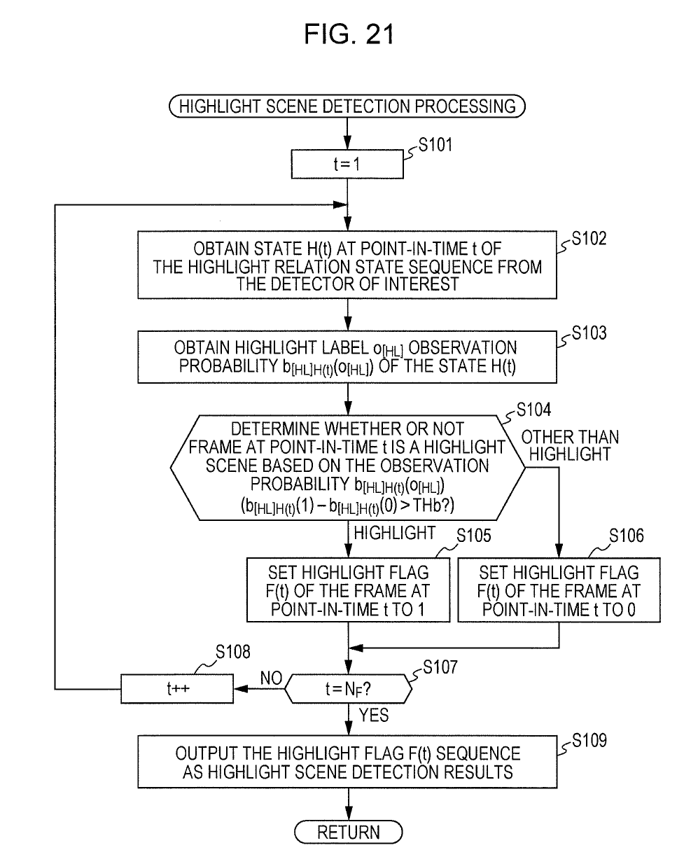

FIG. 21 is a flowchart for describing the highlight scene detection processing that the highlight scene detecting unit 78 (FIG. 18) performs in step S89 in FIG. 20.

In step S101, the highlight scene detecting unit 78 sets a variable t for counting point-in-time (the number of frames of the content of interest) to 1 serving as the initial value, and the processing proceeds to step S102.

In step S102, the highlight scene detecting unit 78 obtains (recognizes) a state H(t)=sⱼ at the point-in-time t (the t'th state from the head) of the highlight relation state sequence from the maximum likelihood state sequence estimating unit 77 out of the states s₁ through s_{N′} of an HMM serving as the detector of interest (N′ represents the total number of the states of an HMM serving as the detector of interest) from the detector selecting unit 76 (FIG. 18).

Subsequently, the processing proceeds from step S102 to step S103, where the highlight scene detecting unit 78 obtains the observation probability b_{[HL]H(t)j}(o_{[HL]}) of the highlight label o_{[HL]} of the state H(t)=sⱼ at the point-in-time t from the HMM serving as the detector of interest from the detector selecting unit 76, and the processing proceeds to step S104.

In step S104, the highlight scene detecting unit 78 determines whether or not the frame at the point-in-time t of the content of interest is a highlight scene based on the observation probability b_{[HL]H(t)j}(o_{[HL]}) of the highlight label o_{[HL]}.

In the event that determination is made in step S104 that the frame at the point-in-time t of the content of interest is a highlight scene, i.e., for example, in the event that, of the observation probability b_{[HL]H(t)j}(o_{[HL]}) of the highlight label o_{[HL]}, difference b_{[HL]j}(o_{[HL]}=“1”)−b_{[HL]H(t)}(o_{[HL]}=“0”) between the observation probability b_{[HL]H(t)}(o_{[HL]}=“1”) of a highlight label representing being a highlight scene, and the observation probability b_{[HL]H(t)}(o_{[HL]}=“0”) of a highlight label representing being other than a highlight scene is greater than the predetermined threshold THb, the processing proceeds to step S105, where the highlight scene detecting unit 78 sets the highlight flag F(t) of the frame at the point-in-time t of the content of interest to “1” of a value representing being a highlight scene.

Also, in the event that determination is made in step S104 that the frame at the point-in-time t of the content of interest is other than a highlight scene, i.e., for example, in the event that, of the observation probability b_{[HL]H(t)j}(o_{[HL]}) of the highlight label o_{[HL]}, difference b_{[HL]j}(o_{[HL]}=“1”)−b_{[HL]j}(o_{[HL]}=“0”) between the observation probability b_{[HL]H(t)}(o_{[HL]}=“1”) of a highlight label representing being a highlight scene, and the observation probability b_{[HL]H(t)}(o_{[HL]}=“0”) of a highlight label representing being other than a highlight scene is not greater than the predetermined threshold THb, the processing proceeds to step S106, where the highlight scene detecting unit 78 sets the highlight flag F(t) of the frame at the point-in-time t of the content of interest to “0” of a value representing being other than a highlight scene.

After steps S105 and S106, the processing proceeds to step S107 in either case, where the highlight scene detecting unit 78 determines whether or not the variable t is equal to the total number N_{F} of the frames of the content of interest.

In the event that determination is made in step S107 that the variable t is not equal to the total number N_{F} of frames, the processing proceeds to step S108, where the highlight scene detecting unit 78 increments the variable t by one, and the processing returns to step S102.

Also, in the event that determination is made in step S107 that the variable t is equal to the total number N_{F} of frames, i.e., in the event that, of the content of interest, the highlight flag F(t) is obtained for each frame with the feature amount being obtained, the processing proceeds to step S109, where the highlight scene detecting unit 78 outputs the sequence of the highlight flag F(t) of the frames of the content of interest to the digest contents generating unit 79 (FIG. 18) as the highlight scene detection result, and the processing returns.

As described above, the highlight detecting unit 53 (FIG. 18) estimates, with a highlight detector, a highlight relation state sequence that is the maximum likelihood state sequence in the event that a pair of the code sequence of the content of interest, and a dummy highlight label sequence is observed, and based on the observation probability of the highlight label of each state of the highlight relation state sequence thereof, detects a highlight scene frame from the content of interest, and generates a digest content using the highlight scene frame thereof.

Also, the highlight detector is obtained by performing learning of an HMM using a label sequence for learning that is a pair of the code sequence obtained by subjecting the feature amount of a content to clustering using the cluster information of a contents model, and a highlight label sequence generated according to the user's operations.

Accordingly, even in the event that the content of interest for generating a digest content is not used for learning of a contents model nor highlight detector, if learning of a contents model and highlight detector is performed using a content having the same category as the content of interest, a digest (digest content) generated by collecting a scene in which the user is interested as a highlight scene can readily be obtained using the contents model and highlight detector thereof.

Configuration Example of Scrapbook Generating Unit 16

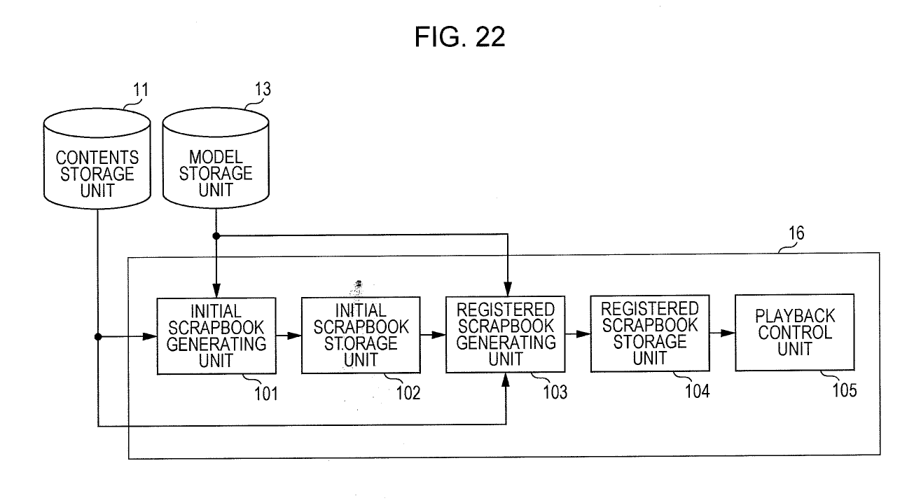

FIG. 22 is a block diagram illustrating a configuration example of the scrapbook generating unit 16 in FIG. 1.

The scrapbook generating unit 16 is configured of an initial scrapbook generating unit 101, an initial scrapbook storage unit 102, a registered scrapbook generating unit 103, a registered scrapbook storage unit 104, and a playback control unit 105.

The initial scrapbook generating unit 101 uses a content stored in the contents storage unit 11, and a contents model stored in the model storage unit 13 to generate a later-described initial scrapbook, and supplies to the initial scrapbook storage unit 102.

The initial scrapbook storage unit 102 stores the initial scrapbook from the initial scrapbook generating unit 101.

The registered scrapbook generating unit 103 uses a content stored in the contents storage unit 11, a contents model stored in the model storage unit 13, and an initial scrapbook stored in the initial scrapbook storage unit 102 to generate a later-described registered scrapbook, and supplies to the registered scrapbook storage unit 104.

The registered scrapbook storage unit 104 stores the registered scrapbook from the registered scrapbook generating unit 103.

The playback control unit 105 performs playback control for playing a registered scrapbook stored in the registered scrapbook storage unit 104.

Configuration Example of Initial Scrapbook Generating Unit 101

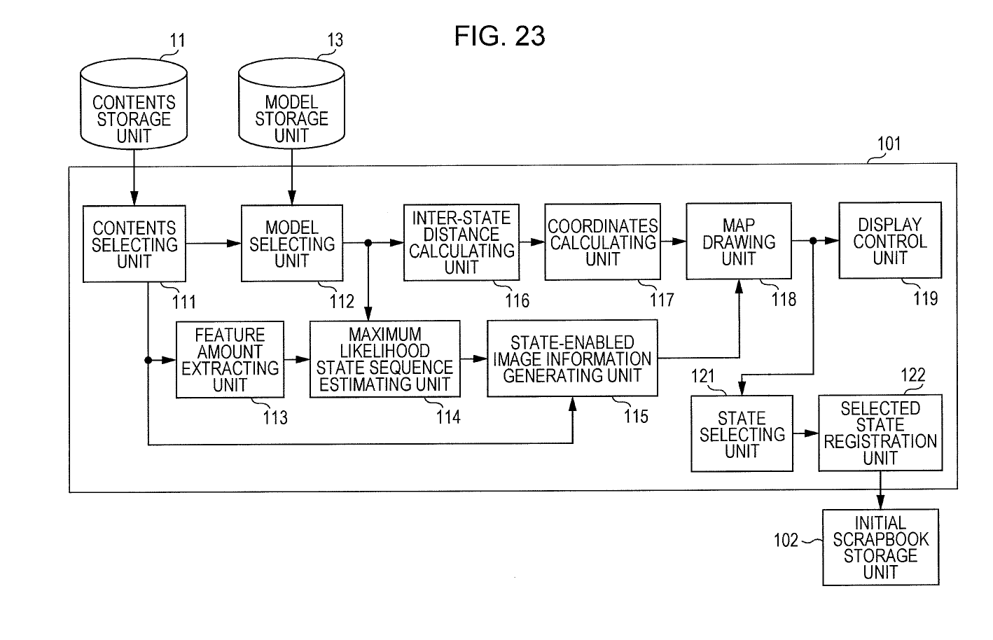

FIG. 23 is a block diagram illustrating a configuration example of the initial scrapbook generating unit 101 in FIG. 22.

In FIG. 23, the initial scrapbook generating unit 101 is configured of a contents selecting unit 111, a model selecting unit 112, a feature amount extracting unit 113, a maximum likelihood state sequence estimating unit 114, a state-enabled image information generating unit 115, a inter-state distance calculating unit 116, a coordinates calculating unit 117, a map drawing unit 118, a display control unit 119, a state selecting unit 121, and a selected state registration unit 122.

The contents selecting unit 111 through the display control unit 119 are configured in the same way as with the contents selecting unit 31 through the display control unit 39 of the contents structure presenting unit 14 (FIG. 9), and perform the contents structure presentation processing described in FIG. 13.

Note that the map drawing unit 118 supplies, in the same way as with the map drawing unit 38 in FIG. 9, a model map to the display control unit 119, and also to the state selecting unit 121.

In the event that a state on the model map (FIG. 11, FIG. 12) displayed by the contents structure presentation processing has been specified by the user's operations, the state selecting unit 121 selects the specified state thereof as a selected state. Further, the state selecting unit 121 references the model map from the map drawing unit 118 to recognize the state ID of the selected state, and supplies to the selected state registration unit 122.

The selected state registration unit 122 generates an empty scrapbook, and registers the state ID of the selected state from the state selecting unit 121 in the empty scrapbook thereof. Subsequently, the selected state registration unit 122 supplies and stores the scrapbook in which the state ID has been registered, to the initial scrapbook storage unit 102 as an initial scrapbook.

Here, the scrapbook that the selected state registration unit 122 generates is an electronic storage warehouse whereby data such as still images (photos), moving images, audio (music), and so forth can be kept (stored).

Note that the empty scrapbook is a scrapbook in which nothing is registered, and the initial scrapbook is a scrapbook in which a state ID is registered.

With the initial scrapbook generating unit 101 configured as described above, the model map (FIG. 11, FIG. 12) is displayed on an unshown display by the contents structure presentation processing (FIG. 13) being performed. Subsequently, in the event that a state on the model map has been specified by the user's operations, the state ID of the specified state (selected state) thereof is registered in the (empty) scrapbook.

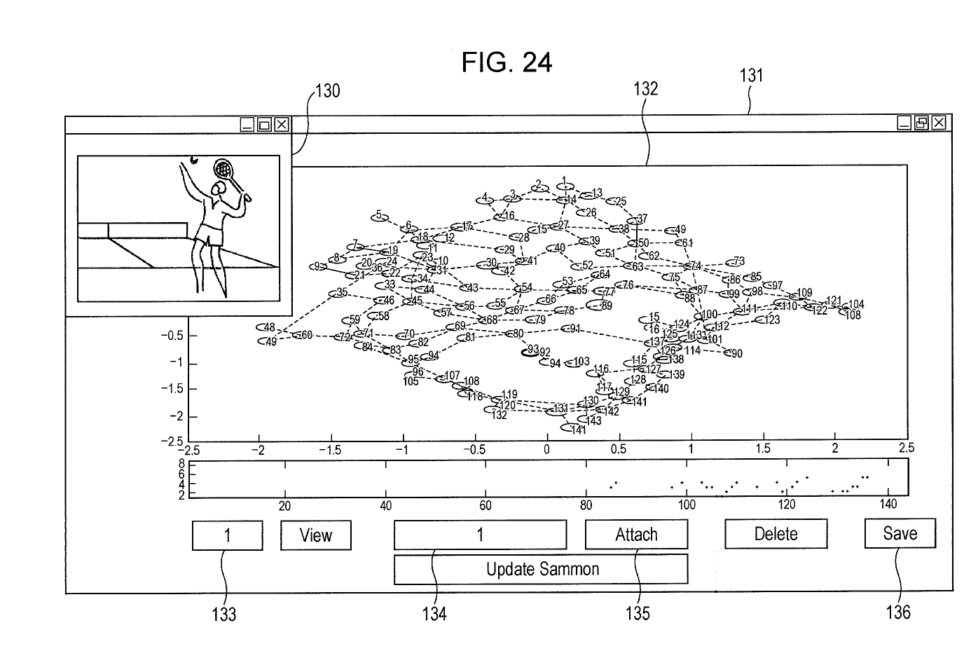

FIG. 24 is a diagram illustrating an example of a user interface for a user specifying a state on a model map, which is displayed by the display control unit 119 performing display control.

In FIG. 24, a model map 132 generated at the map drawing unit 118 is displayed on a window 131.

A state on the model map 132 within the window 131 can be focused by being specified by the user. Specification of a state by the user may be performed, for example, by clicking a state to be focused on using a pointing device such as a mouse or the like, by moving a cursor which moves according to operations of the pointing device to the position of the state to be focused on, or the like.

Also, of states on the model map 132, a state that has already been a selected state, and a state that has not been a selected state may be displayed in a different display format such as different color or the like.

With the lower portion of the window 131, a state ID input field 133, a scrapbook ID input field 134, a registration button 135, an end button 136, and so forth are provided.

Of the states on the model map 132, the state ID of a focused state is displayed on the state ID input field 133.

Note that the user can also input a state ID directly on the state ID input field 133.

A scrapbook ID that is information for determining a scrapbook for registering the state ID of a selected state is displayed on the scrapbook ID input field 134.

Note that the scrapbook ID input field 134 can be operated by the user (e.g., can be clicked using a pointing device such as a mouse or the like), and a scrap book ID to be displayed on the scrapbook ID input field 134 is changed according to operations of the scrapbook ID input field 134 by the user. Accordingly, the user can change the scrapbook in which a state ID is registered by operating the scrapbook ID input field 134.

The registration button 135 is operated in the event of registering the state ID of a focused state (state in which a state ID is displayed on the state ID input field 133) in the scrapbook. That is to say, in the event of the registration button 135 being operated, a focused state is selected (determined) as a selected state.

The end button 136 is operated, for example, when ending the display of the model map 132 (when closing the window 131), or the like.

The window 130 is opened in the event that, of the states on the model map 132, state-enabled image information generated in the contents structure presentation processing is linked to a focused state. Subsequently, the state-enabled image information linked to the focused state is displayed on the window 130.

Note that, on the window 130 (further, an unshown window other than the window 130), instead of the state-enabled image information linked to the focused state, state-enabled image information linked to each of the focused state, and a state near the focused state, or state-enabled image information linked to each of all the states on the model map 132 may be displayed temporally in sequence, or spatially in parallel.

The user can specify an arbitrary state on the model map 132 displayed on the window 131 by clicking or the like.

Upon a state being specified by the user, the display control unit 119 (FIG. 23) displays the state-enabled image information linked to the state specified by the user on the window 130.

Thus, the user can confirm the image of a frame corresponding to the state on the model map 132.

In the event of viewing the image displayed on the window 130, having an interest in the image thereof, and desiring to register on a scrapbook, the user operates the registration button 135.

Upon the registration button 135 being operated, the state selecting unit 121 (FIG. 23) selects the state on the model map 132 specified by the user at that time as a selected state.

Subsequently, upon the user operating the end button 136, the state selecting unit 121 supplies the state ID of a state selected so far to the selected state registration unit 122 (FIG. 23).

The selected state registration unit 122 registers the state ID of the selected state from the state selecting unit 121 in the empty scrapbook, and stores the scrapbook in which the state IDs have been registered in the initial scrapbook storage unit 102 as an initial scrapbook. Subsequently, the display control unit 119 (FIG. 23) closes the window 131.

Initial Scrapbook Generation Processing

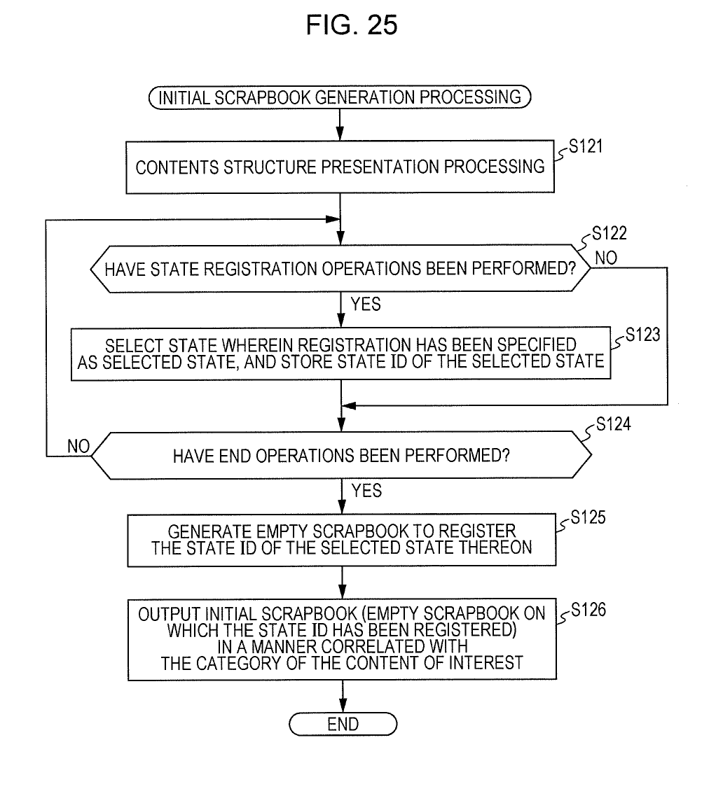

FIG. 25 is a flowchart for describing the processing (initial scrapbook generation processing) that the initial scrapbook generating unit 101 in FIG. 23 performs.

In step S121, the contents selecting unit 111 through display control unit 119 perform the same contents structure presentation processing (FIG. 13) as with the contents selecting unit 31 through the display control unit 39 in the contents structure presenting unit 14 (FIG. 9). Thus, the window 131 (FIG. 24) including the model map 132 is displayed on the unshown display.

Subsequently, the processing proceeds from step S121 to step S122, where the state selecting unit 121 determines whether or not state registration operations have been operated by the user.

In the event that determination is made in step S122 that state registration operations have been performed, i.e., in the event that a state on the model map 132 has been specified by the user, and the registration button 135 (FIG. 24) (of the window 131) has been operated, the processing proceeds to step S123, where the state selecting unit 121 selects the state on the model map 132 specified by the user at the time of the registration button 135 being operated, as a selected state.

Further, the state selecting unit 121 stores the state ID of the selected state in unshown memory, and the processing proceeds from step S123 to step S124.

Also, in the event that determination is made in step S122 that the state registration operation has not been performed, the processing skips step S123 to proceed to step S124.

In step S124, the state selecting unit 121 determines whether or not the end operation has been performed by the user.

In the event that determination is made in step S124 that the end operation has not been performed, the processing returns to step S122, and hereafter, the same processing is repeated.

Also, in the event that determination is made in step S124 that the end operation has been performed, i.e., in the event that the user has operated the end button 136 (FIG. 24), the state selecting unit 121 supplies all the state IDs of the selected states stored in step S123 to the selected state registration unit 122, and the processing proceeds to step S125.

In step S125, the selected state registration unit 122 generates an empty scrapbook, and registers the state ID of the selected state from the state selecting unit 121 in the empty scrapbook thereof.

Further, in step S126, the selected state registration unit 122 takes the scrapbook in which the state IDs have been registered, as an initial scrapbook, and correlates the initial scrapbook thereof with the category of the content selected as the content of interest (content for presentation of interest) in the contents structure presentation processing (FIG. 13) in step S121.

Subsequently, the selected state registration unit 122 supplies and stores the initial scrapbook correlated with the category of the content of interest to the initial scrap book storage unit 102.

Subsequently, the window 131 (FIG. 24) displayed in the contents structure presentation processing in step S121 is closed, and the initial scrapbook generation processing ends.

Configuration Example of Registration Scrapbook Generating Unit 103

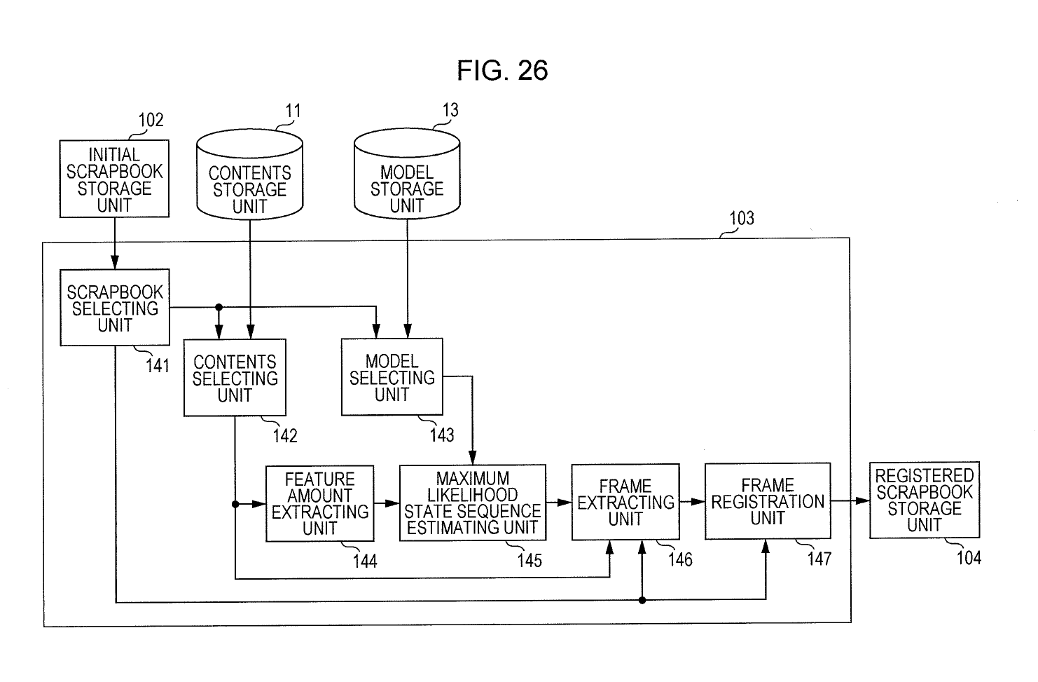

FIG. 26 is a block diagram illustrating a configuration example of the registered scrapbook generating unit 103 in FIG. 22.

In FIG. 26, the registered scrapbook generating unit 103 is configured of a scrapbook selecting unit 141, a contents selecting unit 142, a model selecting unit 143, a feature amount extracting unit 144, a maximum likelihood state sequence estimating unit 145, a frame extracting unit 146, and a frame registration unit 147.

The scrapbook selecting unit 141 selects one of the initial scrapbooks stored in the initial scrapbook storage unit 102 as the scrapbook of interest, and supplies to the frame extracting unit 146 and frame registration unit 147.

Also, the scrapbook selecting unit 141 supplies the category correlated with the scrapbook of interest to the contents selecting unit 142 and model selecting unit 143.

The contents selecting unit 142 selects one of the contents belonging to the category from the scrapbook selecting unit 141 out of the contents stored in the contents storage unit 11 as the content for scrapbook of interest (hereafter, also simply referred to as “content of interest”).

Subsequently, the contents selecting unit 142 supplies the content of interest to the feature amount extracting unit 144 and frame extracting unit 146.

The model selecting unit 143 selects the contents model correlated with the category from the scrapbook selecting unit 141 out of the contents models stored in the model storage unit 13 as the model of interest, and supplies to the maximum likelihood state sequence estimating unit 145.

The feature amount extracting unit 144 extracts, in the same way as with the feature extracting unit 22 in FIG. 2, the feature amount of each frame of (the image of) of the content of interest supplied from the contents selecting unit 142, and supplies (the time sequence of) the feature amount of each frame of the content of interest to the maximum likelihood state sequence estimating unit 145.

The maximum likelihood state sequence estimating unit 145 uses the cluster information of the model of interest from the model selecting unit 143 to subject (the time sequence of) the feature amount of the content of interest from the feature amount extracting unit 144 to clustering, thereby obtaining the code sequence of the content of interest.

The maximum likelihood state sequence estimating unit 145 estimates the maximum likelihood state sequence (the maximum likelihood state sequence of the code model of interest as to the content of interest) that is a state sequence causing state transition where likelihood is the highest that the code sequence of the content of interest will be observed in the code model of interest from the model selecting unit 143, for example, in accordance with the Viterbi algorithm.

Subsequently, the maximum likelihood state sequence estimating unit 145 supplies the maximum likelihood state sequence of the code model of interest as to the content of interest to the frame extracting unit 146.

The frame extracting unit 146 determines, with regard to each state of the maximum likelihood state sequence from the maximum likelihood state sequence estimating unit 145, whether or not the state ID matches the state ID (hereafter, also referred to as “registered state ID”) of a selected state registered in the scrapbook of interest from the scrapbook selecting unit 141.

Further, the frame extracting unit 146 extracts the frame corresponding to a state of the states of the maximum likelihood state sequence from the maximum likelihood state sequence estimating unit 145, of which the state ID matches a registered state ID registered in the scrapbook of interest from the scrapbook selecting unit 141, out of the content of interest from the contents selecting unit 142, and supplies to the frame registration unit 147.

The frame registration unit 147 registers the frame from the frame extracting unit 146 in the scrapbook of interest from the scrapbook selecting unit 141. Further, the frame registration unit 147 supplies and stores the scrapbook of interest after frame registration to the registered scrapbook storage unit 104 as a registered scrapbook.

Registered Scrapbook Generation Processing

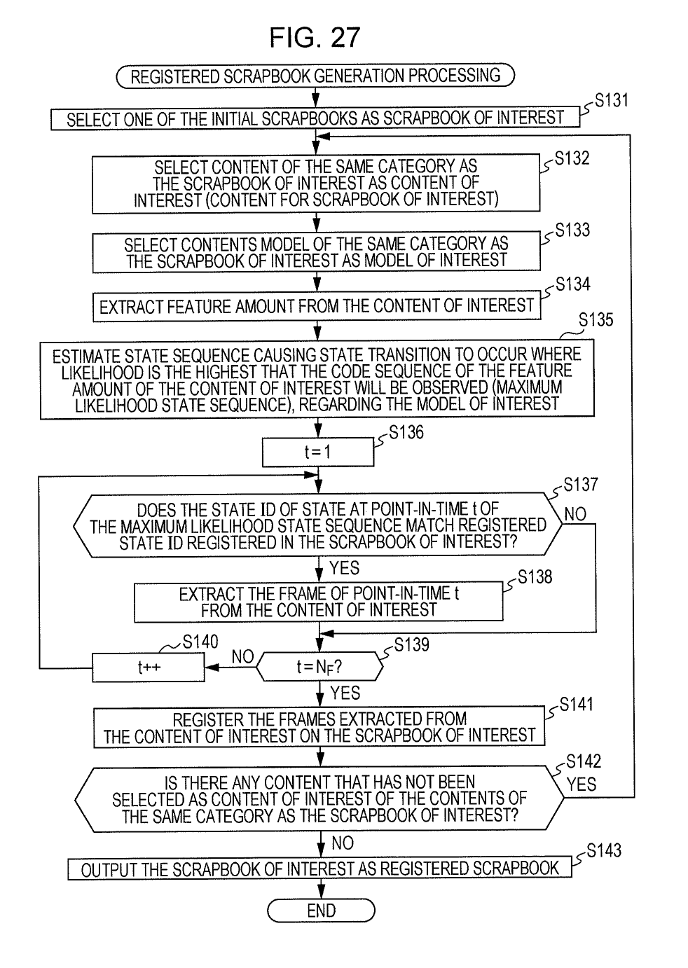

FIG. 27 is a flowchart for describing the registered scrapbook generation processing that the registered scrapbook generating unit 103 in FIG. 26 performs.

In step S131, the scrapbook selecting unit 141 selects, of the initial scrapbooks stored in the initial scrapbook storage unit 102, one of initial scrapbooks that have not been selected yet as the scrapbook of interest, as the scrapbook of interest.

Subsequently, the scrapbook selecting unit 141 supplies the scrapbook of interest to the frame extracting unit 146 and frame registration unit 147. Further, the scrapbook selecting unit 141 supplies the category correlated with the scrapbook of interest to the contents selecting unit 142 and model selecting unit 143, and the processing proceeds from step S131 to step S132.

In step S132, the contents selecting unit 142 selects, of the contents stored in the contents storage unit 11, one of contents that has not been selected yet as the content of interest (content for scrapbook of interest) out of the contents belonging to the category from the scrapbook selecting unit 141, as the content of interest.

Subsequently, the contents selecting unit 142 supplies the content of interest to the feature amount extracting unit 144 and frame extracting unit 146, and the processing proceeds from step S132 to step S133.

In step S133, the model selecting unit 143 selects, of the contents models stored in the model storage unit 13, a contents model correlated with the category from the scrapbook selecting unit 141, as the model of interest.

Subsequently, the model selecting unit 143 supplies the model of interest to the maximum likelihood state sequence estimating unit 145, and the processing proceeds from step S133 to step S134.

In step S134, the feature amount extracting unit 144 extracts the feature amount of each frame of the content of interest supplied from the contents selecting unit 142, and supplies (the time sequence of) the feature amount of each frame of the content of interest to the maximum likelihood state sequence estimating unit 145.

Subsequently, the processing proceeds from step S134 to step S135, where the maximum likelihood state sequence estimating unit 145 uses the cluster information of the model of interest from the model selecting unit 143 to subject (the time sequence of) the feature amount of the content of interest from the feature amount extracting unit 144 to clustering, thereby obtaining the code sequence of the content of interest.

Further, the maximum likelihood state sequence estimating unit 145 estimates the maximum likelihood state sequence (the maximum likelihood state sequence of the code model of interest as to the content of interest) causing state transition where likelihood is the highest that the code sequence of the content of interest will be observed in the code model of interest of the model of interest from the model selecting unit 143.

Subsequently, the maximum likelihood state sequence estimating unit 145 supplies the maximum likelihood state sequence of the model of interest as to the content of interest to the frame extracting unit 146, and the processing proceeds from step S135 to step S136.

In step S136, the frame extracting unit 146 sets the variable t for counting point-in-time (the number of frames of the content of interest) to 1 serving as the initial value, and the processing proceeds to step S137.

In step S137, the frame extracting unit 146 determines whether or not the state ID of the state at the point-in-time t (the t'th state from the head) of the maximum likelihood state sequence (the maximum likelihood state sequence of the code model of interest as to the content of interest) from the maximum likelihood state sequence estimating unit 145 matches one of the registered state IDs in a selected state registered in the scrapbook of interest from the scrapbook selecting unit 141.

In the event that determination is made in step S137 that the state ID of the state at the point-in-time t of the maximum likelihood state sequence of the code model of interest as to the content of interest matches one of the registered state IDs in a selected state registered in the scrapbook of interest, the processing proceeds to step S138, where the frame extracting unit 146 extracts the frame at the point-in-time t from the content of interest from the contents selecting unit 142, supplies to the frame registration unit 147, and the processing proceeds to step S139.

Also, in the event that determination is made in step S137 that the state ID of the state at the point-in-time t of the maximum likelihood state sequence of the code model of interest as to the content of interest does not match any of the registered state IDs in a selected state registered in the scrapbook of interest, the processing skips step S138 to proceed to step S139.

In step S139, the frame extracting unit 146 determines whether or not the variable t is equal to the total number N_{F} of the frames of the content of interest.

In the event that determination is made in step S139 that the variable t is unequal to the total number N_{F} of the frames of the content of interest, the processing proceeds to step S140, where the frame extracting unit 146 increments the variable t by one. Subsequently, the processing returns from step S140 to step S137, and hereafter, the same processing is repeated.

Also, in the event that determination is made in step S139 that the variable t is equal to the total number N_{F} of the frames of the content of interest, the processing proceeds to step S141, where the frame registration unit 147 registers the frames supplied from the frame extracting unit 146, i.e., all the frames extracted from the content of interest in the scrapbook of interest from the scrapbook selecting unit 141.

Subsequently, the processing proceeds from step S141 to step S142, where the contents selecting unit 142 determines whether or not, of the contents belonging to the same category as the category correlated with the scrapbook of interest, stored in the contents storage unit 11, there is a content that has not been selected yet as the content of interest.

In the event that determination is made in step S142 that, of the contents belonging to the same category as the category correlated with the scrapbook of interest, stored in the contents storage unit 11, there is a content that has not been selected yet as the content of interest, the processing returns to step S132, and hereafter, the same processing is repeated.

Also, in the event that determination is made in step S142 that, of the contents belonging to the same category as the category correlated with the scrapbook of interest, stored in the contents storage unit 11, there is no content that has not yet been selected as the content of interest, the processing proceeds to step S143, where the frame registration unit 147 outputs the scrapbook of interest to the registered scrapbook storage unit 104 as a registered scrapbook, and the registered scrapbook generation processing ends.

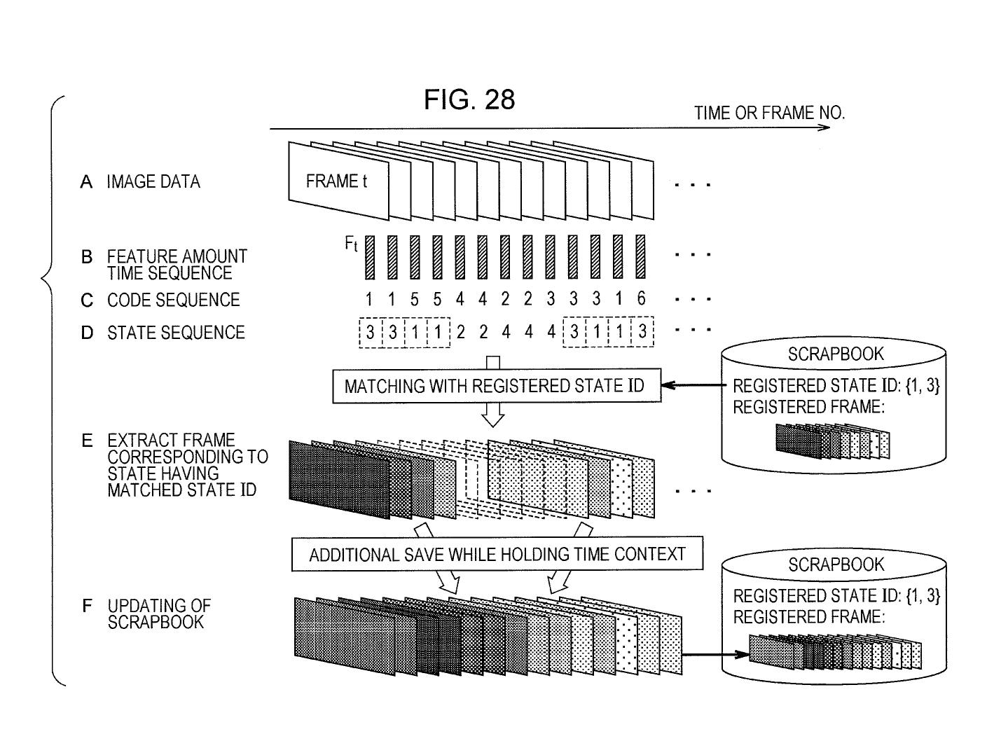

The registered scrapbook generation processing that the registered scrapbook generating unit 103 (FIG. 26) performs will further be described with reference to FIG. 28.

A in FIG. 28 illustrates the time sequence of the frames of the content selected as the content of interest (content for scrapbook of interest) at the contents selecting unit 142 (FIG. 26).

B in FIG. 28 illustrates the time sequence of the feature amount of the time sequence of the frames in A in FIG. 28, extracted at the feature amount extracting unit 144 (FIG. 26).

C in FIG. 28 illustrates a code sequence obtained by subjecting the feature amount of the time sequence of the content of interest in B in FIG. 28 to clustering.

D in FIG. 28 illustrates the maximum likelihood state sequence where the code sequence of the content of interest in C in FIG. 28 will be observed (the maximum likelihood state sequence of the code model of interest as to the content of interest) in the code model of interest, estimated at the maximum likelihood state sequence estimating unit 145 (FIG. 26).

Now, the entity of the maximum likelihood state sequence of the code model of interest as to the content of interest is, as described above, the sequence of state IDs. Subsequently, the t'th state ID from the head of the maximum likelihood state sequence of the code model of interest as to the content of interest is the state ID of a state (with a high probability) where the code of the feature amount of the t'th frame (at point-in-time t) of the content of interest (the state ID of the state corresponding to the frame t) will be observed in the maximum likelihood state sequence.

E in FIG. 28 illustrates frames extracted from the content of interest at the frame extracting unit 146 (FIG. 26).

In E in FIG. 28, “1” and “3” are registered as the registered state IDs of the scrapbook of interest, and each of the frames of which the state IDs are “1” and “3” is extracted from the content of interest.

F in FIG. 28 illustrates a scrapbook on which the frames extracted from the content of interest are registered (registered scrapbook).

With the scrapbook, the frames extracted from the content of interest are registered in a form maintaining the temporal context thereof, e.g., as a moving image.

As described above, the registered scrapbook generating unit 103 estimates the maximum likelihood state sequence causing state transition where likelihood is the highest that the feature amount of the content of interest will be observed in the model of interest, extracts, of the states of the maximum likelihood state sequence thereof, a frame corresponding to a state matching the state ID (registered state ID) of the state on the model map, specified by the user in the initial scrapbook generation processing (FIG. 25), out of the content of interest, and registers the frame extracted from the content of interest in the scrapbook, so the user simply specifies, in the model map, a state corresponding to a frame in which the user is interested (e.g., of scenes where a singer is singing a song, a frame showing a close-up of a face, etc.), whereby the scrapbook collected from frames containing the same material as the frame thereof can be obtained.

Note that, in FIG. 27, generation of a registered scrapbook has been performed with all the contents belonging to the category correlated with the scrapbook of interest as the content of interest, but generation of a registered scrapbook may be performed with just a single content specified by the user as the content of interest.

Also, with the registered scrapbook generation processing in FIG. 27, an arrangement has been made wherein at the scrapbook selecting unit 141, the scrapbook of interest is selected out of the initial scrapbooks stored in the initial scrapbook storage unit 102, and the frames extracted from the content of interest are registered in the scrapbook of interest thereof, but additionally, the scrapbook of interest may be selected out of the registered scrapbooks stored in the registered scrapbook storage unit 104.

Specifically, in the event that a new content has been stored in the contents storage unit 11, if there has already been a registered scrapbook correlated with the category of the new content thereof, the registered scrapbook generation processing (FIG. 27) may be performed with the new content thereof being taken as the content of interest, and also with the registered scrapbook correlated with the category of the content of interest as the scrapbook of interest.

Also, with the registered scrapbook generating unit 103 (FIG. 26), an arrangement may be made wherein in addition to the frames (image) from the content of interest, audio along with the frames thereof is extracted at the frame extracting unit 146, and is registered in an initial scrapbook at the frame registration unit 147.

Further, in the event that a new content has been stored in the contents storage unit 11, if there has already been a registered scrapbook correlated with the category of the new content thereof, the initial scrapbook generation processing (FIG. 25) including the contents structure presentation processing (FIG. 13) may be performed with the new content as the content of interest to additionally register the new state ID in the registered scrapbook.

Subsequently, in the event that the new state ID has additionally been registered in the registered scrapbook by the initial scrapbook generation processing, the registered scrapbook generation processing (FIG. 27) may be performed with the registered scrapbook thereof as the scrapbook of interest to extract, from the contents stored in the contents storage unit 11, a frame of which the state ID matches the new state ID additionally registered in the registered scrapbook so as to be additionally registered in the registered scrapbook.

In this case, from a content c from which a frame f that has already been registered in the registered scrapbook has been extracted, another frame f′ of which the state ID matches the new state ID additionally registered in the registered scrapbook may be extracted and additionally registered in the registered scrapbook.

This additional registration of the frame f′ in the registered scrapbook is performed so as to maintain temporal context with the frame f extracted from the content c from which the frame f′ thereof has been extracted.

Note that, in this case, it is necessary to determine the content c from which the frame f registered in the registered scrapbook has been extracted, so it is also necessary to register a content ID serving as information for determining the content c from which the frame f thereof has been extracted, in the registered scrapbook along with the frame f.

Now, with the highlight scene detection technique according to Japanese Unexamined Patent Application Publication No. 2005-189832, in the processing on the preceding stage, each of the mean value and dispersion of the motion vector sizes extracted from the image of a content is quantized to four or five labels, and also the feature amount extracted from the audio of the content is classified into labels of “applause”, “hit ball”, “female voice”, “male voice”, “music”, “music+voice”, and “noise” by a neural network sorter, thereby obtaining an image label time sequence and an audio label time sequence.

Further, with the highlight scene detection technique according to Japanese Unexamined Patent Application Publication No. 2005-189832, in the processing on the subsequent stage, a detector for detecting a highlight scene is obtained by learning employing the label time sequences.

Specifically, of the content data, with the data of a section serving as a highlight scene as learning data to be used for learning an HMM serving as a detector, learning of a discrete HMM (HMM with the observation value being a discrete value) is performed by providing each label sequence of the image and audio obtained from the learning data to the HMM.

Subsequently, each label time sequence of the image and audio of predetermined length (window length) is extracted from a content that is an object from which a highlight scene is detected by sliding window processing, and is given to the HMM after learning, whereby likelihood that a label time sequence will be observed is obtained in the HMM thereof.

Subsequently, in the event that the likelihood is greater than a predetermined threshold, the section of a label sequence where the likelihood has been obtained is detected as the section of a highlight scene.

According to the highlight scene detection technique according to Japanese Unexamined Patent Application Publication No. 2005-189832, an HMM serving as a detector for detecting a highlight scene can be obtained by learning without designing pre-knowledge from an expert regarding what kind of scene such as feature amount, an event, or the like becomes a highlight scene, by simply providing the data of a section serving as a highlight scene, of the content data, to the HMM as learning data.

As a result thereof, for example, providing the data of a scene in which the user is interested to the HMM as learning data enables the scene in which the user is interested to be detected as a highlight scene.

However, with the highlight scene detection technique according to Japanese Unexamined Patent Application Publication No. 2005-189832, (audio) feature amount adapted to labeling of, for example, “applause”, “hit ball”, “female voice”, “male voice”, “music”, “music+voice”, or “noise” is extracted with a particular genre content as a content to be detected, from such a particular genre content.

Accordingly, with the highlight scene detection technique according to Japanese Unexamined Patent Application Publication No. 2005-189832, a content to be detected is restricted to a particular genre content, and in order to eliminate such restriction, each time the genre of the content to be detected differs, it is necessary to design (determine beforehand) and extract feature amount adapted to the genre thereof. Also, the threshold of likelihood to be used for detection of the section of a highlight scene has to be determined for each content genre, but determination of such a threshold is difficult.

On the other hand, with the recorder in FIG. 1, the feature amount extracted from a content is used as is without being subjected to labeling representing what is in a content such as “applause” or the like to perform learning of a contents model (HMM), and the structure of the content is obtained in the code model in a self-organic manner, so as for the feature amount to be extracted from the content, general-purpose feature amount generally used for classification (identification) of a scene, or the like, can be employed instead of feature amount adapted to a particular genre.

Accordingly, with the recorder in FIG. 1, even in the event that various genres of content are contents to be detected, learning of a contents model has to be performed for each genre, but feature amount to be extracted from the content does not have to be changed for each genre.

Consequently, the highlight scene detection technique according to the recorder in FIG. 1 can be said to be a technique having extremely high versatility independent from content genres.

Also, with the recorder in FIG. 1, an interesting scene (frame) is specified by the user, a highlight label representing whether or not a highlight scene is subjected to labeling to each frame of a content to generate a highlight label sequence in accordance with the specification thereof, and learning of an HMM serving as a highlight detector is performed using a multi stream with the highlight label sequence as a component sequence, whereby the HMM serving as a highlight detector can readily be obtained even without designing pre-knowledge from an expert regarding what kind of scene such as feature amount or event or the like becomes a highlight scene.

In this way, the highlight detection technique according to the recorder in FIG. 1 is also high in versatility in that pre-knowledge from an expert is not necessary.

Subsequently, the recorder in FIG. 1 learns the user's preference, detects a scene suitable for the preference thereof (a scene with the user's interest) as a highlight scene, and presents a digest in which such highlight scenes are collected. Accordingly, “personalization” of viewing and listening of contents, as if it were, is realized, thereby broadening how to enjoy contents.

Application to Server Client System

With the recorder in FIG. 1, the entirety may be configured as a stand-alone device, but may also be configured by being classified into a server and a client as a server client system.

Now, as for contents models, and eventually, contents employed for learning of a contents model, contents (contents models) common to all the users may be employed.

On the other hand, a scene with a user's interest, i.e., a highlight scene for a user differs for each user.

Therefore, in the event that the recorder in FIG. 1 is configured as a server client system, for example, management (storage) of contents to be used for learning of a contents model may be performed by the server.

Also, for example, learning of the structure of a content, i.e., learning of a contents model may be performed by the server for each content category such as a content genre or the like, and further, management (storage) of a contents model after learning may also be performed by the server.

Also, for example, with the code model of a contents model, estimation of the maximum likelihood state sequence causing state transition where likelihood is the highest that the code sequence of the feature amount of a content will be observed, and further, management (storage) of the maximum likelihood state sequence serving as the estimation results thereof may also be performed by the server.

With the server client system, a client requests information necessary for processing from the server, and the server provides (transmits) the information requested from the client to the client. Subsequently, the client performs necessary processing using the information received from the server.

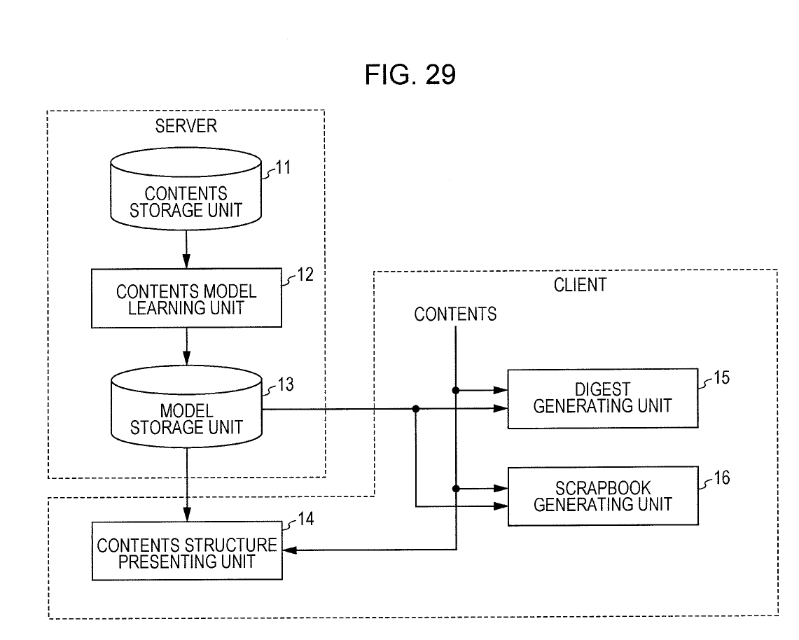

FIG. 29 is a block diagram illustrating, in the event that the recorder in FIG. 1 is configured of a server client system, a configuration example (first configuration example) of the server client system thereof.

In FIG. 29, the server is configured of a contents storage unit 11, a contents model learning unit 12, and a model storage unit 13, and the client is configured of a contents structure presenting unit 14, a digest generating unit 15, and a scrapbook generating unit 16.

Note that, in FIG. 29, contents may be provided to the client from the contents storage unit 11, and may also be provided from an unshown block (e.g., tuner, etc.) other than that.

In FIG. 29, the whole of the contents structure presenting unit 14 is provided to the client side, but with regard to the contents structure presenting unit 14, an arrangement may be made wherein a portion thereof is configured as the server, and the remaining portions are configured as the client.

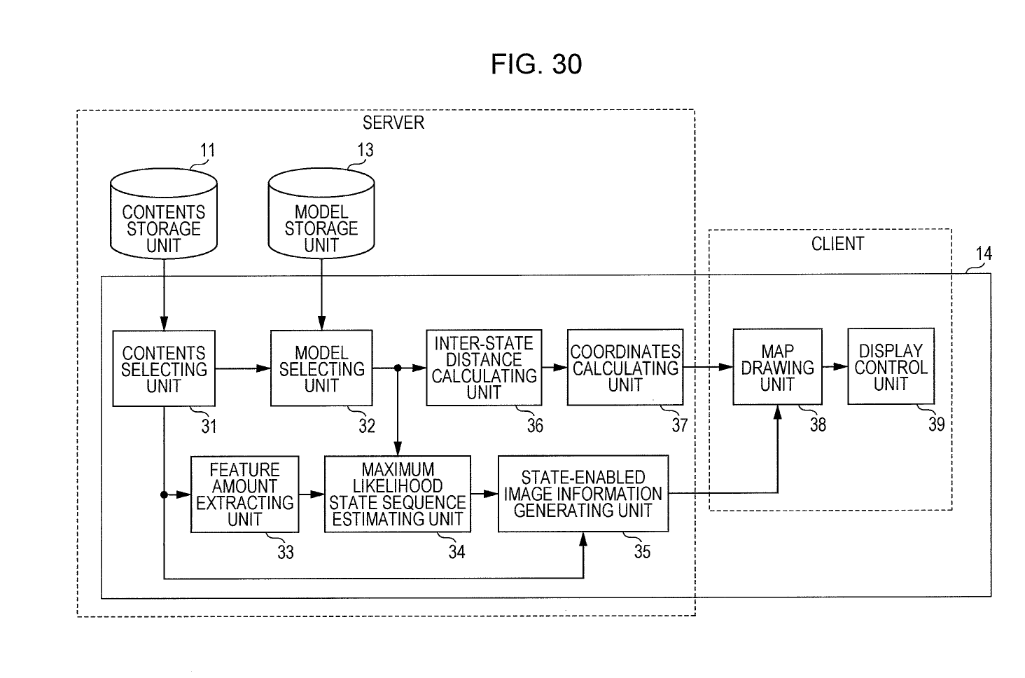

FIG. 30 is a block diagram illustrating a configuration example (second configuration example) of such a server client system.

In FIG. 30, the contents selecting unit 31 through coordinates calculating unit 37 serving as a portion of the contents structure presenting unit 14 (FIG. 9) are provided to the server, and the map drawing unit 38 and display control unit 39 serving as a remaining portion of the contents structure presenting unit 14 are provided to the client.

In FIG. 30, the client transmits a content ID serving as information for determining a content to be used for drawing of a model map to the server.

With the server, the content determined by the content ID from the client is selected as the content of interest at the contents selecting unit 31, and state coordinates necessary for generation (drawing) of a model map are obtained, and also state-enabled image information is generated.

Further, with the server, the state coordinates and the state-enabled image information are transmitted to the client, and with the client, a model map is drawn using the state coordinates from the server, and the model map thereof is linked to the state-enabled image information from the server. Subsequently, with the client, the model map is displayed.

Next, with the above FIG. 29, the whole of the digest generating unit 15 (FIG. 14) including the highlight detector learning unit 51 is provided to the client side, but with regard to the highlight detector learning unit 51 (FIG. 15), an arrangement may be made wherein a portion thereof is configured as the server, and the remaining portions are configured as the client.

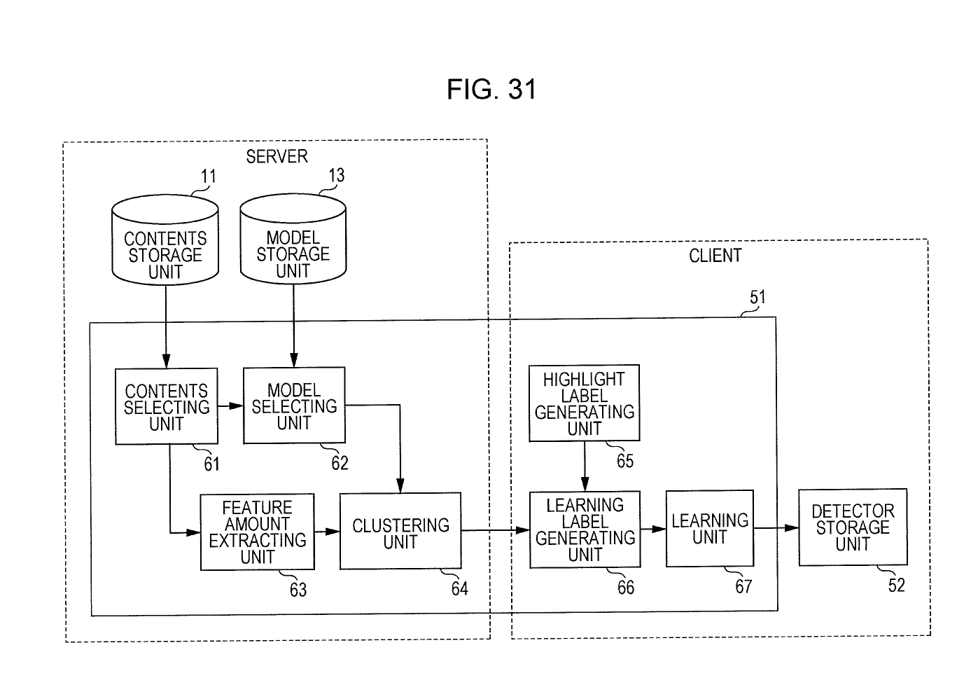

FIG. 31 is a block diagram illustrating a configuration example (third configuration example) of such a server client system.

In FIG. 31, the contents selecting unit 61 through clustering unit 64 serving as a portion of the highlight detector learning unit 51 (FIG. 15) are provided to the server, and the highlight label generating unit 65 through learning unit 67 serving as a remaining portion thereof are provided to the client.

In FIG. 31, the client transmits the content ID of a content to be used for learning of a highlight detector to the server.

With the server, the content determined by the content ID from the client is selected as the content of interest at the contents selecting unit 61, and the code sequence of the content of interest thereof is obtained. Subsequently, with the server, the code sequence of the content of interest is provided to the client.

With the client, a label sequence for learning is generated using the code sequence from the server, and learning of a highlight detector is performed using the label sequence for learning thereof. Subsequently, with the client, the highlight detector after learning is stored in the detector storage unit 52.

Next, with the above FIG. 29, the whole of the digest generating unit 15 (FIG. 14) including the highlight detecting unit 53 is provided to the client side, but with regard to the highlight detecting unit 53 (FIG. 18), an arrangement may be made wherein a portion thereof is configured as the server, and the remaining portions are configured as the client.

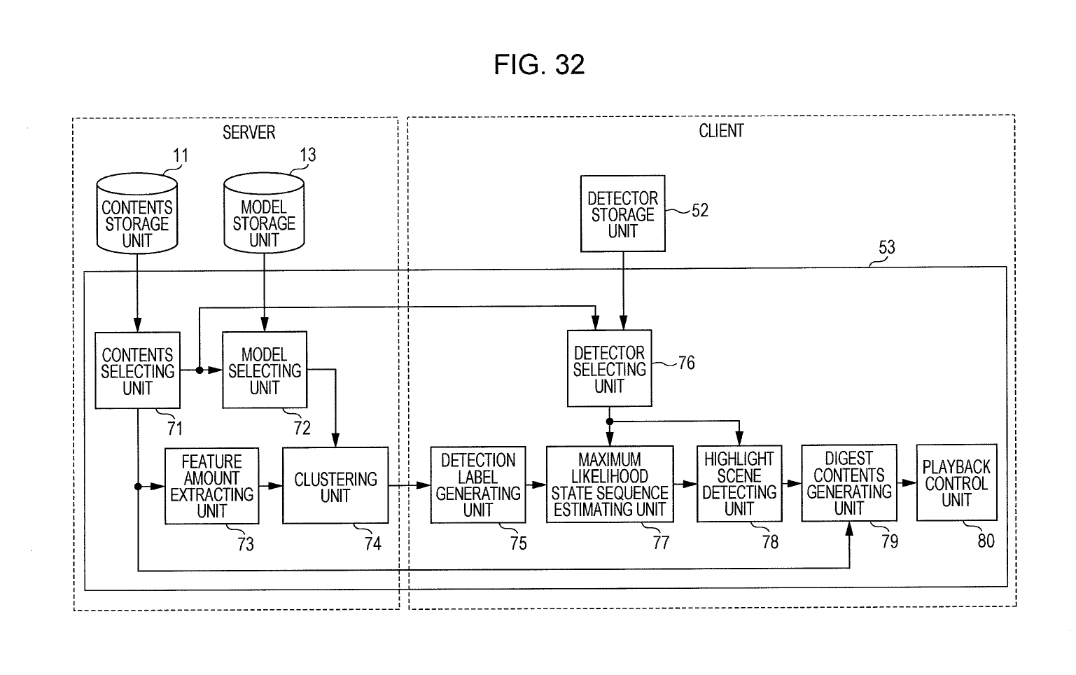

FIG. 32 is a block diagram illustrating a configuration example (fourth configuration example) of such a server client system.

In FIG. 32, the contents selecting unit 71 through clustering unit 74 serving as a portion of the highlight detecting unit 53 (FIG. 18) are provided to the server, and the detection label generating unit 75 through playback control unit 80 serving as a remaining portion thereof are provided to the client.

In FIG. 32, the client transmits the content ID of a content regarding which detection is to be made that is a highlight scene detection object to the server.

With the server, the content determined by the content ID from the client is selected as the content of interest at the contents selecting unit 71, and the code sequence of the content of interest is obtained. Subsequently, with the server, the code sequence of the content of interest is provided to the client.

With the client, a label sequence for detection is generated using the code sequence from the server, and detection of highlight scenes using the label sequence for detection and the highlight detectors stored in the detector storage unit 52, and generation of a digest content using the highlight scenes thereof are performed.

Next, with the above FIG. 29, the whole of the scrapbook generating unit 16 (FIG. 22) including the initial scrapbook generating unit 101 is provided to the client side, but with regard to the initial scrapbook generating unit 101 (FIG. 23), an arrangement may be made wherein a portion thereof is configured as the server, and the remaining portions are configured as the client.

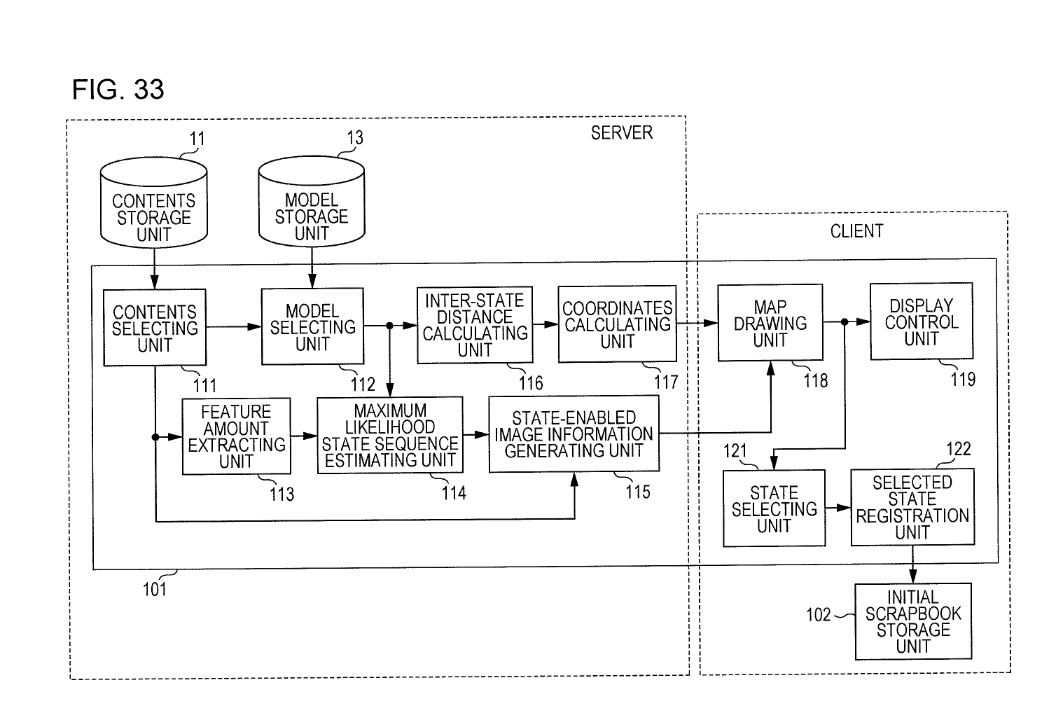

FIG. 33 is a block diagram illustrating a configuration example (fifth configuration example) of such a server client system.

In FIG. 33, the contents selecting unit 111 through coordinates calculating unit 117 serving as a portion of the initial scrapbook generating unit 101 (FIG. 23) are provided to the server, and the map drawing unit 118, display control unit 119, state selecting unit 121, and selected state registration unit 122 serving as a remaining portion thereof are provided to the client.

In FIG. 33, the client transmits a content ID serving as information for determining a content to be used for drawing of a model map to the server.

With the server, the content determined by the content ID from the client is selected as the content of interest at the contents selecting unit 111, and state coordinates necessary for generation (drawing) of a model map are obtained, and also state-enabled image information is generated.

Further, with the server, the state coordinates and the state-enabled image information are transmitted to the client, and with the client, a model map is drawn using the state coordinates from the server, and the model map thereof is linked to the state-enabled image information from the server. Subsequently, with the client, the model map is displayed.

Also, with the client, according to the user's operations, a state on the model map is selected as a selected state, and the state ID of the selected state thereof is recognized. Subsequently, with the client, the state ID of the selected state is registered in a scrapbook, and the scrapbook thereof is stored in the initial scrapbook storage unit 102 as an initial scrapbook.

Next, with the above FIG. 29, the whole of the scrapbook generating unit 16 (FIG. 22) including the registered scrapbook generating unit 103 is provided to the client side, but with regard to the registered scrapbook generating unit 103 (FIG. 26), an arrangement may be made wherein a portion thereof is configured as the server, and the remaining portions are configured as the client.

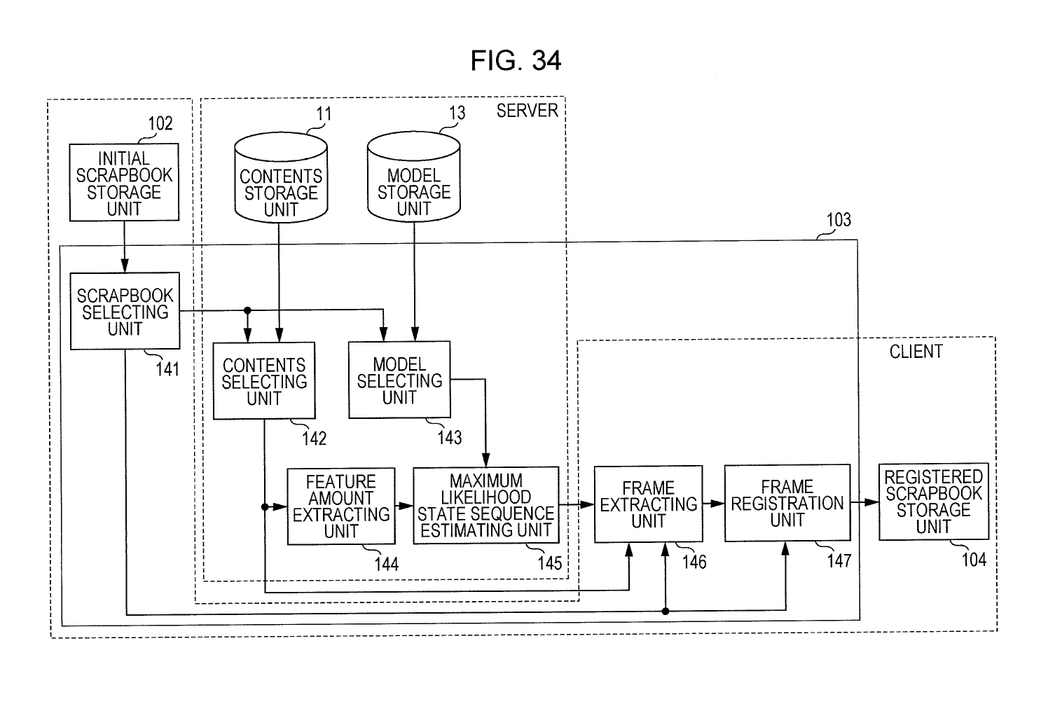

FIG. 34 is a block diagram illustrating a configuration example (sixth configuration example) of such a server client system.

In FIG. 34, the contents selecting unit 142 through maximum likelihood state sequence estimating unit 145 serving as a portion of the registered scrapbook generating unit 103 (FIG. 26) are provided to the server, and the scrapbook selecting unit 141, frame extracting unit 146, and frame registration unit 147 serving as a remaining portion thereof are provided to the client.

In FIG. 34, the client transmits the category correlated with the scrapbook of interest selected by the scrapbook selecting unit 141 to the server.

With the server, as to a content of the category from the client, the maximum likelihood state sequence of the code model of a contents model correlated with the category thereof is estimated, and is provided to the client along with the content of the category from the client.

With the client, of the states of the maximum likelihood state sequence from the server, a frame corresponding to a state of which the state ID matches the state ID (registered state ID) registered in the scrapbook of interest selected at the scrapbook selecting unit 141 is extracted from the content from the server, and is registered in the scrapbook.

As described above, the recorder in FIG. 1 is configured by being divided into the server and the client, whereby processing can rapidly be performed even when the client has low hardware performance.

Note that, of the processing that the recorder in FIG. 1 performs, as long as the client performs processing of a part where the user's preference is reflected, how to divide the recorder in FIG. 1 into the server and the client is not particularly restricted.

Configuration Example of Other Recorders

Description has been made above regarding an example wherein feature amount obtained from a frame-based image is used to learn a contents model by structuring a video content in a self-organized manner, to present a content structure, or to generate a digest video or video scrap. However, at the time of learning a contents model, other than a frame-based image may be employed as feature amount, and for example, audio or an object within an image or the like may be employed as feature amount.

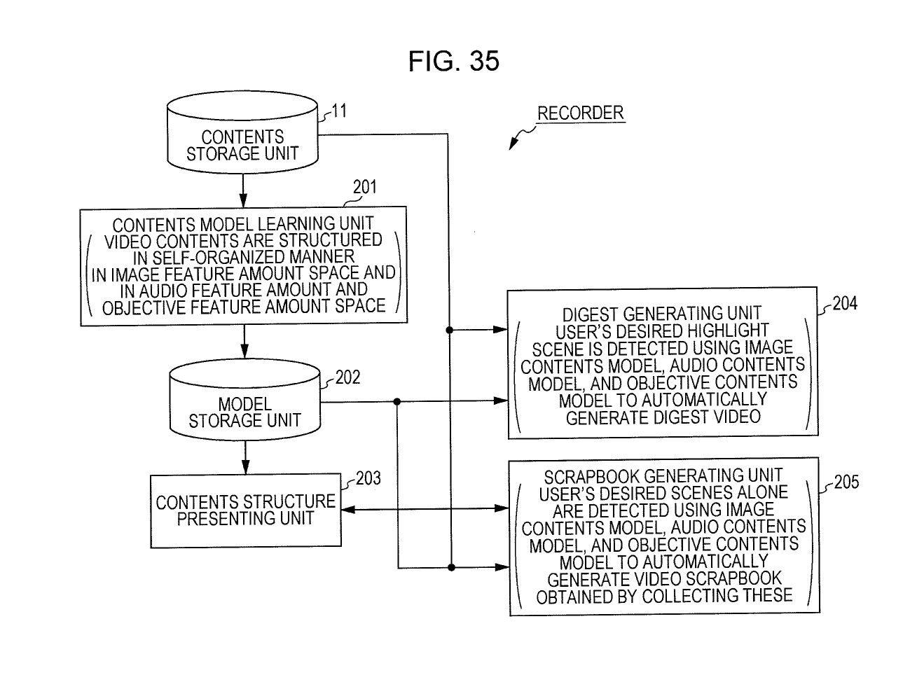

FIG. 35 is a block diagram illustrating a configuration example of another embodiment of a recorder to which the information processing device of the present invention has been applied, which employs feature amount other than a frame-based image. Note that a configuration having the same function as with the recorder in FIG. 1 is denoted with the same reference numeral, and description thereof will be omitted as appropriate.

Specifically, the recorder in FIG. 35 differs from the recorder in FIG. 1 in that a contents model learning unit 201, a model storage unit 202, a contents structure presenting unit 203, a digest generating unit 204, and a scrapbook generating unit 205 are provided instead of the contents model learning unit 12, model storage unit 13, contents structure presenting unit 14, digest generating unit 15, and scrapbook generating unit 16.

The contents model learning unit 201, model storage unit 202, contents structure presenting unit 203, digest generating unit 204, and scrapbook generating unit 205 have basically the same function as with the contents model learning unit 12, model storage unit 13, contents structure presenting unit 14, digest generating unit 15, and scrapbook generating unit 16. However, feature amount treated at the corresponding units differs in that the former handles three types of feature amount of further audio feature amount, and object feature amount in addition to the feature amount of the above frame-based image (hereafter, also referred to as image feature amount). Note that description will be made here regarding an example handling three types of feature amount, but the number of types of feature amount to be handled is not restricted to three, so the number of types of feature amount to be handled may exceed three.

Configuration Example of Contents Model Learning Unit 201

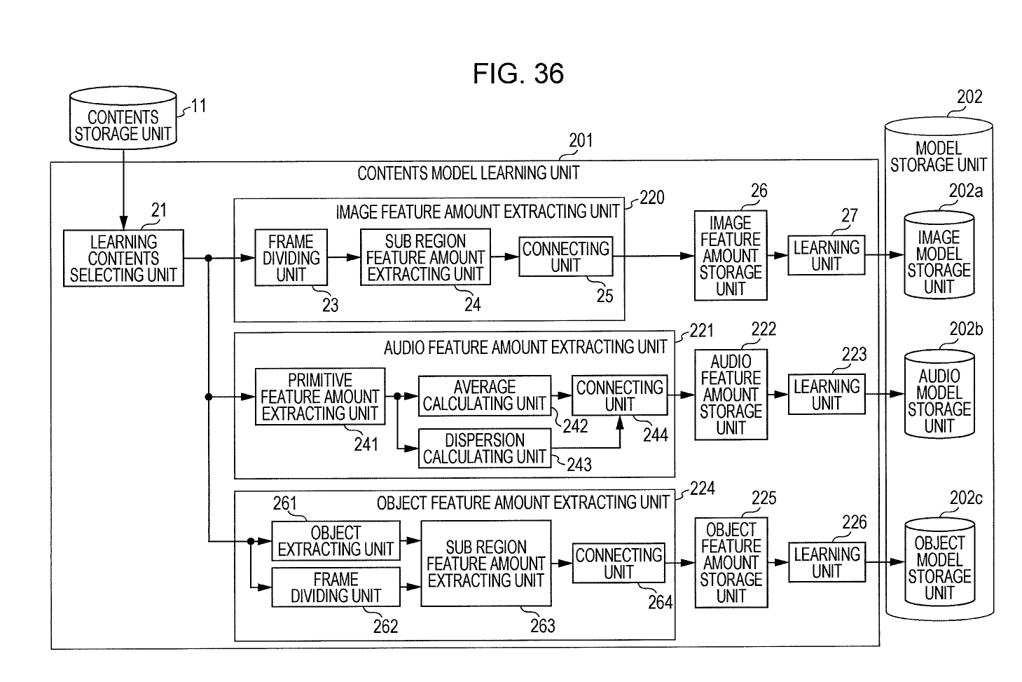

FIG. 36 is a block diagram illustrating a configuration example of the contents model learning unit 201 in FIG. 35. Note that, with the configuration of the contents model learning unit 201 in FIG. 36, a configuration having the same function as with the contents model learning unit 12 described in FIG. 2 is denoted with the same reference numeral, and description thereof will be omitted.

The contents model learning unit 201 extracts image feature amount, audio feature amount, and object feature amount as the feature amount of each frame of the image of a content for learning that is a content to be used for cluster learning and model learning. Subsequently, the contents model learning unit 201 performs learning of a contents model using the image feature amount, audio feature amount, and object feature amount of the content for learning.

The image feature amount extracting unit 220 is the same as the feature amount extracting unit 22 in FIG. 2, and further, the image feature amount storage unit 26 and the learning unit 27 are the same as those in FIG. 2. Specifically, the configuration for handling image feature amount is the same as with the contents model learning unit 12 in FIG. 2. Also, with the learning unit 27, a contents model obtained from learning is stored in an image model storage unit 202a in the model storage unit 202. Specifically, the image model storage unit 202a is the same as the model storage unit 13 in FIG. 2. Note that the contents model stored in the image model storage unit 202a is a contents model obtained from image feature amount, so hereafter will also be referred to as an image contents model.

The audio feature amount extracting unit 221 extracts feature amount regarding the audio of the content for learning in a manner correlated with each frame of the image.

The audio feature amount extracting unit 221 inversely multiplexes the content for learning from the learning contents selecting unit 21 to image data and audio data, extracts audio feature amount in a manner correlated with each frame of the image, and supplies to the audio feature amount storage unit 222. Note that, hereafter, the feature amount regarding the frame-based audio mentioned here will be referred to as audio feature amount.

Specifically, the audio feature amount extracting unit 221 is configured of a primitive feature amount extracting unit 241, an average calculating unit 242, a dispersion calculating unit 243, and a connecting unit 244.

The primitive feature amount extracting unit 241 extracts primitive feature amount that is primitive feature amount for generating audio feature amount suitable for classifying audio into scenes (e.g., “music”, “non-music”, “noise”, “human voice”, “human voice+music”, “music”, etc.) which is used for an audio classification (sound classification) field. The primitive feature amount is used for audio classification, and examples thereof include energy obtained from audio signals by calculation in relatively short time basis such as 10-msec order or so, a zero crossing rate, and spectrum center of gravity.

More specifically, the primitive feature amount extracting unit 241 extracts primitive feature amount using a feature amount extracting method described in, for example, “Zhu Liu; Jincheng Huang; Yao Wang; Tsuhan Chen, Audio feature extraction and analysis for scene classification, First Workshop on Multimedia Signal Processing, 1997., IEEE Volume, Issue, 23-25 Jun. 1997 Page(s): 343-348”, and “Brezeale, D. Cook, D. J., Automatic Video Classification: A Survey of the Literature, IEEE Transactions on Systems, Man, and Cybernetics, Part C: Applications and Reviews, May 2008, Volume: 38, Issue: 3, pp. 416-430”.

The average calculating unit 242 extracts feature amount in a longer predetermined time basis in time sequence by calculating a mean value as statistics amount in a longer predetermined time basis (commonly, 1 sec or more) from the primitive feature amount time sequence, and supplies to the connecting unit 244.

The dispersion calculating unit 243 extracts feature amount in a longer predetermined time basis in time sequence by calculating dispersion as statistics amount in a longer predetermined time basis (commonly, 1 sec or more) from the primitive feature amount time sequence, and supplies to the connecting unit 244.

The connecting unit 244 connects the mean value and dispersion obtained as statistical amount from the primitive feature amount time sequence, and supplies the connection result to the audio feature amount storage unit 222 as the feature amount of the frame of interest.

More specifically, in order to realize later-described processing, audio feature amount has to be extracted so as to synchronize with the above image feature amount. Also, audio feature amount is preferably feature amount adapted to distinguish a scene by audio at each point-in-time when image feature amount is extracted, so audio feature amount is generated in accordance with the following technique.

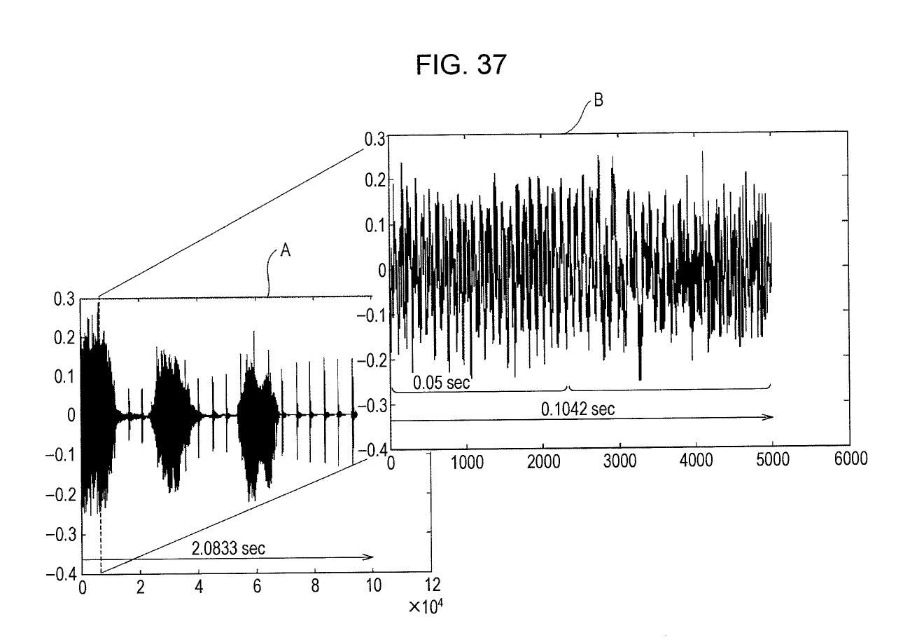

Specifically, first, in the event that a tone signal is a stereo audio signal, the primitive feature amount extracting unit 241 converts the stereo audio signal into a monaural audio signal. Subsequently, the primitive feature amount extracting unit 241 gradually shifts, as illustrated in the waveform charts A and B in FIG. 37, the window of time width of 0.05 sec. with step width of 0.05 sec., and extracts the primitive feature amount of the audio signal within the window. Here, with the waveform charts A and B, in either charts, the vertical axis represents the amplitude of the audio signal, and the horizontal axis represents time. Also, the waveform chart B displays resolution regarding a portion of the waveform chart A, and with the waveform chart A, a range of 0 (×10⁴) through 10 (×10⁴) is a 2.0833-sec scale, and with the waveform chart B, a range of 0 through 5000 is a 0.1042-sec scale. Note that, with regard to the primitive feature amount, multiple types may be extracted from the audio signal within the window. In this case, the primitive feature amount extracting unit 241 makes up a vector with these multiple types as elements to obtain primitive feature amount.

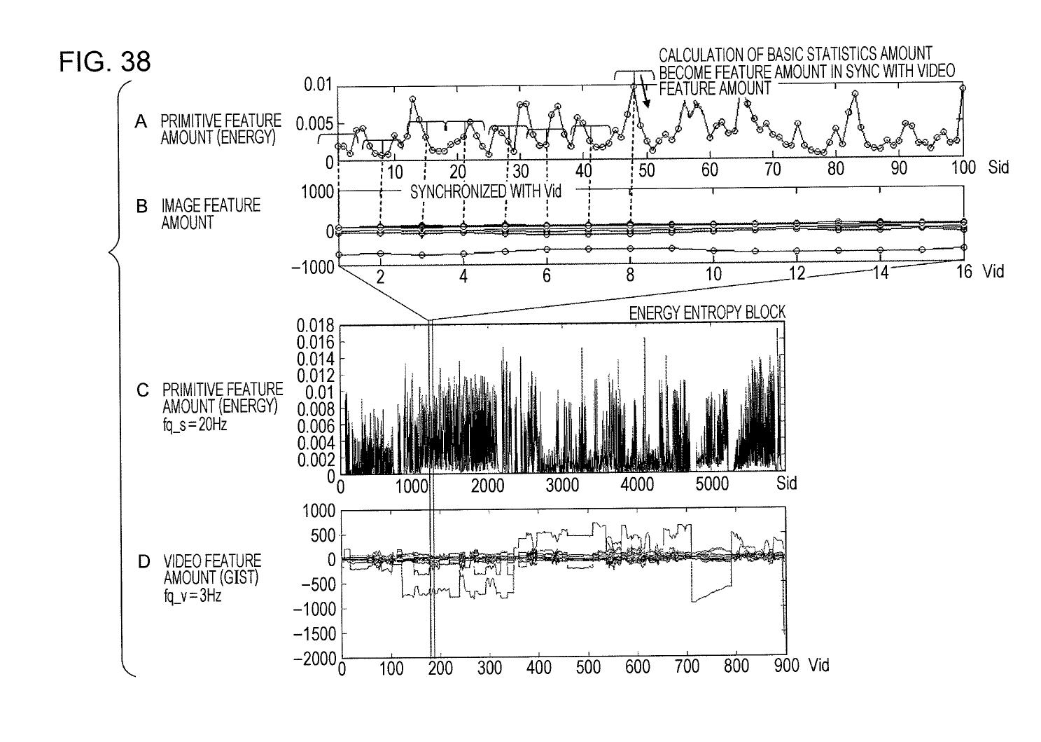

Subsequently, at each point-in-time when image feature amount is extracted (e.g., frame start point-in-time, or midpoint point-in-time between frame start point-in-time and frame end point-in-time), as illustrated in FIG. 38, the average calculating unit 242 and dispersion calculating unit 243 obtain the mean value and dispersion of the primitive feature amount of 0.5-sec worth before and after the point-in-time thereof respectively (i.e., 10-sec worth), and the audio feature amount extracting unit 221 takes these as the audio feature amount at this point-in-time.

In FIG. 38, from the top, the waveform chart A is a waveform illustrating relationship between an identifier (point-in-time when primitive feature amount is extracted) Sid for identifying the sampling data of audio information, and energy that is primitive feature amount, and the waveform chart B is a waveform illustrating relationship between an identifier (point-in-time when primitive feature amount is extracted) Vid for identifying frames of an image, and image feature amount (GIST). Note that, with the waveform charts A and B, circle marks represent primitive feature amount and image feature amount, respectively.

Also, the waveform charts C and D are waveforms serving as the origins of the waveform charts A and B respectively, and the waveform charts A and B are waveforms where the display intervals of the identifiers Sid and Vid of the horizontal axes of portions of the waveform charts C and D are enlarged. FIG. 38 illustrates an example when the sampling rate fq_s of the audio primitive feature amount is 20 Hz, and the sampling rate fq_v of image feature amount is 3 Hz.

The audio identifier Sid of primitive feature amount in sync with the frame of a certain image identifier Vid is indicated with the following Expression (4).

Sid=ceil((Vid−1)×(fq_{—}s/fq_{—}v))+1 (4)

Here, ceil( ) is a function indicating rounding in a positive infinite direction (the minimum integer equal to or greater than a value within the parentheses).

Now, if we say that the number of samples W of primitive feature amount to be used for obtaining a mean value serving as audio feature amount is represented by Expression (5) with a predetermined constant K as 1, the number of samples W is 7. In this case, with the frame of a certain image identifier Vid, the mean value and dispersion of the primitive feature amount of W=7 with the audio identifier Sid satisfying Expression (4) as the center become the corresponding (synchronous) audio feature amount.

W=round(K×(fq_{—}s/fq_{—}v)) (5)

Here, round( ) is a function for converting into the nearest integer (rounding below a decimal point within parentheses). Note that, in Expression (5), if we say that the constant K=fq_v, the primitive feature amount to be used for obtaining audio feature amount becomes 1-sec worth of primitive feature amount.

The audio feature amount thus extracted is stored in the audio feature amount storage unit 222. Note that functions regarding the audio feature amount storage unit 222 and learning unit 223 are the same as with the image feature amount storage unit 26 and learning unit 27, so description thereof will be omitted. Further, a contents model obtained by the learning unit 223 performing cluster learning and model learning is stored in the audio model storage unit 202b of the model storage unit 202 as an audio contents model.

The object feature amount extracting unit 224 extracts feature amount in a manner correlated with an object regarding each frame of the image of a content for learning.

The object feature amount extracting 224 inversely multiplexes the content for learning from the learning contents selecting unit 21 to image data and audio data, and detects an existence range of an object, for example, such as a person, and a face included in each frame of the image as a rectangular image. Subsequently, the object feature amount extracting unit 224 extracts feature amount using the detected rectangular image, and supplies to the object feature amount storage unit 225.

Specifically, the object feature amount extracting unit 224 is configured of an object extracting unit 261, a frame dividing unit 262, a sub region feature amount extracting unit 263, and a connecting unit 264.

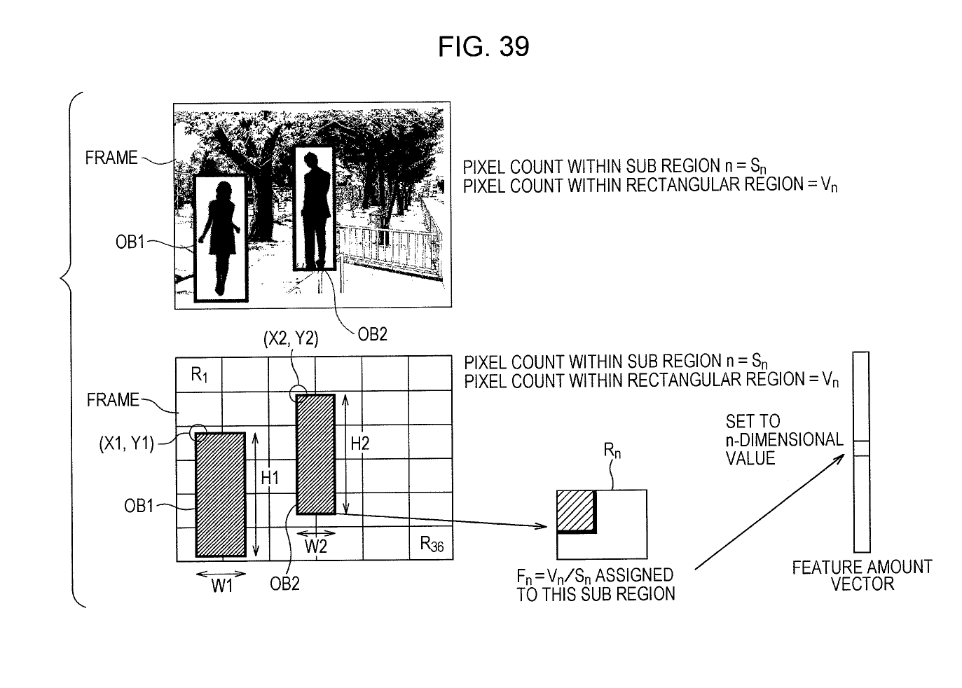

The object extracting unit 261 first inversely multiplexes the content for learning to image data and audio data. Next, the object extracting unit 261 executes object detection processing regarding each frame of the image, and if we say that the object is a person's whole body appearance, as illustrated in the upper left portion in FIG. 39, detects objects OB1 and OB2 made up of a rectangular region within the frame. Subsequently, the object extracting unit 261 outputs vectors (X1, Y1, W1, H1) and (X2, Y2, W2, H2) made up of the upper left coordinates and width and height of a rectangular region including a detected object, indicated with a shaded portion in the lower left portion in FIG. 39, to the sub region feature amount extracting unit 263. Note that in the event that multiple objects have been detected, and multiple rectangular regions have been output, this information is output to one frame, equivalent to the number of detections.

At the same time, the frame dividing unit 262 divides, in the same way as with the frame dividing unit 23, a frame into, for example, sub regions R₁ through R₃₆ (6×6) as illustrated in the lower left portion in FIG. 39, and supplies to the sub region feature amount extracting unit 263.

The sub region feature amount extracting unit 263 counts, as illustrated in the middle lower portion in FIG. 39, the number of pixels Vₙ, of a rectangular region in each sub region Rₙ, and accumulates only detection count worth. Further, the sub region feature amount extracting unit 263 normalizes the image size by dividing the number of pixels Vₙ of the rectangular region by the total number of pixels Sₙ within the sub region, and outputs to the connecting unit 264.

The connecting unit 264 connects, as illustrated in the lower right portion in FIG. 39, a value Fₙ=Vₙ/Sₙ calculated in each sub region Rₙ as a vector component, thereby generating a vector serving as object feature amount to output to the object feature amount storage unit 225. Note that functions regarding the object feature amount storage unit 225 and learning unit 226 are the same as with the image feature amount storage unit 26 and learning unit 27, description thereof will be omitted. Further, the contents model obtained by the learning unit 226 performing cluster learning and model learning is stored in the object model storage unit 202c of the model storage unit 202 as an object contents model.

Contents Model Learning Processing Performed by Contents Model Learning Unit 201

Next, the contents learning processing that the contents model learning unit 201 in FIG. 36 performs will be described. The contents learning processing that the contents model learning unit 201 in FIG. 36 performs is made up of image contents model learning processing, audio contents model learning processing, and object contents model learning processing, according to the type of feature amount. Of these, the image contents model learning processing is the same as the contents model learning processing described with reference to FIG. 8, and a generated image contents model is simply stored in the image model storage unit 202a, so description thereof will be omitted.

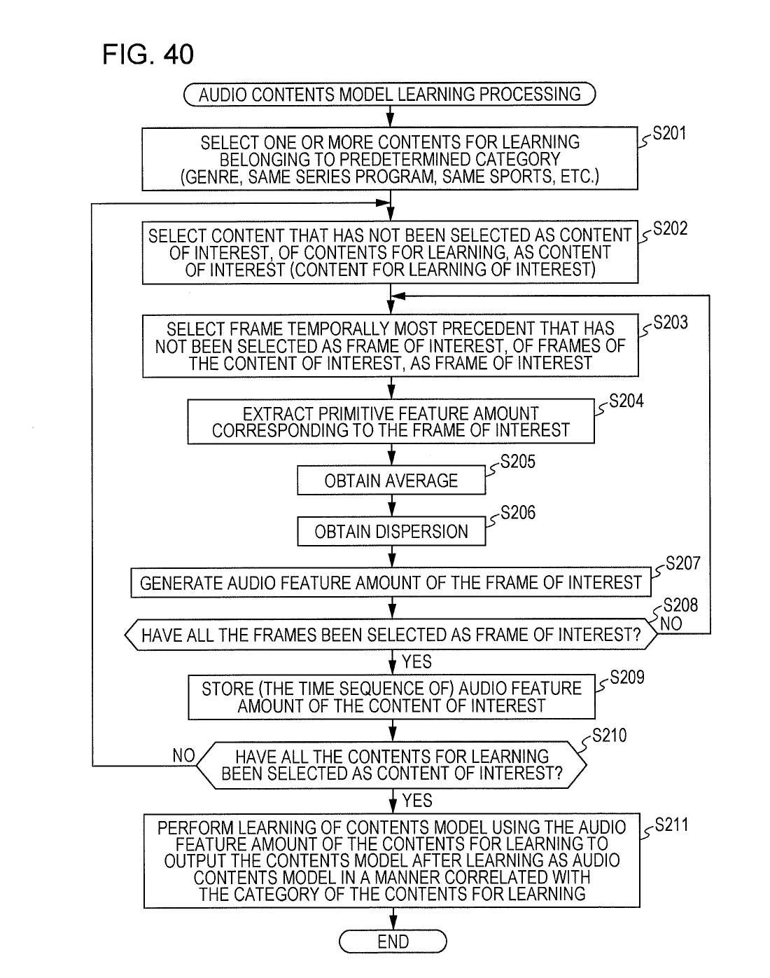

Next, the audio contents model learning processing that the contents model learning unit 201 in FIG. 36 performs will be described with reference to the flowchart in FIG. 40. Note that the processing in step S201 in FIG. 40 is the same as the processing in step S11 in FIG. 8, so description thereof will be omitted.

In step S202, the primitive feature amount extracting unit 241 of the audio feature amount extracting unit 221 selects one of contents for learning that have not been selected yet as the content for learning of interest (hereafter, also referred to as “content of interest”) out of the contents for learning from the learning contents selecting unit 21, as the content of interest.

Subsequently, the processing proceeds from step S202 to step S203, where the primitive feature amount extracting unit 241 selects a temporally most preceding frame that has not been selected as the frame of interest, out of the frames of the content of interest, as the frame of interest, and the processing proceeds to step S204.

In step S204, the primitive feature amount extracting unit 241 extracts, as described with reference to FIG. 37 and FIG. 38, primitive feature amount to be used for generating audio feature amount corresponding to the frame of interest out of audio of the content of interest. Subsequently, the primitive feature amount extracting unit 241 supplies the extracted primitive feature amount to the average calculating unit 242 and dispersion calculating unit 243.

In step S205, the average calculating unit 242 calculates, of the supplied primitive feature amount, a mean value regarding the frame of interest worth, and supplies to the connecting unit 244.

In step S206, the dispersion calculating unit 243 calculates, of the supplied primitive feature amount, dispersion regarding the frame of interest worth, and supplies to the connecting unit 244.

In step S207, the connecting unit 244 connects the mean value of primitive feature amount of the frame of interest, supplied from the average calculating 242, and the dispersion of the primitive feature amount of the frame of interest, supplied from the dispersion calculating unit 243, thereby making up a feature amount vector. Subsequently, the connecting unit 244 generates this feature amount vector as the audio feature amount of the frame of interest, and the processing proceeds to step S208.

In step S208, the frame dividing unit 23 determines whether or not all the frames of the content of interest have been selected as the frame of interest.

In the event that determination is made in step S208 that, of the frames of the content of interest, there is a frame that has not been selected as the frame of interest, the processing returns to step S203, and hereafter, the same processing is repeated.

Also, in the event that determination is made in step S208 that all the frames of the content of interest have been selected as the frame of interest, the processing proceeds to step S209, where the connecting unit 244 supplies and stores (the time sequence of) the feature amount of each frame of the content of interest obtained regarding the content of interest to the audio feature amount storage unit 222.

Subsequently, the processing proceeds from step S209 to step S210, where the primitive feature amount extracting unit 241 determines whether or not all the contents for learning from the learning contents selecting unit 21 have been selected as the content of interest.

In the event that determination is made in step S210 that there is, of the contents for learning, a content for learning that has not been selected yet as the content of interest, the processing returns to step S202, and hereafter, the same processing is repeated.

Also, in the event that determination is made in step S210 that all the contents for learning have been selected as the content of interest, the processing proceeds to step S211, where the learning unit 223 uses the audio feature amount (the time sequence of the audio feature amount of each frame) of the content for learning stored in the audio feature amount storage unit 222 to perform learning of a contents model.

Specifically, the learning unit 223 uses the audio feature amount of the content for learning to perform cluster learning, thereby obtaining cluster information (e.g., code book).

Further, the learning unit 223 uses the cluster information obtained by performing cluster learning using the audio feature amount of the content for learning to subject the audio feature amount of the content for learning to clustering, thereby obtaining the code sequence of the audio feature amount of the content for learning.

Also, the learning unit 223 uses the code sequence of the audio feature amount of the content for learning to perform model learning of an HMM that is a state transition model, for example.

Subsequently, the learning unit 223 outputs (supplies) a set of the HMM (code model) after model learning using the code sequence of the audio feature amount of the content for learning, and the cluster information obtained by cluster learning to the audio model storage unit 202b as an audio contents model in a manner correlated with the category of the content for learning, and the audio contents model learning processing ends.

Note that the audio contents model learning processing may be started at an arbitrary timing.

According to the above audio contents model learning processing, the structure of a content (e.g., structure created from audio or the like) hidden in a content for learning is obtained in a self-organized manner with the HMM serving as an audio contents model.

As a result thereof, each state of the HMM serving as an audio contents model obtained in the audio contents model learning processing corresponds to an element of the structure of a content obtained by learning, and state transition expresses temporal transition between elements of the structure of the content.

Subsequently, the state of the HMM serving as an audio contents model expresses a frame group of having spatially near distance and temporally similar context (i.e., “similar scenes”) in audio feature amount space (the space of audio feature amount extracted at the audio feature amount extracting unit 221 (FIG. 36)) in a collected manner.

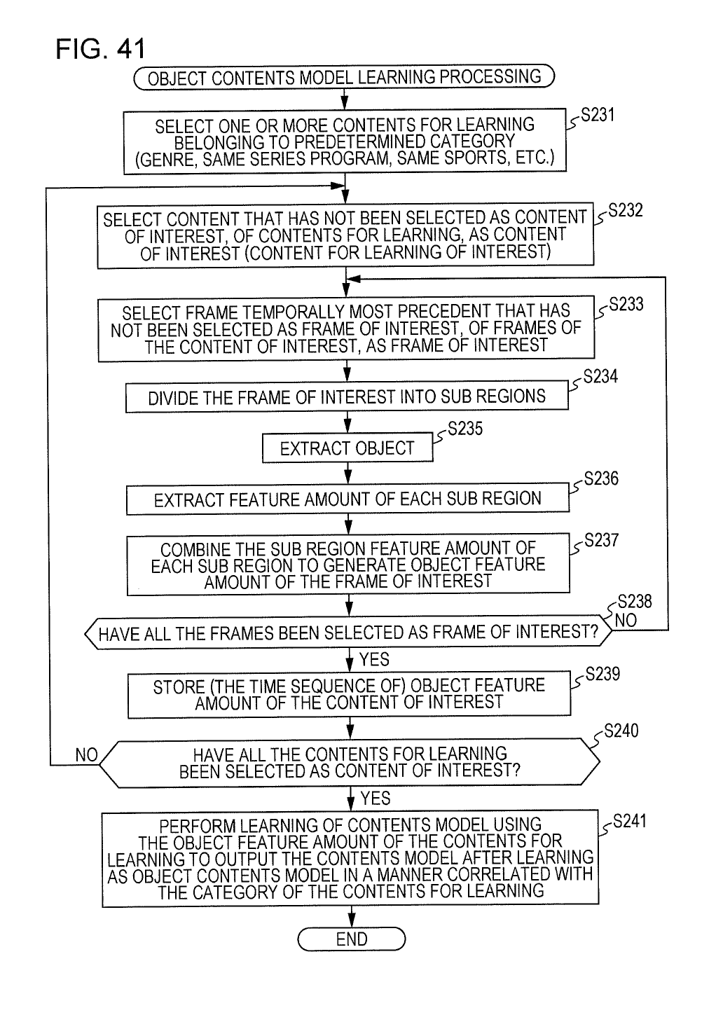

Next, the object contents model learning processing that the contents model learning unit 201 in FIG. 36 performs will be described with reference to the flowchart in FIG. 41. Note that the processing in step S231 in FIG. 41 is the same as the processing in step S11 in FIG. 8, so description thereof will be omitted.

In step S232, the frame dividing unit 262 of the object feature amount extracting unit 224 selects, of the contents for learning from the learning contents selecting unit 21, one of contents for learning that have not been selected yet as the content for learning of interest (hereafter, also referred to as “content of interest”), as the content of interest.

Subsequently, the processing proceeds from step S232 to step S233, where the frame dividing unit 262 selects a temporally most preceding frame that has not been selected as the frame of interest, out of the frames of the content of interest, as the frame of interest, and the processing proceeds to step S234.

In step S234, the frame dividing unit 262 divides the frame of interest into multiple sub regions, and supplies to the sub region feature amount extracting unit 263, and the processing proceeds to step S235.

In step S235, the object extracting unit 261 detects an object included in the frame of interest, takes the region including the detected object as a rectangular region, and outputs a vector made up of the upper left coordinates, width, and height of the rectangular region to sub region feature amount extracting unit 263.

In step S236, the sub region feature amount extracting unit 263 counts the number of pixels Vₙ making up the rectangular region including the object regarding each sub region Rₙ from the frame dividing unit 262. Further, the sub region feature amount extracting unit 263 performs normalization by dividing the number of pixels Vₙ making up the rectangular region in each sub region Rₙ by the total number of pixels Sₙ included in the sub region Rₙ, and supplies to the connecting unit 264 as the sub region feature amount Fₙ=Vₙ/Sₙ.

In step S237, the connecting unit 264 generates the object feature amount of the frame of interest by connecting the sub region feature amount Fₙ of each of the multiple sub regions Rₙ making up the frame of interest, from the sub region feature amount extracting unit 263, and the processing proceeds to step S238.

In step S238, the frame dividing unit 262 determines whether or not all the frames of the content of interest have been selected as the frame of interest.

In the event that determination is made in step S238 that there is, of the frames of the content of interest, a frame that has not been selected as the frame of interest, the processing returns to step S233, and hereafter, the same processing is repeated.

Also, in the event that determination is made in step S238 that all the frames of the content of interest have been selected as the frame of interest, the processing proceeds to step S239, where the connecting unit 244 supplies and stores (the time sequence of) the object feature amount of each frame of the content of interest obtained regarding the content of interest to the object feature amount storage unit 225.

Subsequently, the processing proceeds from step S239 to step S240, where the frame dividing unit 262 determines whether or not all the contents for learning from the learning contents selecting unit 21 have been selected as the content of interest.

In the event that determination is made in step S240 that there is, of the contents for learning, a content for learning that has not been selected as the content of interest, the processing returns to step S232, and hereafter, the same processing is repeated.

Also, in the event that determination is made in step S240 that all the contents for learning have been selected as the content of interest, the processing proceeds to step S241. In step S241, the learning unit 226 uses the object feature amount of the contents for learning (the time sequence of the object feature amount of each frame) stored in the object feature amount storage unit 225 to perform learning of a contents model.

Specifically, the learning unit 226 performs cluster learning using the object feature amount of the content for learning to obtain cluster information (e.g., code book).

Further, the learning unit 226 subjects the object feature amount of the content for learning to clustering using the cluster information obtained by performing cluster learning using the object feature amount of the content for learning to obtain the code sequence of the object feature amount of the content for learning.

Also, the learning unit 226 uses the code sequence of the object feature amount of the content for learning to perform model learning of the HMM serving as a state transition model, for example.

Subsequently, the learning unit 226 outputs (supplies) a set of the HMM (code model) after model learning using the code sequence of the object feature amount of the content for learning, and the cluster information obtained by cluster learning to the object model storage unit 202c as an object contents model in a manner correlated with the category of the content for learning, and the object contents model learning processing ends.

Note that the object contents model learning processing may be started at an arbitrary timing.

According to the above object contents model learning processing, the structure of a content (e.g., structure created from appearance/disappearance of an object) hidden in a content for learning is obtained in a self-organized manner with the HMM serving as an object contents model.

As a result thereof, each state of the HMM serving as an object contents model obtained in the object contents model learning processing corresponds to an element of the structure of a content obtained by learning, and state transition expresses temporal transition between elements of the structure of the content.

Subsequently, the state of the HMM serving as an object contents model expresses a frame group of having spatially near distance and temporally similar context (i.e., “similar scenes”) in object feature amount space (the space of object feature amount extracted at the object feature amount extracting unit 224 (FIG. 36)) in a collected manner.

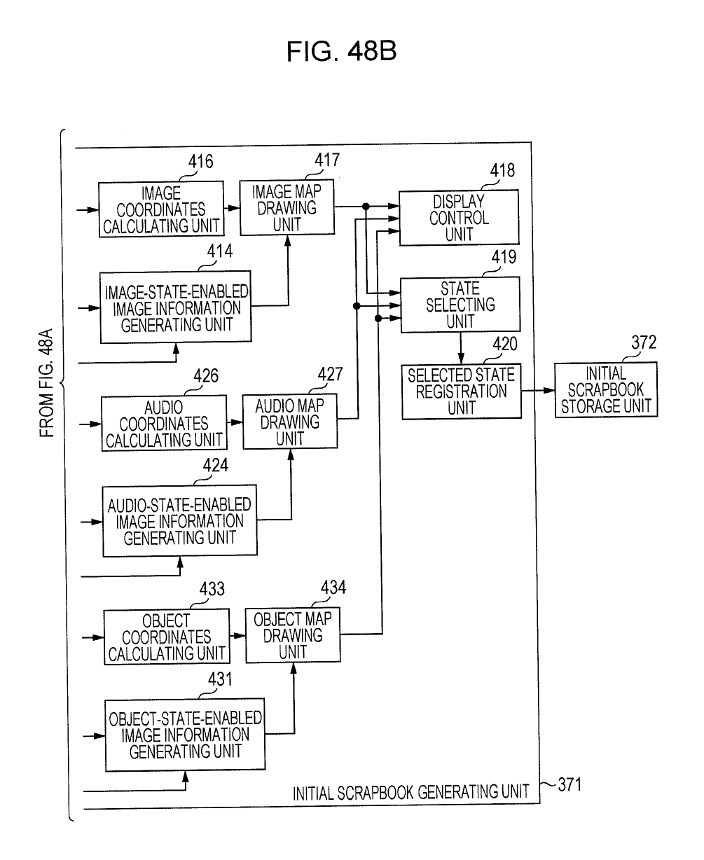

Next, a configuration example of the contents structure presenting unit 203 will be described. A configuration example of the contents structure presenting unit 203 will become, for example, a configuration wherein the state selecting unit 419 and selected state registration unit 420 of a later-described initial scrapbook generating unit 317 (FIG. 48) are eliminated. This is because the contents structure presenting unit 203 is configured wherein a contents structure presenting unit 14 corresponding to each of an image contents model, an audio contents model, and an object contents model is provided.

Also, with the contents structure presentation processing of the contents structure presenting unit 203, the same processing as the above contents structure presentation processing (FIG. 13) of the contents structure presenting unit 14 (FIG. 9) regarding each of the image contents model, audio contents model, and object contents model, is performed, and thus, a model map obtained by using the HMM (code model) of each of the image contents model, audio contents model, and object contents model is displayed individually or on an independent window.

According to the above reasons, with regard to a configuration example of the contents structure presenting unit 203, and the contents structure presentation processing thereof, description thereof will be omitted.

Configuration Example of Digest Generating Unit 204

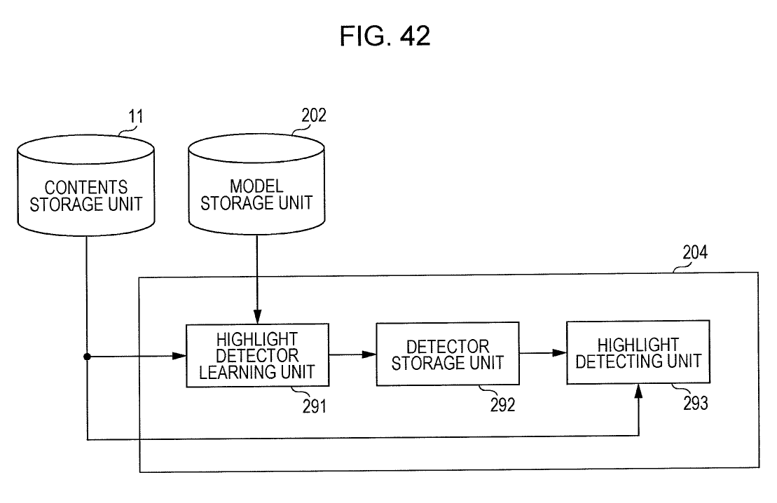

FIG. 42 is a block diagram illustrating a configuration example of the digest generating unit 204 in FIG. 35.

The digest generating unit 204 is configured of a highlight detector learning unit 291, a detector storage unit 292, and a highlight detecting unit 293.

The highlight detector learning unit 291, detector storage unit 292, and highlight detecting unit 293 have basically the same functions as with the highlight detector learning unit 51, detector storage unit 52, and highlight detecting unit 53, but any of these can execute processing for handling an image contents model, audio contents model, and object contents model.

Configuration Example of Highlight Detector Learning Unit 291

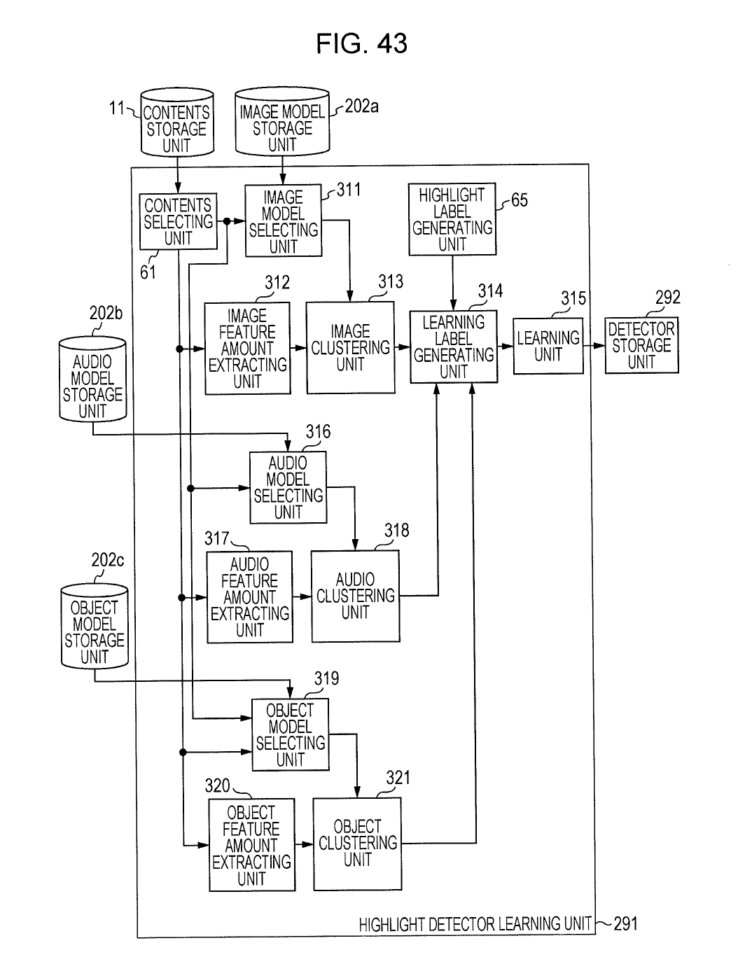

FIG. 43 is a block diagram illustrating a configuration example of the highlight detector learning unit 291 in FIG. 42. Note that, with the configuration of the highlight detector learning unit 291 in FIG. 43, a configuration having the same function as with the configuration of the highlight detector learning unit 51 in FIG. 15 is denoted with the same reference numeral, and description thereof will be omitted as appropriate.

Specifically, the highlight detector learning unit 291 differs from the configuration of the highlight detector learning unit 51 in that a model selecting unit, a feature amount extracting unit, and a clustering unit, which can handle image feature amount, audio feature amount, and object feature amount, are provided. More specifically, the highlight detector learning unit 291 includes an image model selecting unit 311, an image feature amount extracting unit 312, and an image clustering unit 313, which can handle image feature amount. Also, the highlight detector learning unit 291 includes an audio model selecting unit 316, an audio feature amount extracting unit 317, and an audio clustering unit 318, which can handle audio feature amount. Further, the highlight detector learning unit 291 includes an object model selecting unit 319, an object feature amount extracting unit 320, and an object clustering unit 321, which can handle object feature amount.

However, the image model selecting unit 311, image feature amount extracting unit 312, and image clustering unit 313, which take an image contents model as an object, are the same as the model selecting unit 62, feature amount extracting unit 63, and clustering unit 64. Also, the audio model selecting unit 316, audio feature amount extracting unit 317, audio clustering unit 318 have basically the same functions as with the model selecting unit 62, feature amount extracting unit 63, and clustering unit 64 except that feature amount to be handled is audio feature amount. Further, the object model selecting unit 319, object feature amount extracting unit 320, and object clustering unit 321 also have basically the same functions as with the model selecting unit 62, feature amount extracting unit 63, and clustering unit 64 except that feature amount to be handled is object feature amount.

Further, the image model selecting unit 311 selects one of image contents models from the image model storage unit 202a of the model storage unit 202. The audio model selecting unit 316 selects one of audio contents models from the audio model storage unit 202b of the model storage unit 202. The object model selecting unit 319 selects one of object contents models from the object model storage unit 202c of the model storage unit 202.

Also, the highlight detector learning unit 291 in FIG. 43 includes a learning label generating unit 314 instead of the learning label generating unit 66. With the learning label generating unit 314, the basic function is the same as with the learning label generating unit 66.

The learning label generating unit 314 obtains the code sequence of the image feature amount of the content of interest (also referred to as “image code sequence”) obtained by clustering of the image feature amount of the content of interest using the cluster information of the image contents model serving as the model of interest by the image clustering unit 313.

Also, the learning label generating unit 314 obtains the code sequence of the audio feature amount of the content of interest (also referred to as “audio code sequence”) obtained by clustering of the audio feature amount of the content of interest using the cluster information of the audio contents model serving as the model of interest by the audio clustering unit 318.

Further, the learning label generating unit 314 obtains the code sequence of the object feature amount of the content of interest (also referred to as “object code sequence”) obtained by clustering of the object feature amount of the content of interest using the cluster information of the object contents model serving as the model of interest by the object model selecting unit 321.

Also, the learning label generating unit 314 obtains the highlight label sequence from the highlight label generating unit 65.

Subsequently, the learning label generating unit 314 generates a learning label sequence made up of an image code sequence, an audio code sequence, an object code sequence, and a highlight label sequence.

Specifically, the learning label generating unit 314 generates a multi-stream label sequence for learning synthesized from code at each point-in-time t in the image code sequence, audio code sequence, object code sequence, and highlight label sequence, and a highlight label.

Accordingly, the learning label generating unit 314 generates a multi-stream label sequence for learning made up of a component sequence of the number of streams M=4 in the above Expression (2). Subsequently, the learning label generating unit 314 supplies the multi-stream label sequence for learning to the learning unit 315.

The learning unit 315 uses the label sequence for learning from the learning label generating unit 314 to perform, for example, learning of a highlight detector that is an Ergodic type multi-stream HMM in accordance with the Baum-Welch re-estimation method.

Subsequently, the learning unit 315 supplies and stores the highlight detector after learning to the detector storage unit 292 in a manner correlated with the category of the content of interest selected at the content selecting unit 61.

Note that, with the learning of a multi-stream HMM at the learning unit 315, as described above, configuration is made by four types of component sequence of M=4, so with the sequence weight of each component sequence as W₁ through W₄, for example, in the event that all are equally allocated, any of these may be set to ¼ (=0.25). Also, if the number of streams M is generalized, in the event that the sequence weight of each sequence is set to be equal, any sequence weight may be set to 1/M.

Highlight Detector Learning Processing

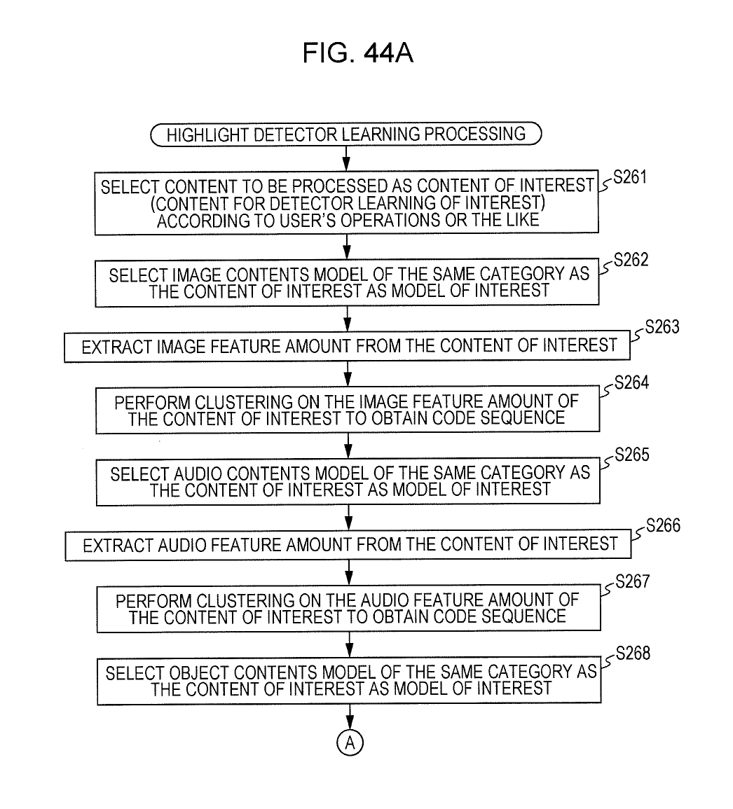

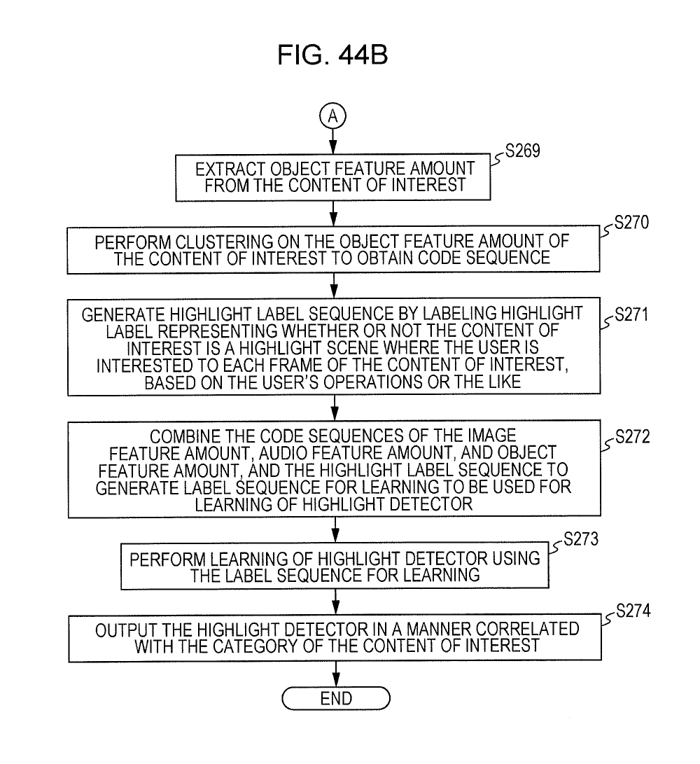

FIG. 44 is a flowchart for describing the processing (highlight detector learning processing) that the highlight detector learning unit 291 in FIG. 43 performs.

In step S261, the contents selecting unit 61 selects a content of which the playback has been specified by the user's operation out of the contents stored in the contents storage unit 11 as the content of interest (content for detector learning of interest).

Subsequently, the contents selecting unit 61 supplies the content of interest to each of the image feature amount extracting unit 312, audio feature amount extracting unit 317, and object feature amount extracting unit 320. Also, the contents selecting unit 61 recognizes the category of the content of interest, and supplies to the image model selecting unit 311, audio model selecting unit 316, and object model selecting unit 319, and the processing proceeds from step S261 to step S262.

In step S262, the image model selecting unit 311 selects an image contents model correlated with the category of the content of interest, from the contents selecting unit 61, out of the image contents models stored in the image model storage unit 202a, as the model of interest.

Subsequently, the image model selecting unit 311 supplies the model of interest to the image clustering unit 313, and the processing proceeds from step S262 to step S263.

In step S263, the image feature amount extracting unit 312 extracts the image feature amount of each frame of the content of interest supplied from the contents selecting unit 61, and supplies (the time sequence of) the image feature amount of each frame of the content of interest to the image clustering unit 313. Subsequently, the processing proceeds to step S264.

In step S264, the image clustering unit 313 uses the cluster information of the image contents model serving as the model of interest from the image model selecting unit 311 to subject (the time sequence of) the image feature amount of the content of interest from the image feature amount extracting unit 312 to clustering, supplies the image code sequence obtained as a result thereof to the learning label generating unit 314, and the processing proceeds from step S264 to step S265.

In step S265, the audio model selecting unit 316 selects an audio contents model correlated with the category of the content of interest, from the contents selecting unit 61, out of the audio contents models stored in the audio model storage unit 202b, as the model of interest.

Subsequently, the audio model selecting unit 316 supplies the model of interest to the audio clustering unit 318, and the processing proceeds from step S265 to step S266.

In step S266, the audio feature amount extracting unit 317 extracts the audio feature amount of each frame of the content of interest supplied from the contents selecting unit 61, and supplies (the time sequence of) the audio feature amount of each frame of the content of interest to the audio clustering unit 318. Subsequently, the processing proceeds to step S267.

In step S267, the audio clustering unit 318 uses the cluster information of the audio contents model serving as the model of interest from the audio model selecting unit 316 to subject (the time sequence of) the audio feature amount of the content of interest from the audio feature amount extracting unit 317 to clustering, supplies the audio code sequence obtained as a result thereof to the learning label generating unit 314, and the processing proceeds from step S267 to step S268.

In step S268, the object model selecting unit 319 selects an object contents model correlated with the category of the content of interest, from the contents selecting unit 61, out of the object contents models stored in the object model storage unit 202c, as the model of interest.

Subsequently, the object model selecting unit 319 supplies the model of interest to the object clustering unit 321, and the processing proceeds from step S268 to step S269.

In step S269, the object feature amount extracting unit 320 extracts the object feature amount of each frame of the content of interest supplied from the contents selecting unit 61, and supplies (the time sequence of) the object feature amount of each frame of the content of interest to the object clustering unit 321. Subsequently, the processing proceeds to step S270.

In step S270, the object clustering unit 321 uses the cluster information of the object contents model serving as the model of interest from the object model selecting unit 319 to subject (the time sequence of) the object feature amount of the content of interest from the object feature amount extracting unit 320 to clustering, supplies the object code sequence obtained as a result thereof to the learning label generating unit 314, and the processing proceeds from step S270 to step S271.

In step S271, the highlight label generating unit 65 labels a highlight label to each frame of the content of interest selected at the contents selecting unit 61 in accordance with the user's operations, thereby generating a highlight label sequence regarding the content of interest.

Subsequently, the highlight label generating unit 65 supplies the highlight label sequence generated regarding the content of interest to the learning label generating unit 314, and the processing proceeds to step S272.

In step S272, the learning label generating unit 314 obtains the image code sequence from the image clustering unit 313, the audio code sequence from the audio clustering unit 318, and the object code sequence from the object clustering unit 321. Further, the learning label generating unit 314 obtains the highlight label sequence from the highlight label generating unit 65.

Subsequently, the learning label generating unit 314 generates a label sequence for learning by combining four sequences of the image code sequence, audio code sequence, object code sequence, and highlight label sequence.

Subsequently, the learning label generating unit 314 supplies the label sequence for learning to the learning unit 315, and the processing proceeds from step S272 to step S273.

In step S273, the learning unit 315 uses the label sequence for learning from the learning label generating unit 314 to perform learning of a highlight detector that is a multi-stream HMM, and the processing proceeds to step S274.

In step S274, the learning unit 315 supplies and stores the highlight detector after learning to the detector storage unit 292 in a manner correlated with the category of the content of interest selected at the content selecting unit 61.

As described above, the highlight detector is obtained by learning of a multi-stream HMM using the four label sequences for learning of the image code sequence, audio code sequence, object code sequence, and highlight label sequence obtained by subjecting the content of interest to clustering using the cluster information of the model of interest.

Accordingly, by the observation probability of the highlight sequence, of each state of the highlight detector that is a multi-stream HMM, being referenced, determination may be made whether or not a frame of which the feature amount is subjected to clustering to obtain a cluster that the code (with a high possibility of being) observed in that state represents is a scene with the user's interest (highlight scene).

Configuration Example of Highlight Detecting Unit 293

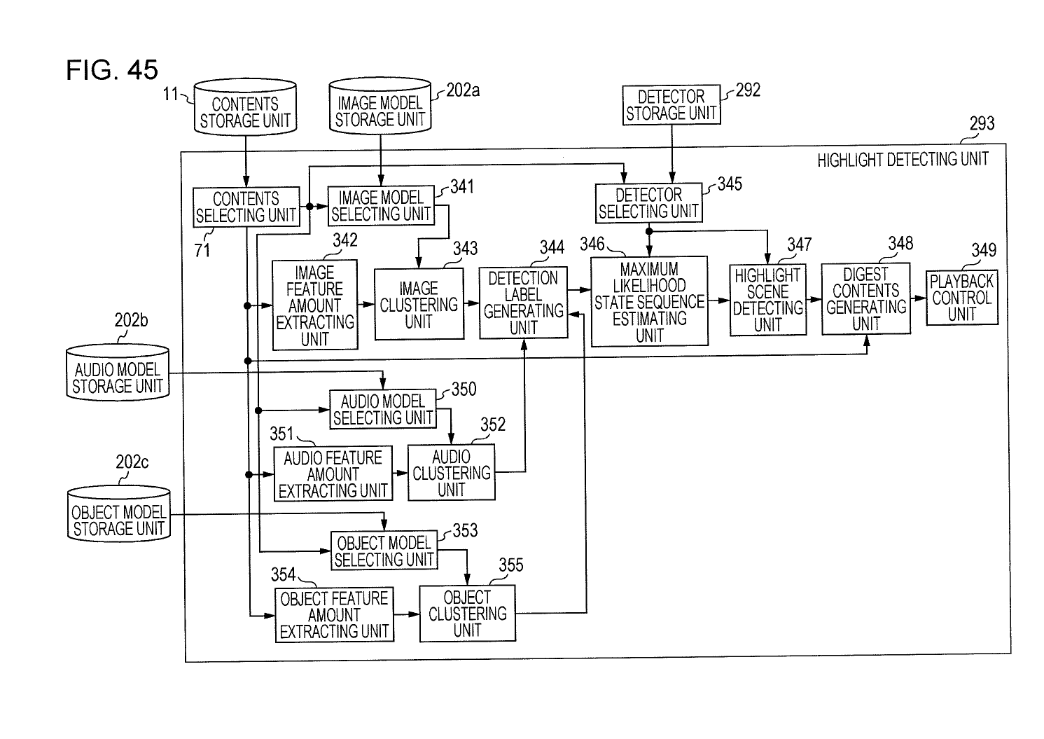

FIG. 45 is a block diagram illustrating a configuration example of the highlight detecting unit 293 in FIG. 42. Note that, with the highlight detecting unit 293 in FIG. 45, a configuration including the same function as the configuration in the highlight detecting unit 53 in FIG. 18 is denoted with the same reference numeral, and description thereof will be omitted.

The highlight detecting unit 293 in FIG. 45 has basically the same function as with the highlight detecting unit 53 in FIG. 18, but differs in that a detection label is generated in response to each of image feature amount, audio feature amount, and object feature amount.

Specifically, the image model selecting unit 341, image feature amount extracting unit 342, and image clustering unit 343 are the same as the image model selecting unit 311, image feature amount extracting unit 312, and image clustering unit 313 of the highlight detector learning unit 291 in FIG. 43. Also, the audio model selecting unit 350, audio feature amount extracting unit 351, and audio clustering unit 352 are the same as the audio model selecting unit 316, audio feature amount extracting unit 317, and audio clustering unit 318 of the highlight detector learning unit 291 in FIG. 43. Further, the object model selecting unit 353, object feature amount extracting unit 354, and object clustering unit 355 are the same as the object model selecting unit 319, object feature amount extracting unit 320, and object clustering unit 321 of the highlight detector learning unit 291 in FIG. 43.

Due to such a configuration, the detection label generating unit 344 is supplied with image code sequence, audio code sequence, and object code sequence, obtained by clustering the image feature amount, audio feature amount, and object feature amount of the content of interest, using cluster information of an image content model, audio content model, and object content model, respectively, as model of interest.

The detection label generating unit 344 generates a label sequence for detection made up of the image code sequence, audio code sequence, object code sequence, and highlight label sequence.

Specifically, the detection label generating unit 344 generates a highlight label sequence made up of highlight labels alone representing other than a highlight scene, and having the same length (sequence length) as the image code sequence, audio code sequence, and object code sequence, as a dummy sequence, as if it were, to be given to a highlight detector.

Further, the detection label generating unit 344 generates a multi-stream label sequence for detection by code at each point-in-time t in the image code sequence, audio code sequence, object code sequence, and highlight label sequence serving as a dummy sequence, and a highlight label being combined.

Subsequently, the learning label generating unit 344 supplies the label sequence for detection to the maximum likelihood state sequence estimating unit 346.

Note that the multi-stream label for detection that the detector selecting unit 345, maximum likelihood state sequence estimating unit 346, highlight scene detecting unit 347, digest contents generating unit 348, and playback control unit 349 handle becomes a label sequence for detection made up of four streams. With regard to points other than this, these have basically the same function as with the detector selecting unit 76, maximum likelihood state sequence estimating unit 77, highlight scene stream detecting unit 78, digest contents generating unit 79, and playback control unit 80 in FIG. 18, so description thereof will be omitted.

Here, with the maximum likelihood state sequence estimating unit 346, the maximum likelihood state sequence (highlight relation state sequence) where a label sequence for detection will be observed is estimated at the HMM serving as a highlight detector, but with estimation thereof, at the time of obtaining the observation probability of the label sequence for detection, as for sequence weight W₁ through W₄ of each sequence of the image code sequence, audio code sequence, object code sequence, and highlight label sequence serving as a dummy sequence, (W₁:W₂:W₃:W₄)=(⅓:⅓:⅓:0) is employed.

Thus, with the maximum likelihood state sequence estimating unit 346, estimation of a highlight relation state sequence is performed while taking only the image code sequence, audio code sequence, and object code sequence of the content of interest into consideration without taking the highlight label sequence input as a dummy sequence into consideration. Note that if the weight in the case of the number of streams M is generalized, in the event that the weight of the highlight sequence is set to 0, and the sequence weight other than the highlight sequence is set to be equal, any sequence weight may be set to 1/(M−1).

Highlight Detection Processing

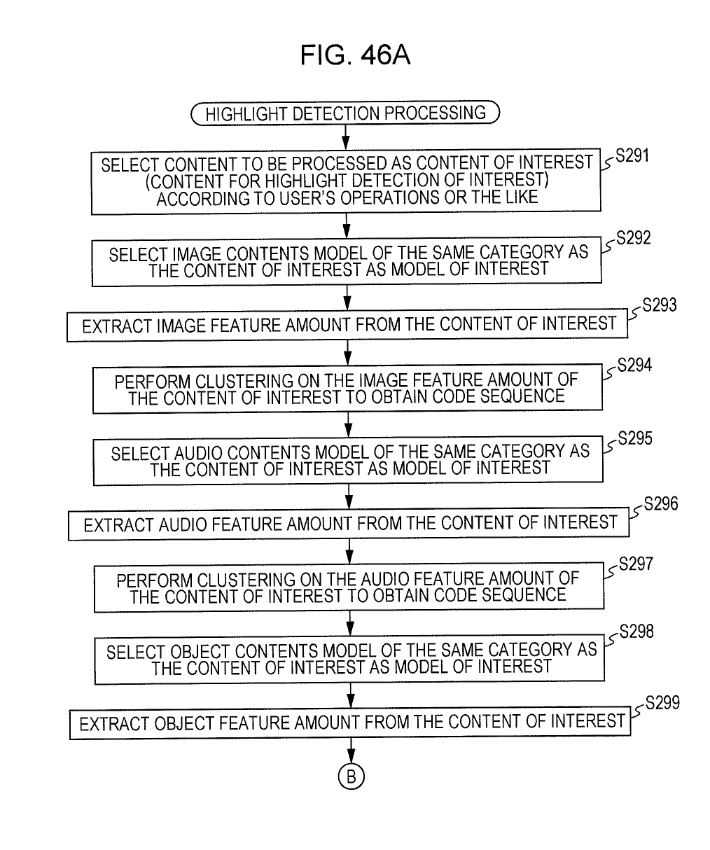

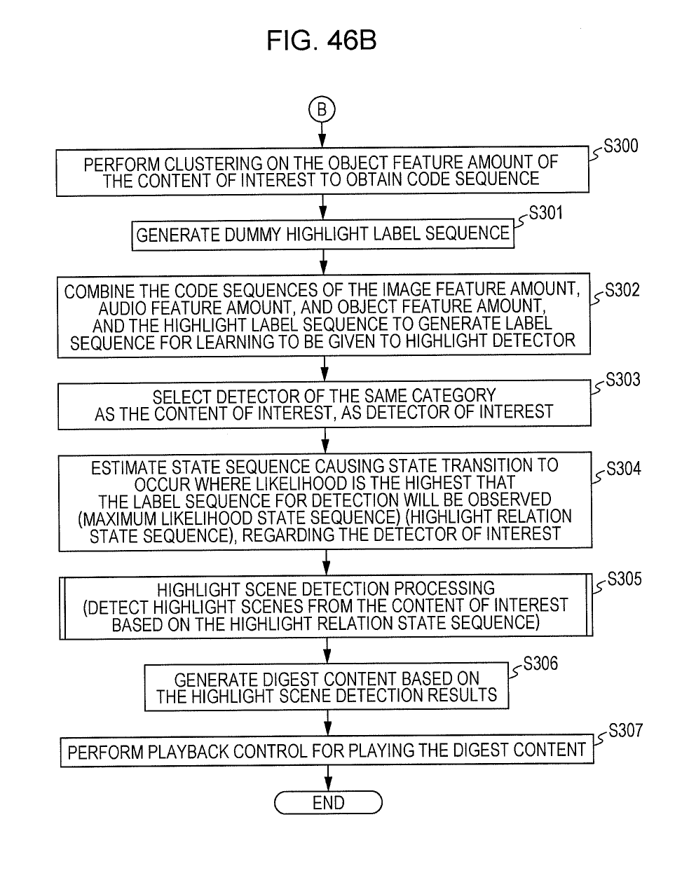

FIG. 46 is a flowchart for describing the processing (highlight detection processing) of the highlight detecting unit 293 in FIG. 45.

In step S291, the contents selecting unit 71 selects the content of interest that is a content from which a highlight scene is to be detected (content for highlight detection of interest) out of the contents stored in the contents storage unit 11.

Subsequently, the contents selecting unit 71 supplies the content of interest to the image feature amount extracting unit 342, audio feature amount extracting unit 351, and object feature amount extracting unit 354. Further, the contents selecting unit 71 recognizes the category of the content of interest, supplies to the image model selecting unit 341, audio model selecting unit 350, object model selecting unit 353, and detector selecting unit 345, and the processing proceeds from step S291 to step S292.

In step S292, the image model selecting unit 341 selects an image contents model correlated with the category of the content of interest, from the contents selecting unit 71, out of the image contents models stored in the image model storage unit 202a, as the model of interest.

Subsequently, the image model selecting unit 341 supplies the model of interest to the image clustering unit 343, and the processing proceeds from step S292 to step S293.

In step S293, the image feature amount extracting unit 342 extracts the image feature amount of each frame of the content of interest supplied from the contents selecting unit 71, supplies to the image clustering unit 343, and the processing proceeds to step S294.

In step S294, the image clustering unit 343 uses the cluster information of the image contents model that is the model of interest from the image model selecting unit 341 to subject (the time sequence of) the image feature amount of the content of interest from the image feature amount extracting unit 342 to clustering, supplies the image code sequence obtained as a result thereof to the detection label generating unit 344, and the processing proceeds from step S294 to step S295.

In step S295, the audio model selecting unit 350 selects an audio contents model correlated with the category of the content of interest, from the contents selecting unit 71, out of the audio contents models stored in the audio model storage unit 202b, as the model of interest.

Subsequently, the audio model selecting unit 350 supplies the model of interest to the audio clustering unit 352, and the processing proceeds from step S295 to step S296.

In step S296, the audio feature amount extracting unit 351 extracts the audio feature amount of each frame of the content of interest supplied from the contents selecting unit 71, supplies to the audio clustering unit 352, and the processing proceeds to step S297.

In step S297, the audio clustering unit 352 uses the cluster information of the audio contents model that is the model of interest from the audio model selecting unit 350 to subject (the time sequence of) the audio feature amount of the content of interest from the audio feature amount extracting unit 351 to clustering, supplies the audio code sequence obtained as a result thereof to the detection label generating unit 344, and the processing proceeds from step S297 to step S298.

In step S298, the object model selecting unit 353 selects an object contents model correlated with the category of the content of interest, from the contents selecting unit 71, out of the object contents models stored in the object model storage unit 202c, as the model of interest.

Subsequently, the object model selecting unit 353 supplies the model of interest to the object clustering unit 355, and the processing proceeds from step S298 to step S299.

In step S299, the object feature amount extracting unit 354 extracts the object feature amount of each frame of the content of interest supplied from the contents selecting unit 71, supplies to the object clustering unit 355, and the processing proceeds to step S300.

In step S300, the object clustering unit 355 uses the cluster information of the object contents model that is the model of interest from the object model selecting unit 353 to subject (the time sequence of) the object feature amount of the content of interest from the object feature amount extracting unit 354 to clustering, supplies the object code sequence obtained as a result thereof to the detection label generating unit 344, and the processing proceeds from step S300 to step S301.

In step S301, the detection label generating unit 344 generates, for example, a highlight label sequence made up of highlight labels (highlight labels of which the values are “0”) alone representing being other than a highlight scene, as a dummy highlight label sequence, and the processing proceeds to step S302.

In step S302, the detection label generating unit 344 generates four sequences of label sequences for detection of the image code sequence, audio code sequence, and object code sequence, and a dummy highlight sequence.

Subsequently, the detection label generating unit 344 supplies the label sequences for detection to the maximum likelihood state sequence estimating unit 346, and the processing proceeds from step S302 to step S303.

In step S303, the detector selecting unit 345 selects a highlight detector correlated with the category of the content of interest, from the contents selecting unit 71, out of the highlight detectors stored in the detector storage unit 292, as the detector of interest. Subsequently, the detector selecting unit 345 obtains the detector of interest out of the highlight detectors stored in the detector storage unit 292, supplies to the maximum likelihood state sequence estimating unit 346 and highlight detecting unit 347, and the processing proceeds from step S303 to step S304.

In step S304, the maximum likelihood state sequence estimating unit 346 estimates the maximum likelihood state sequence (highlight relation state sequence) causing state transition where likelihood is the highest that the label sequence for detection from the detection label generating unit 344 will be observed in the detector of interest from the detector selecting unit 345.

Subsequently, the maximum likelihood state sequence estimating unit 346 supplies the highlight relation state sequence to the highlight detecting unit 347, and the processing proceeds from step S304 to step S305.

In step S305, the highlight scene detecting unit 347 performs highlight scene detection processing for recognizing the highlight label observation probability of each state of the highlight relation state sequence from the maximum likelihood state sequence estimating unit 346 from the HMM serving as the detector of interest from the detector selecting unit 345, and based on the observation probability thereof, detecting a highlight scene from the content of interest to output a highlight flag.

Subsequently, after completion of the highlight detection processing, the processing proceeds from step S305 to step S306, where the digest contents generating unit 348 extracts the frame of a highlight scene determined by the highlight flag that the highlight scene detecting unit 347 outputs, from the frames of the content of interest from the contents selecting unit 71.

Further, the digest contents generating unit 348 uses the highlight scene frame extracted from the frames of the content of interest to generate a digest content of the content of interest, supplies to the playback control unit 349, and the processing proceeds from step S306 to step S307.

In step S307, the playback control unit 49 performs playback control for playing the digest content from the digest contents generating unit 348.

Note that the highlight scene detection processing in step S305 is the same as the processing in step S89 in FIG. 20, i.e., the processing described with reference to the flowchart in FIG. 21, so description thereof will be omitted.

As described above, the highlight detecting unit 293 estimates in the highlight detector the highlight relation state sequence that is the maximum likelihood state sequence where a label sequence for detection made up of the image code sequence, audio code sequence, object code sequence, and dummy highlight label sequence obtained by subjecting the feature amount of each of the image, audio, and object to clustering will be observed. Subsequently, the highlight detecting unit 293 detects a highlight scene frame from the content of interest based on the highlight label observation probability of each state of the highlight relation state sequence thereof, and generates a digest content using the highlight scene thereof.

Also, the highlight detector is obtained by performing learning of an HMM serving as a highlight detector using a label sequence for learning made up of four sequences of combination of the image code sequence, audio code sequence, object code sequence of the content, and a highlight label sequence generated according to the user's operations.

Accordingly, even in the event that the content of interest for generating a digest content is not used for learning of a contents model or highlight detector, if learning of a contents model or highlight detector is performed using a content having the same category as the content of interest, a digest (digest content) generated by collecting a scene in which the user is interested as a highlight scene can readily be obtained using the contents model and highlight detector thereof.

Configuration Example of Scrapbook Generating Unit 205

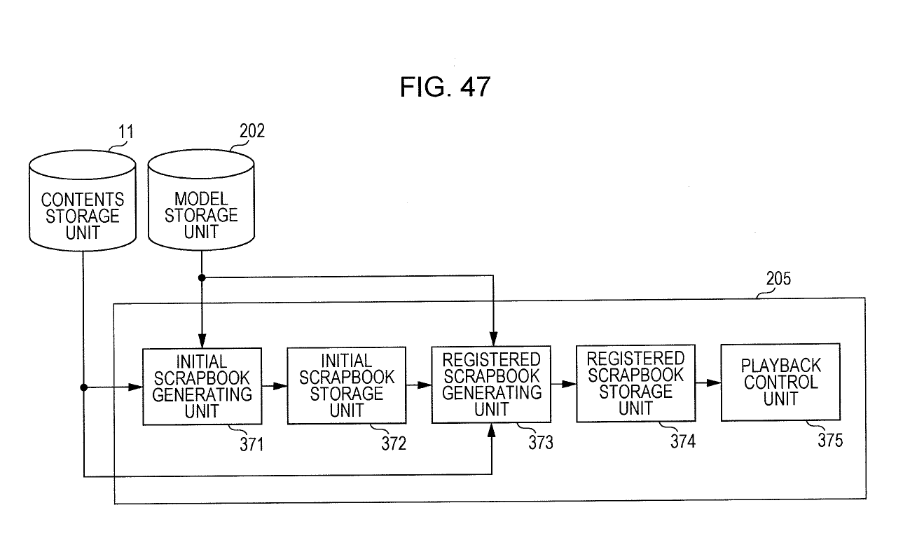

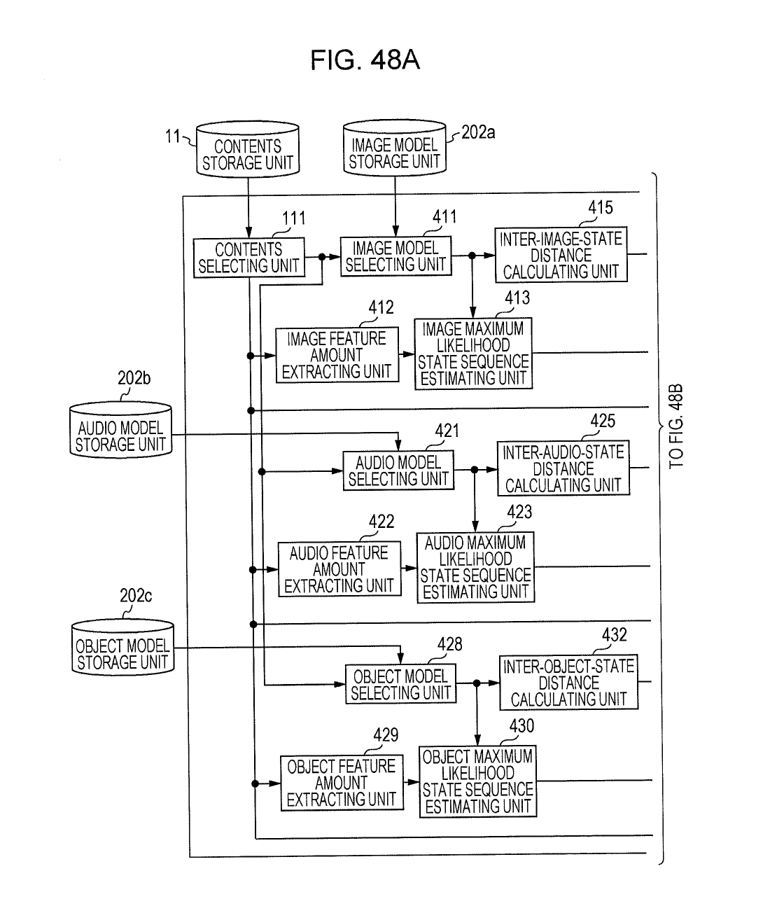

FIG. 47 is a block diagram illustrating a configuration example of the scrapbook generating unit 205 in FIG. 35.

The scrapbook generating unit 205 is configured of an initial scrapbook generating unit 371, an initial scrapbook storage unit 372, a registered scrapbook generating unit 373, a registered scrapbook storage unit 374, and a playback control unit 375.

The initial scrapbook generating unit 371, initial scrapbook storage unit 372, registered scrapbook generating unit 373, registered scrapbook storage unit 374, and playback control unit 375 are basically the same as the initial scrapbook generating unit 101 through the playback control unit 105. However, any of these executes processing corresponding to not only an image contents model based on image feature amount but also an audio contents model based on audio feature amount, and an object contents model based on object feature amount.

Configuration Example of Initial Scrapbook Generating Unit 371

FIG. 48 is a block diagram illustrating a configuration example of the initial scrapbook generating unit 371 in FIG. 47. Note that, with the configuration of the initial scrapbook generating unit 371 in FIG. 48, a configuration having the same function as with the initial scrapbook generating unit 101 in FIG. 23 is denoted with the same reference numeral, and description thereof will be omitted as appropriate.

Also, in FIG. 48, of the initial scrapbook generating unit 371, an image model selecting unit 411, an image feature amount extracting unit 412, an image maximum likelihood state sequence estimating unit 413, an image-state-enabled image information generating unit 414, an inter-image-state calculating unit 415, an image coordinates calculating unit 416, and an image map drawing unit 417 are the same as the model selecting unit 112, feature amount extracting unit 113, maximum likelihood state sequence estimating unit 114, state-enabled image information generating unit 115, inter-state distance calculating unit 116, coordinates calculating unit 117, and map drawing unit 118 respectively, so description thereof will be omitted.

Specifically, the image model selecting unit 411 through the image map drawing unit 417 are configured in the same way as the model selecting unit 32 through the map drawing unit 38 of the contents structure presenting unit 14 (FIG. 9), and perform contents structure presentation processing based on the image feature amount described in FIG. 13.

Also, an audio model selecting unit 421, an audio feature amount extracting unit 422, an audio maximum likelihood state sequence estimating unit 423, an audio-state-enabled image information generating unit 424, an inter-audio-state calculating unit 425, an audio coordinates calculating unit 426, and an audio map drawing unit 427 perform the same processing as the image model selecting unit 411, image feature amount extracting unit 412 through image map drawing unit 417 except that an object to be handled is audio feature amount.

Further, an object model selecting unit 428, an object feature amount extracting unit 429, an object maximum likelihood state sequence estimating unit 430, an object-state-enabled image information generating unit 431, an inter-object-state calculating unit 432, an object coordinates calculating unit 433, and an object map drawing unit 434 perform the same processing as the image model selecting unit 411 through the image map drawing unit 417 except that an object to be handled is object feature amount.

Also, a display control unit 418, a state selecting unit 419, and a selected state registration unit 420 perform the same processing as the display control unit 119, state selecting unit 121, and selected state registration unit 122, respectively.

Accordingly, with the initial scrapbook generating unit 371, the model map (FIG. 11, FIG. 12) is displayed on the unshown display based on each of the image feature amount, audio feature amount, and object feature amount by the contents structure presentation processing being performed. Subsequently, in the event that a state on the model map based on each of the image feature amount, audio feature amount, and object feature amount has been specified by the user's operation, the state ID of the specified state (selected state) is registered in the (empty) scrapbook.

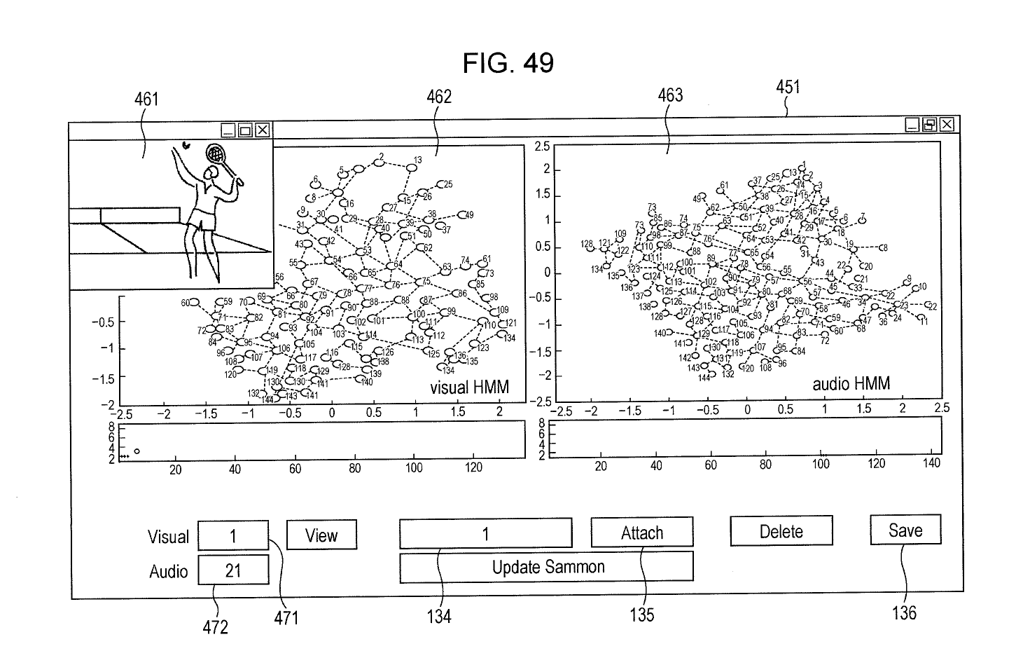

FIG. 49 is a diagram illustrating a user interface example to be displayed by the display control unit 418 performing display control for the user specifying a state on the model map. Note that display having the same function as with the display in the window 131 in FIG. 24 is denoted with the same reference numeral, and description thereof will be omitted as appropriate.

In FIG. 49, a model map 462 based on the image feature amount generated at the image map drawing unit 417, and a model map 463 based on the audio feature amount generated at the audio map drawing unit 427 are displayed on a window 451. Note that, with the example in FIG. 49, though not illustrated, it goes without saying that a model map based on the object feature amount generated at the object map drawing unit 434 may be displayed together. Also, in the event that another feature amount other than the image feature amount, audio feature amount, and object feature amount is handled, a model map based on the other feature amount may further be drawn and displayed. Further, each of the model maps may also be displayed on a different window.

The states on the model maps 462 and 463 within the window 451 can be focused by the user's specification. Specification of a state by the user may be performed by clicking using a pointing device such as a mouse or the like, or by moving a cursor which moves according to the operation of a pointing device to the position of a state to be focused on, or the like.

Also, of the states on the model maps 462 and 463, a state that has already been in a selected state, and a state that has not been in a selected state may be displayed in a different display format such as a different color or the like.

With the display in the lower portion of the window 451, a point different from the window 131 in FIG. 24 is in that an image state ID input field 471 and an audio state ID input field 472 are provided instead of the state ID input field 133.

Of the states on the model map 462 based on the image feature amount, the state ID of a focused state is displayed on the image state ID input filed 471.

Of the states on the model map 463 based on the audio feature amount, the state ID of a focused state is displayed on the audio state ID input filed 472.

Note that the user may also directly input a state ID on the image state ID input field 471 and the audio state ID input field 472. Also, in the event that a model map based on the object feature amount is displayed, an object state ID input filed is also displayed together.

The window 461 is opened in the event that, of the states on the model maps 462 and 463, a focused state is linked to the state-enabled image information generated at the contents structure presentation processing. Subsequently, the state-enabled image information linked to the focused state is displayed.

Note that state-enabled image information linked to each of a focused state and a state positioned in the vicinity of the focused state on the model maps 462 and 463 may be displayed on the window 461. Also, state-enabled image information linked to each of all the states on the model maps 462 and 463 may be displayed on the window 461 temporally serially, or spatially in parallel.

The user may specify an arbitrary state on the model maps 462 and 463 displayed on the window 451 by clicking the state, or the like.

Upon a state being specified by the user, the display control unit 418 (FIG. 48) displays the state-enabled image information linked to the state specified by the user on the window 461.

Thus, the user can confirm the image of a frame corresponding to a state on the model maps 462 and 463.

With the initial scrapbook generating unit 371 in FIG. 48, the state ID of a selected state of the image model map, audio model map, and object model map is registered in the initial scrapbook by the selected state registration unit 420.

Specifically, the initial scrapbook generation processing by the initial scrapbook generating unit 371 in FIG. 48 is the same as the processing described with reference to FIG. 25 regarding each of the image model map (model map based on the image feature amount) (model map to be generated using the code model (HMM) of the image contents model obtained by the contents model learning processing using the image feature amount), audio model map (model map based on the audio feature amount), and object model map (model map based on the object feature amount), so description thereof will be omitted.

However, with the initial scrapbook generating unit 371 in FIG. 48, in the event that, of the image model map, audio model map, and object model map, a selected state selected (specified) from a certain model map, and a selected state selected form another model map correspond to the same frame, (the state IDs of) these selected states are registered in the initial scrapbook in a correlated manner.

Specifically, for example, now, let us pay attention on the image model map and the audio model map.

Each frame of the content of interest corresponds to one state on the image model map, and also corresponds to one state on the audio model map.

Accordingly, there may be a case where the same frame of the content of interest corresponds to a selected state selected from the image model map, and a selected state selected from the audio model map.

In this case, the selected state selected from the image model map, and the selected state selected from the audio model map, which correspond to the same frame, are registered in the initial scrapbook in a correlated manner.

In addition to a case where of the image model map, audio model map, and object model map, the same frame corresponds to two selected states selected from each of arbitrary two model maps, in the event that the same frame corresponds to three selected states selected from each of three model maps of the image model map, audio model map, and object model map as well, the three selected states thereof are registered in the initial scrapbook in a correlated manner.

Now, of the state IDs (registered state IDs) of the selected states registered in the initial scrapbook, the state ID of a selected state selected from the image model map (state of the code model of an image contents model) will also be referred to as “image registered state ID”, hereafter, as appropriate.

Similarly, of the registered state IDs registered in the initial scrapbook, the state ID of a selected state selected from the audio model map (state of the code model of an audio contents model) will also be referred to as “audio registered state ID”, hereafter, as appropriate, and the state ID of a selected state selected from the object model map (state of the code model of an object contents model) will also be referred to as “object registered state ID”, hereafter, as appropriate.

Configuration Example of Registered Scrapbook Generating Unit 373

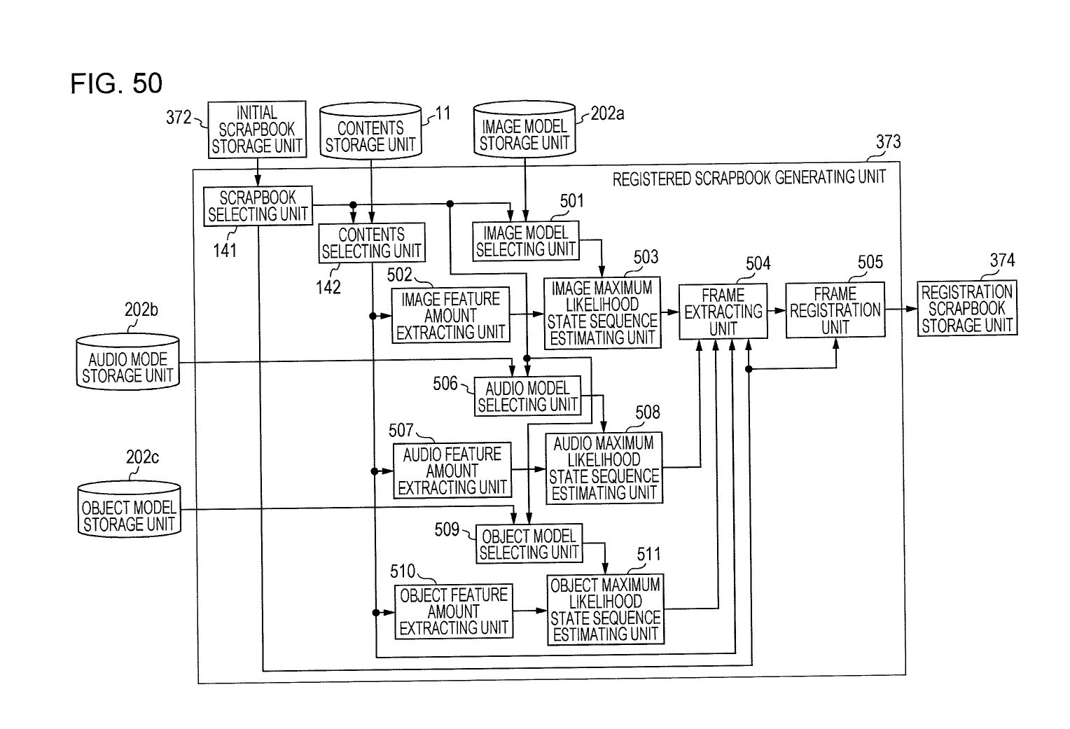

FIG. 50 is a block diagram illustrating a configuration example of the registered scrapbook generating unit 373 in FIG. 47. Note that, with registered scrapbook generating unit 373 in FIG. 50, a configuration having the same function as with the configuration in the registered scrapbook generating unit 103 in FIG. 26 is denoted with the same reference numeral, and description thereof will be omitted as appropriate.

In FIG. 50, an image model selecting unit 501, an image feature amount extracting unit 502, an image maximum likelihood state sequence estimating unit 503, and a frame registration unit 505 are the same as the model selecting unit 143 through the maximum likelihood state sequence estimating unit 145, and frame registration unit 147 in FIG. 26, so description thereof will be omitted.

Also, an audio model selecting unit 506, an audio feature amount extracting unit 507, an audio maximum likelihood state sequence estimating unit 508 are the same as the image model selecting unit 501 through the image maximum likelihood state sequence estimating unit 503 except that an object to be handled is audio feature amount, so description thereof will be omitted.

Further, an object model selecting unit 509, an object feature amount extracting unit 510, an object maximum likelihood state sequence estimating unit 511 are the same as the image model selecting unit 501 through the image maximum likelihood state sequence estimating unit 503 except that an object to be handled is object feature amount, so description thereof will be omitted.

A frame extracting unit 504 has basically the same function as with the frame extracting unit 146 in FIG. 26, but differs in a state sequence to be handled. Specifically, the frame extracting unit 504 determines whether or not each state ID of the image maximum likelihood state sequence (maximum likelihood state sequence where the image code sequence of the image feature amount is observed), audio maximum likelihood state sequence (maximum likelihood state sequence where the audio code sequence of the audio feature amount is observed), and object maximum likelihood state sequence (maximum likelihood state sequence where the object code sequence of the object feature amount is observed) matches a registered state ID registered in the scrapbook of interest from the scrapbook selecting unit 141.

Further, the frame extracting unit 504 extracts, from the content of interest, a frame corresponding to a state of which the state ID matches a registered state ID registered in the scrapbook of interest from the scrapbook selecting unit 141, and supplies to the frame registration unit 505.

Registered Scrapbook Generation Processing by Registered Scrapbook Generating Unit 373

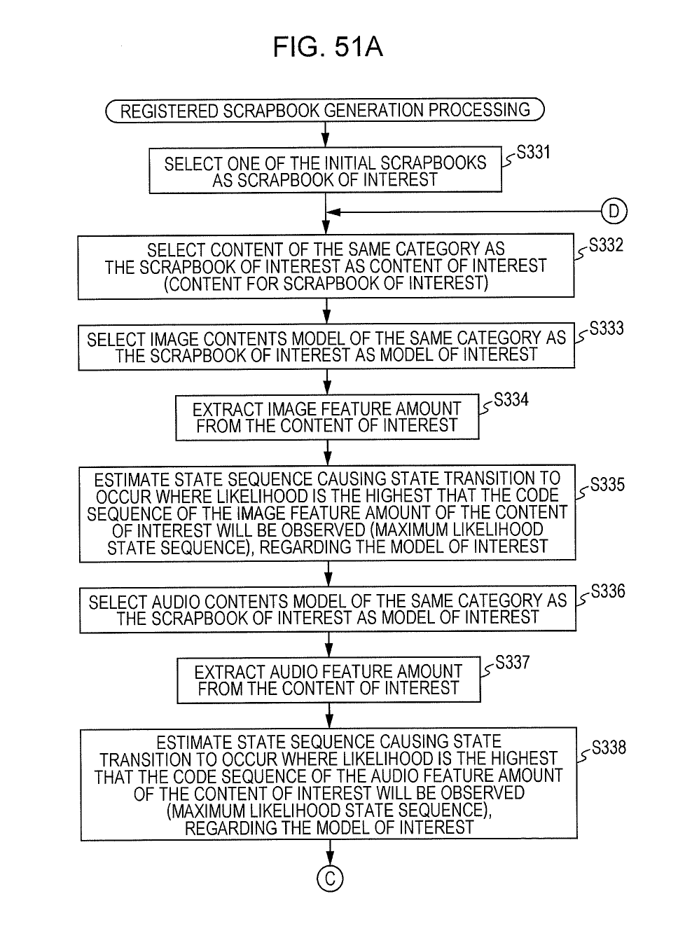

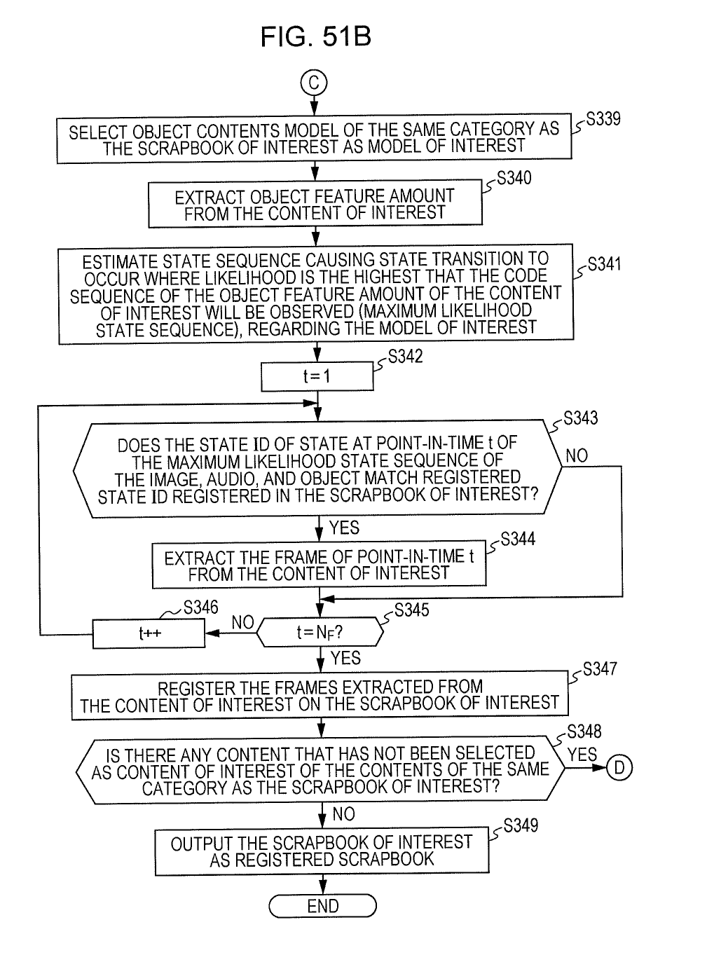

FIG. 51 is a flowchart for describing the registered scrapbook generation processing that the registered scrapbook generating unit 373 in FIG. 50 performs.

In step S331, the scrapbook selecting unit 141 selects, of the initial scrapbooks stored in the initial scrapbook storage unit 372, one of the initial scrapbooks that have not been selected yet as the scrapbook of interest, as the scrapbook of interest.

Subsequently, the scrapbook selecting unit 141 supplies the scrapbook of interest to the frame extracting unit 504 and frame registration unit 505. Further, the scrapbook selecting unit 141 supplies the category correlated with the scrapbook of interest to the contents selecting unit 142, image model selecting unit 501, audio model selecting unit 506, and object model selecting unit 509. Subsequently, the processing proceeds from step S331 to step S332.

In step S332, the contents selecting unit 142 selects, one of contents that have not been selected yet as the content of interest, out of the contents belonging to the category from the scrapbook selecting unit 141 of the contents stored in the contents storage unit 11, as the content of interest.

Subsequently, the contents selecting unit 142 supplies the content of interest to the image feature amount extracting unit 502, audio feature amount extracting unit 507, object feature amount extracting unit 510, and frame extracting unit 504, and the processing proceeds from step S332 to step S333.

In step S333, the image model selecting unit 501 selects an image contents model correlated with the category from the scrapbook selecting unit 141 out of the image contents models stored in the image model storage unit 202a, as the model of interest.

Subsequently, the image model selecting unit 501 supplies the model of interest to the image maximum likelihood state sequence estimating unit 503, and the processing proceeds from step S333 to step S334.

In step S334, the image feature amount extracting unit 502 extracts the image feature amount of each frame of the content of interest supplied from the contents selecting unit 142, and supplies (the time sequence of) the image feature amount of each frame of the content of interest to the image maximum likelihood state sequence estimating unit 503.

Subsequently, the processing proceeds from step S334 to step S335. In step S335, the image maximum likelihood state sequence estimating unit 503 subjects (the time sequence of) the image feature amount of the content of interest from the image feature amount extracting unit 502 to clustering using the cluster information of the image contents model that is the model of interest from the image model selecting unit 501 to obtain the image code sequence of the image feature amount of the content of interest.

Further, the image maximum likelihood state sequence estimating unit 503 estimates the maximum likelihood state sequence causing state transition where likelihood is the highest that the image code sequence of the image feature amount of the content of interest (hereafter, also referred to as the image maximum likelihood state sequence of the code model of interest as to the content of interest) will be observed in the HMM (code model of interest) of the image contents model that is the model of interest, for example, in accordance with the Viterbi algorithm.

Subsequently, the image maximum likelihood state sequence estimating unit 503 supplies the image maximum likelihood state sequence of the code model of interest as to the content of interest to the frame extracting unit 504, and the processing proceeds from step S335 to step S336.

In step S336, the audio model selecting unit 506 selects an audio contents model correlated with the category from the scrapbook selecting unit 141 out of the audio contents models stored in the audio model storage unit 202b, as the model of interest.

Subsequently, the audio model selecting unit 506 supplies the model of interest to the audio maximum likelihood state sequence estimating unit 508, and the processing proceeds from step S336 to step S337.

In step S337, the audio feature amount extracting unit 507 extracts the audio feature amount of each frame of the content of interest supplied from the contents selecting unit 142, and supplies (the time sequence of) the audio feature amount of each frame of the content of interest to the audio maximum likelihood state sequence estimating unit 508.

Subsequently, the processing proceeds from step S337 to step S338. In step S338, the audio maximum likelihood state sequence estimating unit 508 subjects (the time sequence of) the audio feature amount of the content of interest from the audio feature amount extracting unit 507 to clustering using the cluster information of the audio contents model that is the model of interest from the audio model selecting unit 506 to obtain the audio code sequence of the audio feature amount of the content of interest.

Further, the audio maximum likelihood state sequence estimating unit 508 estimates the maximum likelihood state sequence causing state transition where likelihood is the highest that the audio code sequence of the audio feature amount of the content of interest (hereafter, also referred to as the audio maximum likelihood state sequence of the code model of interest as to the content of interest) will be observed in the HMM of the audio contents model that is the model of interest from the audio model selecting unit 506, for example, in accordance with the Viterbi algorithm.

Subsequently, the audio maximum likelihood state sequence estimating unit 508 supplies the audio maximum likelihood state sequence of the code model of interest as to the content of interest to the frame extracting unit 504, and the processing proceeds from step S338 to step S339.

In step S339, the object model selecting unit 509 selects an object contents model correlated with the category from the scrapbook selecting unit 141 out of the object contents models stored in the object model storage unit 202c, as the model of interest.

Subsequently, the object model selecting unit 509 supplies the model of interest to the object maximum likelihood state sequence estimating unit 511, and the processing proceeds from step S339 to step S340.

In step S340, the object feature amount extracting unit 510 extracts the object feature amount of each frame of the content of interest supplied from the contents selecting unit 142, and supplies (the time sequence of) the object feature amount of each frame of the content of interest to the object maximum likelihood state sequence estimating unit 511.

Subsequently, the processing proceeds from step S340 to step S341. In step S341, the object maximum likelihood state sequence estimating unit 511 subjects the object feature amount of the content of interest from the object feature amount extracting unit 510 to clustering using the cluster information of the object contents model that is the model of interest from the object model selecting unit 509 to obtain the object code sequence of the object feature amount of the content of interest.

Further, the object maximum likelihood state sequence estimating unit 511 estimates the maximum likelihood state sequence causing state transition where likelihood is the highest that the object code sequence of the object feature amount of the content of interest (hereafter, also referred to as the object maximum likelihood state sequence of the code model of interest as to the content of interest) will be observed in the HMM of the object contents model that is the model of interest from the object model selecting unit 509, for example, in accordance with the Viterbi algorithm.

Subsequently, the object maximum likelihood state sequence estimating unit 511 supplies the object maximum likelihood state sequence of the code model of interest as to the content of interest to the frame extracting unit 504, and the processing proceeds from step S341 to step S342.

In step S342, the frame extracting unit 504 sets the variable t for counting point-in-time (the number of frames of the content of interest) to 1 serving as the initial value, and the processing proceeds to step S343.

In step S343, the frame extracting unit 504 determines whether or not the state ID of the state at the point-in-time t (the t'th state from the head) of the image maximum likelihood state sequence, audio maximum likelihood state sequence, or object maximum likelihood state sequence matches one of the registered state IDs in a selected state registered in the scrapbook of interest from the scrapbook selecting unit 141.

In the event that determination is made in step S343 that the state ID of the state at the point-in-time t of the image maximum likelihood state sequence, audio maximum likelihood state sequence, or object maximum likelihood state sequence of the code model of interest as to the content of interest matches one of the registered state IDs of the scrapbook of interest, the processing proceeds to step S344.

Here, in this case, as for the registered state IDs of the scrapbook, there are three types of an image registered state ID, audio registered state ID, and object registered state ID.

Therefore, as for the case where the state ID of the state at the point-in-time t of the image maximum likelihood state sequence, audio maximum likelihood state sequence, or object maximum likelihood state sequence matches one of the registered state IDs of the scrapbook of interest, there are three cases of a case where the state ID of the state at the point-in-time t of the image maximum likelihood state sequence matches one of the image registered state IDs of the scrapbook of interest, a case where the state ID of the state at the point-in-time t of the audio maximum likelihood state sequence matches one of the audio registered state IDs of the scrapbook of interest, and a case where the state ID of the state at the point-in-time t of the object maximum likelihood state sequence matches one of the object registered state IDs of the scrapbook of interest.

In step S344, the frame extracting unit 504 extracts the frame at the point-in-time t from the content of interest from the contents selecting unit 142, supplies to the frame registration unit 505, and the processing proceeds to step S345.

Also, in the event that determination is made in step S343 that the state ID of the state at the point-in-time t of the image maximum likelihood state sequence, audio maximum likelihood state sequence, or object maximum likelihood state sequence of the model of interest do not match any of the registered state IDs of the scrapbook of interest, the processing proceeds to step S345. That is to say, step S344 is skipped.

In step S345, the frame extracting unit 504 determines whether or not the variable t is equal to the total number N_{F} of the frames of the content of interest.

In the event that determination is made in step S345 that the variable t is unequal to the total number N_{F} of the frames of the content of interest, the processing proceeds to step S346, where the frame extracting unit 504 increments the variable t by one. Subsequently, the processing returns from step S346 to step S343, and hereafter, the same processing is repeated.

Also, in the event that determination is made in step S345 that the variable t is equal to the total number N_{F} of the frames of the content of interest, the processing proceeds to step S347.

In step S347, the frame registration unit 505 registers the frames supplied from the frame extracting unit 504, i.e., all the frames extracted from the content of interest in the scrapbook of interest from the scrapbook selecting unit 141.

Subsequently, the processing proceeds from step S347 to step S348. In step S348, the contents selecting unit 142 determines whether or not, of the contents belonging to the same category as the category correlated with the scrapbook of interest, stored in the contents storage unit 11, there is a content that has not been selected yet as the content of interest.

In the event that determination is made in step S348 that, of the contents belonging to the same category as the category correlated with the scrapbook of interest, stored in the contents storage unit 11, there is a content that has not been selected yet as the content of interest, the processing returns to step S332.

Also, in the event that determination is made in step S348 that, of the contents belonging to the same category as the category correlated with the scrapbook of interest, stored in the contents storage unit 11, there is no content that has not been selected yet as the content of interest, the processing proceeds to step S349.

In step S349, the frame registration unit 505 outputs the scrapbook of interest to the registered scrapbook storage unit 374 as a registered scrapbook, and the registered scrapbook generation processing ends.

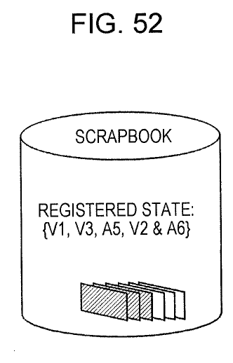

Description will be made regarding the registered scrapbook generation processing that the registered scrapbook generating unit 373 performs, and specifically regarding difference with the scrapbook generation processing in the event of employing only the image feature amount by the registered scrapbook generating unit 103 described in FIG. 28, with reference to FIG. 52.

Specifically, in E in FIG. 28, “1” and “3” are registered as the image registered state IDs of the scrapbook of interest, and the frames of which the state IDs based on the image feature amount (state IDs in the image maximum likelihood state sequence where the (image) code sequence of the image feature amount of the content of interest will be observed) are “1” and “3” are extracted from the content of interest, respectively.

Subsequently, as illustrated in F in FIG. 28, the frames extracted from the content of interest are registered in a form maintaining the temporal context thereof, for example, as a moving image.

On the other hand, in the event of employing feature amount other than the image feature amount, i.e., for example, in the event of employing the image feature amount and audio feature amount, as illustrated in FIG. 52, “V1”, “V3”, “A5”, and “V2&A6” may be registered as the registered state IDs of the scrapbook of interest.

Here, in FIG. 52, a character string made up of a character of “V” and a number following this character such as “V1” and so forth represents an image registered state ID of the registered state IDs, and a character string made up of a character of “A” and a number following this character such as “A5” and so forth represents an audio registered state ID of the registered state IDs.

Also, in FIG. 52, “V2&A6” represents that “V2” that is an image registered state ID, and “A6” that is an audio registered state ID are correlated.

As illustrated in FIG. 52, in the event that “V1”, “V3”, “A5”, and “V2&A6” are registered in the scrapbook of interest as the registered state IDs, with the frame extracting unit 504 (FIG. 50), a frame of which the state ID based on the image feature amount matches the image registered state ID=“V1”, and a frame of which the state ID based on the image feature amount matches the image registered state ID=“V3” are extracted from the content of interest, and also a frame of which the state ID based on the audio feature amount matches the audio registered state ID=“A5” is extracted from the content of interest.

Further, with the frame extracting unit 504, a frame of which the state ID based on the image feature amount matches the image registered state ID=“V2” and also the state ID based on the audio feature amount matches the audio registered state ID=“A6” is extracted from the content of interest.

Accordingly, frames are selected while taking a plurality of feature amount into consideration, and accordingly, as compared to the case of employing the image feature amount alone, a scrapbook in which frames with the user's interest are collected with further high precision can be obtained.

Note that, in FIG. 52, an example employing the image feature amount and audio feature amount is illustrated, but it goes without saying that the object feature amount may further be employed.

Also, description has been made above regarding an example employing the image feature amount, audio feature amount, and object feature amount, but further a combination of a plurality of different feature amounts may be employed, or these may independently be employed. Further, an arrangement may be made wherein the object feature amount is set according to the type of objects, and these are used in a distinction manner, e.g., each of a person's whole image, the upper half of the body, a face image, and so forth serving as objects may be used as individual object feature amount.

Description of Computer with Present Invention Being Applied

Next, the above series of processing may be performed by hardware, and may be performed by software. In the event of performing the series of processing by software, a program making up the software thereof is installed into a general-purpose computer or the like.

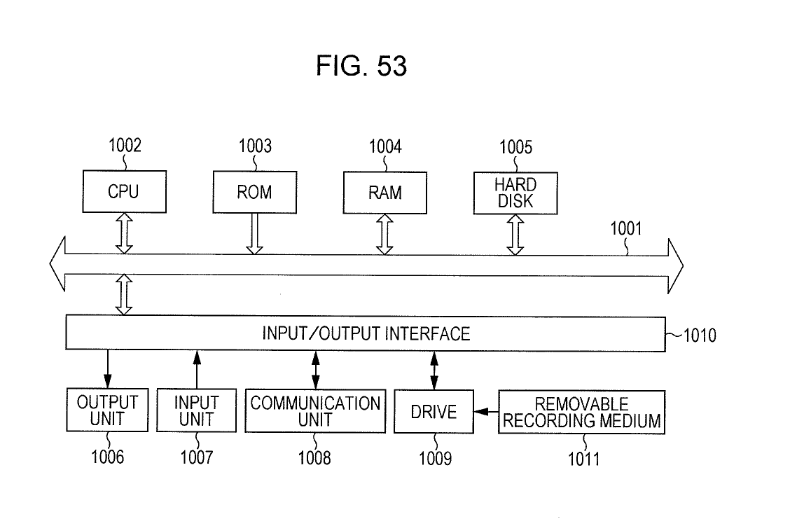

Therefore, FIG. 53 illustrates a configuration example of an embodiment of a computer into which a program that executes the above series of processing is installed.

The program may be recorded beforehand in a hard disk 1005 or ROM 1003 serving as a recording medium housed in the computer.

Alternatively, the program may be stored (recorded) beforehand in a removable recording medium to be mounted on a drive 1009. Such a removable recording medium 1011 may be provided as so-called package software. Here, examples of the removable recording medium 1011 include flexible disks, CD-ROM (Compact Disc Read Only Memory), MO (Magneto Optical) disks, DVD (Digital Versatile Disc), magnetic disks, and semiconductor memory.

Note that the program may be downloaded into the computer via a communication network or broadcast network and installed into a built-in hard disk 1005 in addition to installing into the computer from the removable recording medium 1011 as described above. Specifically, for example, the program may wirelessly be transferred to the computer from a download site via satellite for digital satellite broadcasting, or may be transferred to the computer by cable via a network such as a LAN (Local Area Network) or the Internet.

The computer houses a CPU (Central Processing Unit) 1002, and the CPU 1002 is connected to an input/output interface 1010 via a bus 1001.

Upon a command being input by a user operating an input unit 1007 or the like via the input/output interface 1010, the CPU 1002 executes, in accordance therewith, the program stored in the ROM (Read Only Memory) 1003. Alternatively, the CPU 1002 loads the program stored in the hard disk 1005 into RAM (Random Access Memory) 1004 and executes this.

Thus, the CPU 1002 performs the processing in accordance with the above flowcharts, or the processing to be performed by the configurations of the above block diagrams. Subsequently, with the CPU 1002, if necessary, for example, the processing results is output from an output unit 1006, or transmitted from a communication unit 1008, or further recorded in the hard disk, or the like, via the input/output interface 1010.

Note that the input unit 1007 is configured of a keyboard, a mouse, a microphone, and so forth. Also, the output unit 1006 is configured of an LCD (Liquid Crystal Display), a speaker, and so forth.

Now, with the present Specification, processing that the computer performs in accordance with the program does not necessarily have to be performed in time sequence along the sequence described as a flowchart. Specifically, the processing that the computer performs in accordance with the program also includes processing executed in parallel or individually (e.g., parallel processing or processing by an object).

Also, the program may be a program to be executed by a single computer (processor), or a program to be processed by multiple computers in a distributed manner. Further, the program may be a program to be transferred to a remote computer and executed there.

Note that embodiments of the present invention are not restricted to the above-mentioned embodiments, and various changes can be made without departing from the essence and spirit of the present invention.

The present application contains subject matter related to that disclosed in Japanese Priority Patent Application JP 2010-090054 filed in the Japan Patent Office on Apr. 9, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device comprising:
feature amount extracting means configured to extract the feature amount of each frame of an image of a content for detector learning of interest that is a content to be used for learning of a highlight detector which is a model for detecting a scene in which the user is interested as a highlight scene;
clustering means configured to use cluster information that is the information of said cluster obtained by performing cluster learning for extracting the feature amount of each frame of an image of a content for learning that is a content to be used for cluster learning for dividing feature amount space that is the space of said feature amount into a plurality of clusters, and dividing said feature amount space into a plurality of clusters using the feature amount of each frame of said content for learning to subject the feature amount of each frame of said content for detector learning of interest to clustering into one cluster of said plurality of clusters, thereby converting the time sequence of the feature amount of said content for detector learning of interest into the code sequence of a code representing a cluster to which the feature amount of said content for detector learning of interest belongs;
highlight label generating means configured to generate a highlight label sequence regarding said content for detector learning of interest by labeling each frame of said content for detector learning of interest using a highlight label representing whether or not said highlight scene in accordance with the user's operations; and
highlight detector learning means configured to perform learning of said highlight detector which is a state transition probability model stipulated by state transition probability that a state will proceed, and observation probability that a predetermined observation value will be observed from said state, using a label sequence for learning that is a pair of said code sequence obtained from said content for detector learning of interest, and said highlight label sequence.

2. The information processing device according to claim 1, further comprising:
highlight detecting means configured to extract the feature amount of each frame of an image of a content for highlight detection of interest that is a content from which a highlight scene is to be detected,
to convert the time sequence of the feature amount of said content for highlight detection of interest into said code sequence by subjecting the feature amount of each frame of said content for highlight detection of interest to clustering into one cluster of said plurality of clusters using said cluster information,
to estimate the maximum likelihood state sequence that is a state sequence causing state transition to occur where likelihood is the highest that a label sequence for detection that is a pair of said code sequence obtained from said content for highlight detection of interest, and the highlight label sequence of a highlight label representing a highlight scene or non-highlight scene will be observed in said highlight detector,
to detect the frame of a highlight scene from said content for highlight detection of interest based on the observation probability of said highlight label of each state of a highlight relation state sequence that is said maximum likelihood state sequence obtained from said label sequence for detection, and
to generate a digest content that is the digest of said content for highlight detection of interest using the frame of said highlight scene.

3. The information processing device according to claim 2, wherein said highlight detecting means detect, in the event that difference between the observation probability of a highlight label representing a highlight scene, and the observation probability of a highlight label representing a non-highlight scene in a predetermined point-in-time state of said highlight relation state sequence is greater than a predetermined threshold, the frame of said content for highlight detection of interest corresponding to said predetermined point-in-time state as the frame of a highlight scene.

4. The information processing device according to claim 1, further comprising:
scrapbook generating means configured to extract the feature amount of each frame of an image of a content,
to subject the feature amount of said content to clustering using said cluster information to convert into a code sequence,
to estimate the maximum likelihood state sequence that is a state sequence causing state transition to occur where likelihood is the highest that the code sequence of said content will be observed with a code model that is a state transition probability model after said model learning obtained by performing model learning that is learning of a state transition probability model using the code sequence of said content for learning,
to extract, of the states of said maximum likelihood state sequence, a frame corresponding to a state matching the state instructed by the user, from said content, and
to register the frame extracted from said content in a scrapbook in which said highlight scene is registered.

5. The information processing device according to claim 1, further comprising:
inter-state distance calculating means configured to obtain inter-state distance from one state to another state of said code model based on state transition probability from said one state to said another state;
coordinates calculating means configured to obtain, so as to reduce error between Euclidean distance from said one state to said another state and said inter-state distance on a model map that is a two-dimensional or three-dimensional map where a state of said code model is disposed, state coordinates that are the coordinates of the position of said state on said model map; and
display control means configured to perform display control for displaying said model map where said corresponding state is disposed in the position of said state coordinates.

6. The information processing device according to claim 5, wherein said coordinates calculating means obtain said state coordinates so as to minimize a Sammon Map error function in proportion to statistical error between said Euclidean distance and said inter-state distance, and in the event that the Euclidean distance from said one state to said another state is greater than a predetermined threshold, set the Euclidean distance from said one state to said another state to distance equal to said inter-state distance from said one state to said another state, and perform calculation of said error function.

7. The information processing device according to claim 5, further comprising:
scrapbook generating means configured to extract the feature amount of each frame of an image of a content,
to subject the feature amount of said content to clustering using said cluster information to convert into a code sequence,
to estimate the maximum likelihood state sequence that is a state sequence causing state transition to occur where likelihood is the highest that the code sequence of said content will be observed with a code model that is a state transition probability model after said model learning obtained by performing model learning that is learning of a state transition probability model using the code sequence of said content for learning,
to extract, of the states of said maximum likelihood state sequence, a frame corresponding to a state matching a state on said model map, instructed by the user, from said content, and
to register the frame extracted from said content in a scrapbook in which said highlight scene is registered.

8. The information processing device according to claim 1, wherein the feature amount of said frame is obtained by dividing said frame into sub regions that are a plurality of small regions, extracting the feature amount of each of said plurality of sub regions, and combining the feature amount of each of said plurality of sub regions.

9. The information processing device according to claim 1, wherein the feature amount of said frame is obtained by combining a mean value and dispersion of audio energy, zero crossing rate, or spectrum center of gravity within predetermined time corresponding to said frame.

10. The information processing device according to claim 1, wherein the feature amount of said frame is obtained by detecting the display region of an object within said frame, dividing said frame into sub regions that are a plurality of small regions, extracting the percentage of the number of pixels of the display region of said object in said sub regions as to the number of pixels in each of said plurality of sub regions, as feature amount, and combining the feature amount of each of said plurality of sub regions.

11. The information processing device according to claim 1, further comprising:
cluster information and code model learning means configured to obtain said cluster information by performing cluster learning for dividing said feature amount space into a plurality of clusters using the feature amount of said content for learning, and also
to generate said code model by performing model learning of a state transition probability model using a code sequence obtained by subjecting the feature amount of said content for learning to clustering using said cluster information.

12. An information processing method using an information processing device, comprising the steps of:
extracting the feature amount of each frame of an image of a content for detector learning of interest that is a content to be used for learning of a highlight detector which is a model for detecting a scene in which the user is interested as a highlight scene;
using cluster information that is the information of said cluster obtained by performing cluster learning for extracting the feature amount of each frame of an image of a content for learning that is a content to be used for cluster learning for dividing feature amount space that is the space of said feature amount into a plurality of clusters, and dividing said feature amount space into a plurality of clusters using the feature amount of each frame of said content for learning to subject the feature amount of each frame of said content for detector learning of interest to clustering into one cluster of said plurality of clusters, thereby converting the time sequence of the feature amount of said content for detector learning of interest into the code sequence of a code representing a cluster to which the feature amount of said content for detector learning of interest belongs;
generating a highlight label sequence regarding said content for detector learning of interest by labeling each frame of said content for detector learning of interest using a highlight label representing whether or not said highlight scene in accordance with the user's operations; and
performing learning of said highlight detector which is a state transition probability model stipulated by state transition probability that a state will proceed, and observation probability that a predetermined observation value will be observed from said state, using a label sequence for learning that is a pair of said code sequence obtained from said content for detector learning of interest, and said highlight label sequence.

13. A program causing a computer to serve as:
feature amount extracting means configured to extract the feature amount of each frame of an image of a content for detector learning of interest that is a content to be used for learning of a highlight detector which is a model for detecting a scene in which the user is interested as a highlight scene;
clustering means configured to use cluster information that is the information of said clusters obtained by performing cluster learning for extracting the feature amount of each frame of an image of a content for learning that is a content to be used for cluster learning for dividing feature amount space that is the space of said feature amount into a plurality of clusters, and dividing said feature amount space into a plurality of clusters using the feature amount of each frame of said content for learning to subject the feature amount of each frame of said content for detector learning of interest to clustering into one cluster of said plurality of clusters, thereby converting the time sequence of the feature amount of said content for detector learning of interest into the code sequence of a code representing a cluster to which the feature amount of said content for detector learning of interest belongs;
highlight label generating means configured to generate a highlight label sequence regarding said content for detector learning of interest by labeling each frame of said content for detector learning of interest using a highlight label representing whether or not said highlight scene in accordance with the user's operations; and
highlight detector learning means configured to perform learning of said highlight detector which is a state transition probability model stipulated by state transition probability that a state will proceed, and observation probability that a predetermined observation value will be observed from said state, using a label sequence for learning that is a pair of said code sequence obtained from said content for detector learning of interest, and said highlight label sequence.

14. An information processing device comprising:
obtaining means configured to obtain said highlight detector obtained by
extracting the feature amount of each frame of an image of a content for detector learning of interest that is a content to be used for learning of a highlight detector which is a model for detecting a scene in which the user is interested as a highlight scene,
using cluster information that is the information of said clusters obtained by performing cluster learning for extracting the feature amount of each frame of an image of a content for learning that is a content to be used for cluster learning for dividing feature amount space that is the space of said feature amount into a plurality of clusters, and dividing said feature amount space into a plurality of clusters using the feature amount of each frame of said content for learning to subject the feature amount of each frame of said content for detector learning of interest to clustering into one cluster of said plurality of clusters, thereby converting the time sequence of the feature amount of said content for detector learning of interest into the code sequence of a code representing a cluster to which the feature amount of said content for detector learning of interest belongs,
generating a highlight label sequence regarding said content for detector learning of interest by labeling each frame of said content for detector learning of interest using a highlight label representing whether or not said highlight scene in accordance with the user's operations, and
performing learning of said highlight detector which is a state transition probability model stipulated by state transition probability that a state will proceed, and observation probability that a predetermined observation value will be observed from said state, using a label sequence for learning that is a pair of said code sequence obtained from said content for detector learning of interest, and said highlight label sequence;
feature amount extracting means configured to extract the feature amount of each frame of an image of a content for highlight detection of interest that is a content from which a highlight scene is to be detected;
clustering means configured to convert the time sequence of the feature amount of said content for highlight detection of interest into said code sequence by subjecting the feature amount of each frame of said content for highlight detection of interest to clustering into one cluster of said plurality of clusters using said cluster information;
maximum likelihood state sequence estimating means configured to estimate the maximum likelihood state sequence that is a state sequence causing state transition to occur where likelihood is the highest that a label sequence for detection that is a pair of said code sequence obtained from said content for highlight detection of interest, and the highlight label sequence of a highlight label representing a highlight scene or non-highlight scene will be observed in said highlight detector;
highlight scene detecting means configured to detect the frame of a highlight scene from said content for highlight detection of interest based on the observation probability of said highlight label of each state of a highlight relation state sequence that is said maximum likelihood state sequence obtained from said label sequence for detection; and
digest contents generating means configured to generate a digest content that is the digest of said content for highlight detection of interest using the frame of said highlight scene.

15. The information processing device according to claim 14, wherein said highlight detecting means detect, in the event that difference between the observation probability of a highlight label representing a highlight scene, and the observation probability of a highlight label representing a non-highlight scene in a predetermined point-in-time state of said highlight relation state sequence is greater than a predetermined threshold, the frame of said content for highlight detection of interest corresponding to said predetermined point-in-time state as the frame of a highlight scene.

16. The information processing device according to claim 14, further comprising:
scrapbook generating means configured to extract the feature amount of each frame of an image of a content,
to subject the feature amount of said content to clustering using said cluster information to convert into a code sequence,
to estimate the maximum likelihood state sequence that is a state sequence causing state transition to occur where likelihood is the highest that the code sequence of said content will be observed with a code model that is a state transition probability model after said model learning obtained by performing model learning that is learning of a state transition probability model using the code sequence of said content for learning,
to extract, of the states of said maximum likelihood state sequence, a frame corresponding to a state matching the state instructed by the user, from said content, and
to register the frame extracted from said content in a scrapbook in which said highlight scene is registered.

17. The information processing device according to claim 14, further comprising:
inter-state distance calculating means configured to obtain inter-state distance from one state to another state of said code model based on state transition probability from said one state to said another state;
coordinates calculating means configured to obtain, so as to reduce error between Euclidean distance from said one state to said another state and said inter-state distance on a model map that is a two-dimensional or three-dimensional map where a state of said code model is disposed, state coordinates that are the coordinates of the position of said state on said model map; and
display control means configured to perform display control for displaying said model map where said corresponding state is disposed in the position of said state coordinates.

18. The information processing device according to claim 17, wherein said coordinates calculating means obtain said state coordinates so as to minimize a Sammon Map error function in proportion to statistical error between said Euclidean distance and said inter-state distance, and in the event that the Euclidean distance from said one state to said another state is greater than a predetermined threshold, set the Euclidean distance from said one state to said another state to distance equal to said inter-state distance from said one state to said another state, and perform calculation of said error function.

19. The information processing device according to claim 17, further comprising:
scrapbook generating means configured to extract the feature amount of each frame of an image of a content,
to subject the feature amount of said content to clustering using said cluster information to convert into a code sequence,
to estimate the maximum likelihood state sequence that is a state sequence causing state transition to occur where likelihood is the highest that the code sequence of said content will be observed with a code model that is a state transition probability model after said model learning obtained by performing model learning that is learning of a state transition probability model using the code sequence of said content for learning,
to extract, of the states of said maximum likelihood state sequence, a frame corresponding to a state matching a state on said model map, instructed by the user, from said content, and
to register the frame extracted from said content in a scrapbook in which said highlight scene is registered.

20. The information processing device according to claim 14, wherein the feature amount of said frame is obtained by dividing said frame into sub regions that are a plurality of small regions, extracting the feature amount of each of said plurality of sub regions, and combining the feature amount of each of said plurality of sub regions.

21. The information processing device according to claim 14, wherein the feature amount of said frame is obtained by combining a mean value and dispersion of audio energy, zero crossing rate, or spectrum center of gravity within predetermined time corresponding to said frame.

22. The information processing device according to claim 14, wherein the feature amount of said frame is obtained by detecting the display region of an object within said frame, dividing said frame into sub regions that are a plurality of small regions, extracting the percentage of the number of pixels of the display region of said object in said sub regions as to the number of pixels in each of said plurality of sub regions, as feature amount, and combining the feature amount of each of said plurality of sub regions.

23. An information processing method using an information processing device, comprising the steps of:
obtaining said highlight detector to be obtained by
extracting the feature amount of each frame of an image of a content for detector learning of interest that is a content to be used for learning of a highlight detector which is a model for detecting a scene in which the user is interested as a highlight scene,
using cluster information that is the information of said clusters obtained by performing cluster learning for extracting the feature amount of each frame of an image of a content for learning that is a content to be used for cluster learning for dividing feature amount space that is the space of said feature amount into a plurality of clusters, and dividing said feature amount space into a plurality of clusters using the feature amount of each frame of said content for learning to subject the feature amount of each frame of said content for detector learning of interest to clustering into one cluster of said plurality of clusters, thereby converting the time sequence of the feature amount of said content for detector learning of interest into the code sequence of a code representing a cluster to which the feature amount of said content for detector learning of interest belongs,
generating a highlight label sequence regarding said content for detector learning of interest by labeling each frame of said content for detector learning of interest using a highlight label representing whether or not said highlight scene in accordance with the user's operations, and
performing learning of said highlight detector which is a state transition probability model stipulated by state transition probability that a state will proceed, and observation probability that a predetermined observation value will be observed from said state, using a label sequence for learning that is a pair of said code sequence obtained from said content for detector learning of interest, and said highlight label sequence;
extracting the feature amount of each frame of an image of a content for highlight detection of interest that is a content from which a highlight scene is to be detected;
converting the time sequence of the feature amount of said content for highlight detection of interest into said code sequence by subjecting the feature amount of each frame of said content for highlight detection of interest to clustering into one cluster of said plurality of clusters using said cluster information;
estimating the maximum likelihood state sequence that is a state sequence causing state transition to occur where likelihood is the highest that a label sequence for detection that is a pair of said code sequence obtained from said content for highlight detection of interest, and the highlight label sequence of a highlight label representing a highlight scene or non-highlight scene will be observed in said highlight detector;
detecting the frame of a highlight scene from said content for highlight detection of interest based on the observation probability of said highlight label of each state of a highlight relation state sequence that is said maximum likelihood state sequence obtained from said label sequence for detection; and
generating a digest content that is the digest of said content for highlight detection of interest using the frame of said highlight scene.

24. A program causing a computer to serve as:
obtaining means configured to obtain said highlight detector obtained by
extracting the feature amount of each frame of an image of a content for detector learning of interest that is a content to be used for learning of a highlight detector which is a model for detecting a scene in which the user is interested as a highlight scene,
using cluster information that is the information of said clusters obtained by performing cluster learning for extracting the feature amount of each frame of an image of a content for learning that is a content to be used for cluster learning for dividing feature amount space that is the space of said feature amount into a plurality of clusters, and dividing said feature amount space into a plurality of clusters using the feature amount of each frame of said content for learning to subject the feature amount of each frame of said content for detector learning of interest to clustering into one cluster of said plurality of clusters, thereby converting the time sequence of the feature amount of said content for detector learning of interest into the code sequence of a code representing a cluster to which the feature amount of said content for detector learning of interest belongs,
generating a highlight label sequence regarding said content for detector learning of interest by labeling each frame of said content for detector learning of interest using a highlight label representing whether or not said highlight scene in accordance with the user's operations, and
performing learning of said highlight detector which is a state transition probability model stipulated by state transition probability that a state will proceed, and observation probability that a predetermined observation value will be observed from said state, using a label sequence for learning that is a pair of said code sequence obtained from said content for detector learning of interest, and said highlight label sequence;
feature amount extracting means configure to extract the feature amount of each frame of an image of a content for highlight detection of interest that is a content from which a highlight scene is to be detected;
clustering means configured to convert the time sequence of the feature amount of said content for highlight detection of interest into said code sequence by subjecting the feature amount of each frame of said content for highlight detection of interest to clustering into one cluster of said plurality of clusters using said cluster information;
maximum likelihood state sequence estimating means configured to estimate the maximum likelihood state sequence that is a state sequence causing state transition to occur where likelihood is the highest that a label sequence for detection that is a pair of said code sequence obtained from said content for highlight detection of interest, and the highlight label sequence of a highlight label representing a highlight scene or non-highlight scene will be observed in said highlight detector;
highlight scene detecting means configured to detect the frame of a highlight scene from said content for highlight detection of interest based on the observation probability of said highlight label of each state of a highlight relation state sequence that is said maximum likelihood state sequence obtained from said label sequence for detection; and
digest contents generating means configured to generate a digest content that is the digest of said content for highlight detection of interest using the frame of said highlight scene.

25. An information processing device comprising:
a feature amount extracting unit configured to extract the feature amount of each frame of an image of a content for detector learning of interest that is a content to be used for learning of a highlight detector which is a model for detecting a scene in which the user is interested as a highlight scene;
a clustering unit configured to use cluster information that is the information of said cluster obtained by performing cluster learning for extracting the feature amount of each frame of an image of a content for learning that is a content to be used for cluster learning for dividing feature amount space that is the space of said feature amount into a plurality of clusters, and dividing said feature amount space into a plurality of clusters using the feature amount of each frame of said content for learning to subject the feature amount of each frame of said content for detector learning of interest to clustering into one cluster of said plurality of clusters, thereby converting the time sequence of the feature amount of said content for detector learning of interest into the code sequence of a code representing a cluster to which the feature amount of said content for detector learning of interest belongs;
a highlight label generating unit configured to generate a highlight label sequence regarding said content for detector learning of interest by labeling each frame of said content for detector learning of interest using a highlight label representing whether or not said highlight scene in accordance with the user's operations; and
a highlight detector learning unit configured to perform learning of said highlight detector which is a state transition probability model stipulated by state transition probability that a state will proceed, and observation probability that a predetermined observation value will be observed from said state, using a label sequence for learning that is a pair of said code sequence obtained from said content for detector learning of interest, and said highlight label sequence.

26. A program causing a computer to serve as:
a feature amount extracting unit configured to extract the feature amount of each frame of an image of a content for detector learning of interest that is a content to be used for learning of a highlight detector which is a model for detecting a scene in which the user is interested as a highlight scene;
a clustering unit configured to use cluster information that is the information of said clusters obtained by performing cluster learning for extracting the feature amount of each frame of an image of a content for learning that is a content to be used for cluster learning for dividing feature amount space that is the space of said feature amount into a plurality of clusters, and dividing said feature amount space into a plurality of clusters using the feature amount of each frame of said content for learning to subject the feature amount of each frame of said content for detector learning of interest to clustering into one cluster of said plurality of clusters, thereby converting the time sequence of the feature amount of said content for detector learning of interest into the code sequence of a code representing a cluster to which the feature amount of said content for detector learning of interest belongs;
a highlight label generating unit configured to generate a highlight label sequence regarding said content for detector learning of interest by labeling each frame of said content for detector learning of interest using a highlight label representing whether or not said highlight scene in accordance with the user's operations; and
a highlight detector learning unit configured to perform learning of said highlight detector which is a state transition probability model stipulated by state transition probability that a state will proceed, and observation probability that a predetermined observation value will be observed from said state, using a label sequence for learning that is a pair of said code sequence obtained from said content for detector learning of interest, and said highlight label sequence.

27. An information processing device comprising:
an obtaining unit configured to obtain said highlight detector obtained by
extracting the feature amount of each frame of an image of a content for detector learning of interest that is a content to be used for learning of a highlight detector which is a model for detecting a scene in which the user is interested as a highlight scene,
using cluster information that is the information of said clusters obtained by performing cluster learning for extracting the feature amount of each frame of an image of a content for learning that is a content to be used for cluster learning for dividing feature amount space that is the space of said feature amount into a plurality of clusters, and dividing said feature amount space into a plurality of clusters using the feature amount of each frame of said content for learning to subject the feature amount of each frame of said content for detector learning of interest to clustering into one cluster of said plurality of clusters, thereby converting the time sequence of the feature amount of said content for detector learning of interest into the code sequence of a code representing a cluster to which the feature amount of said content for detector learning of interest belongs,
generating a highlight label sequence regarding said content for detector learning of interest by labeling each frame of said content for detector learning of interest using a highlight label representing whether or not said highlight scene in accordance with the user's operations, and
performing learning of said highlight detector which is a state transition probability model stipulated by state transition probability that a state will proceed, and observation probability that a predetermined observation value will be observed from said state, using a label sequence for learning that is a pair of said code sequence obtained from said content for detector learning of interest, and said highlight label sequence;
a feature amount extracting unit configured to extract the feature amount of each frame of an image of a content for highlight detection of interest that is a content from which a highlight scene is to be detected;
a clustering unit configured to convert the time sequence of the feature amount of said content for highlight detection of interest into said code sequence by subjecting the feature amount of each frame of said content for highlight detection of interest to clustering into one cluster of said plurality of clusters using said cluster information;
a maximum likelihood state sequence estimating unit configured to estimate the maximum likelihood state sequence that is a state sequence causing state transition to occur where likelihood is the highest that a label sequence for detection that is a pair of said code sequence obtained from said content for highlight detection of interest, and the highlight label sequence of a highlight label representing a highlight scene or non-highlight scene will be observed in said highlight detector;
a highlight scene detecting unit configured to detect the frame of a highlight scene from said content for highlight detection of interest based on the observation probability of said highlight label of each state of a highlight relation state sequence that is said maximum likelihood state sequence obtained from said label sequence for detection; and
a digest contents generating unit configured to generate a digest content that is the digest of said content for highlight detection of interest using the frame of said highlight scene.

28. A program causing a computer to serve as:
an obtaining unit configured to obtain said highlight detector obtained by
extracting the feature amount of each frame of an image of a content for detector learning of interest that is a content to be used for learning of a highlight detector which is a model for detecting a scene in which the user is interested as a highlight scene,
using cluster information that is the information of said clusters obtained by performing cluster learning for extracting the feature amount of each frame of an image of a content for learning that is a content to be used for cluster learning for dividing feature amount space that is the space of said feature amount into a plurality of clusters, and dividing said feature amount space into a plurality of clusters using the feature amount of each frame of said content for learning to subject the feature amount of each frame of said content for detector learning of interest to clustering into one cluster of said plurality of clusters, thereby converting the time sequence of the feature amount of said content for detector learning of interest into the code sequence of a code representing a cluster to which the feature amount of said content for detector learning of interest belongs,
generating a highlight label sequence regarding said content for detector learning of interest by labeling each frame of said content for detector learning of interest using a highlight label representing whether or not said highlight scene in accordance with the user's operations, and
performing learning of said highlight detector which is a state transition probability model stipulated by state transition probability that a state will proceed, and observation probability that a predetermined observation value will be observed from said state, using a label sequence for learning that is a pair of said code sequence obtained from said content for detector learning of interest, and said highlight label sequence;
a feature amount extracting unit configure to extract the feature amount of each frame of an image of a content for highlight detection of interest that is a content from which a highlight scene is to be detected;
a clustering unit configured to convert the time sequence of the feature amount of said content for highlight detection of interest into said code sequence by subjecting the feature amount of each frame of said content for highlight detection of interest to clustering into one cluster of said plurality of clusters using said cluster information;
a maximum likelihood state sequence estimating unit configured to estimate the maximum likelihood state sequence that is a state sequence causing state transition to occur where likelihood is the highest that a label sequence for detection that is a pair of said code sequence obtained from said content for highlight detection of interest, and the highlight label sequence of a highlight label representing a highlight scene or non-highlight scene will be observed in said highlight detector;
a highlight scene detecting unit configured to detect the frame of a highlight scene from said content for highlight detection of interest based on the observation probability of said highlight label of each state of a highlight relation state sequence that is said maximum likelihood state sequence obtained from said label sequence for detection; and
a digest contents generating unit configured to generate a digest content that is the digest of said content for highlight detection of interest using the frame of said highlight scene.
